(19) United States
(12) Patent Application Publication
(10) Pub. No.: US 2024/0357248 A1
(43) Pub. Date: Oct. 24, 2024

(54) IMAGING DEVICE AND IMAGING METHOD

(71) Applicant: SONY SEMICONDUCTOR SOLUTIONS CORPORATION, KANAGAWA (JP)

(72) Inventor: SHIGERU SAITOU, KANAGAWA (JP)

(21) Appl. No.: 18/577,286

(22) PCT Filed: Feb. 17, 2022
(86) PCT No.: PCT/JP2022/006501

§ 371 Date: Jan. 8, 2024

(30) Foreign Application Priority Data
Jul. 14, 2021 (JP) 2021-116719

(51) Int. Cl. H04N 25/40; H04N 25/772; H04N 25/779; H04N 25/79

(52) U.S. Cl. CPC H04N 25/40; H04N 25/772; H04N 25/779; H04N 25/79

(57) ABSTRACT

An imaging device of the present disclosure includes: a signal generation circuit that is configured to generate a first control signal; a first selection control circuit that is configured to generate a plurality of first selection signals; and a plurality of pixel circuits each including a light-receiving element, an accumulation section, a first switch, a first circuit, and a comparator circuit. The light-receiving element is configured to generate electric charge corresponding to an amount of received light. The accumulation section is configured to accumulate the electric charge generated by the light-receiving element. The first switch is configured to couple the light-receiving element to the accumulation section by being turned on. The first circuit is configured to control an operation of the first switch on the basis of one of the plurality of first selection signals and the first control signal. The comparator circuit is configured to compare a pixel signal including a voltage in the accumulation section with a reference signal having a ramp waveform.

### TECHNICAL FIELD

The present disclosure relates to an imaging device that images a subject, and an imaging method.

### BACKGROUND ART

In a typical imaging device, pixels each including a photodiode are arranged in a matrix form, and each of the pixels generates a pixel voltage corresponding to an amount of received light. For example, an analog/digital conversion circuit (Analog to Digital Converter) then converts the pixel voltage (analog signal) into a digital signal. For example, PTL 1 discloses an imaging device in which a plurality of pixel circuits each converts a pixel voltage into a digital signal.

### CITATION LIST

### Patent Literature

PTL 1: Japanese Unexamined Patent Application Publication No. 2019-149713

### SUMMARY OF THE INVENTION

Incidentally, imaging devices are desired to have a high degree of freedom in an imaging operation, and are expected to have a further improved degree of freedom.

It is desirable to provide an imaging device that makes it possible to enhance a degree of freedom in an imaging operation.

An imaging device according to an embodiment of the present disclosure includes a signal generation circuit, a first selection control circuit, and a plurality of pixel circuits. The signal generation circuit is configured to be able to generate a first control signal. The first selection control circuit is configured to be able to generate a plurality of first selection signals. Each of the plurality of pixel circuits includes a light-receiving element, an accumulation section, a first switch, a first circuit, and a comparator circuit. The light-receiving element is configured to be able to generate electric charge corresponding to an amount of received light. The accumulation section is configured to be able to accumulate the electric charge generated by the light-receiving element. The first switch configured to be able to couple the light-receiving element to the accumulation section by being turned on. The first circuit is configured to be able to control an operation of the first switch on the basis of one of the plurality of first selection signal and the first control signal. The comparator circuit is configured to be able to compare a pixel signal including a voltage in the accumulation section with a reference signal having a ramp waveform.

An imaging method according to an embodiment of the present disclosure includes: generating a first control signal; generating a plurality of first selection signals; and in each of a plurality of pixel circuits, generating electric charge corresponding an amount of received light by a light-receiving element, coupling the light-receiving element to an accumulation section by a first switch on the basis of one of the plurality of first selection signals and the first control signal, and comparing a pixel signal including a voltage in the accumulation section with a reference signal having a ramp waveform by a comparator circuit.

In the imaging device and the imaging method according to the embodiments of the present disclosure, the light-receiving element generates the electric charge corresponding to the amount of received light, and the first switch couples the light-receiving element to the accumulation section on the basis of one of the plurality of first selection signals and the first control signal. Thereafter, the comparator circuit compares the pixel signal including the voltage in the accumulation section with the reference signal having a ramp waveform.

### BRIEF DESCRIPTION OF DRAWINGS

FIG. 1 is a block diagram illustrating a configuration example of an imaging device according to a first embodiment of the present disclosure.

FIG. 2 is an explanatory diagram illustrating an implementation example of the imaging device illustrated in FIG. 1.

FIG. 3 is an explanatory diagram illustrating a configuration example of a pixel array illustrated in FIG. 1.

FIG. 4 is a circuit diagram illustrating a configuration example of a pixel circuit corresponding to a pixel illustrated in FIG. 1.

FIG. 5 is a block diagram illustrating a configuration example of the pixel array and a pixel driver illustrated in FIG. 1.

FIG. 6 is a truth table illustrating an operation example of a first logic circuit illustrated in FIG. 4.

FIG. 7 is a truth table illustrating an operation example of a second logic circuit illustrated in FIG. 4.

FIG. 8 is a timing waveform diagram illustrating an operation example of the imaging device illustrated in FIG. 1.

FIG. 9 is a timing waveform diagram illustrating another operation example of the imaging device illustrated in FIG. 1.

FIG. 10 is an explanatory diagram illustrating another operation example of the imaging device illustrated in FIG. 1.

FIG. 11 is a timing chart illustrating another operation example of the imaging device illustrated in FIG. 1.

FIG. 12 is an explanatory diagram illustrating another operation example of the imaging device illustrated in FIG. 1.

FIG. 13A is an explanatory diagram illustrating an operation state in another operation example of the imaging device illustrated in FIG. 1.

FIG. 13B is an explanatory diagram illustrating another operation state in another operation example of the imaging device illustrated in FIG. 1.

FIG. 14 is a timing chart illustrating another operation example of the imaging device illustrated in FIG. 1.

FIG. 15 is a timing chart illustrating another operation example of the imaging device illustrated in FIG. 1.

FIG. 16 is an explanatory diagram illustrating another operation example of the imaging device illustrated in FIG. 1.

FIG. 17 is an explanatory diagram illustrating another operation example of the imaging device illustrated in FIG. 1.

FIG. 18 is a circuit diagram illustrating a configuration example of a pixel circuit according to a modification example of the first embodiment.

FIG. 19 is a block diagram illustrating a configuration example of a pixel array and a pixel driver illustrated in FIG. 18.

FIG. 20 is a block diagram illustrating a configuration example of an imaging device according to a second embodiment.

FIG. 21 is a circuit diagram illustrating a configuration example of a pixel circuit corresponding to a pixel illustrated in FIG. 20.

FIG. 22 is a block diagram illustrating a configuration example of a pixel array and a pixel driver illustrated in FIG. 20.

FIG. 23 is a truth table illustrating an operation example of a first logic circuit illustrated in FIG. 21.

FIG. 24 is a truth table illustrating an operation example of a second logic circuit illustrated in FIG. 21.

FIG. 25 is an explanatory diagram illustrating an operation example of the imaging device illustrated in FIG. 20.

FIG. 26 is a timing waveform diagram illustrating another operation example of the imaging device illustrated in FIG. 20.

FIG. 27 is an explanatory diagram illustrating a configuration example of a pixel array according to a modification example of the second embodiment.

FIG. 28 is an explanatory diagram illustrating an operation example of an imaging device according to a modification example of the second embodiment.

FIG. 29 is a timing waveform diagram illustrating an operation example of an imaging device according to a modification example of the second embodiment.

FIG. 30 is an explanatory diagram illustrating a configuration example of an imaging device according to a third embodiment.

FIG. 31 is a circuit diagram illustrating a configuration example of a pixel circuit corresponding to a pixel illustrated in FIG. 30.

FIG. 32 is a block diagram illustrating a configuration example of a pixel array and a pixel driver illustrated in FIG. 30.

FIG. 33 is a truth table illustrating an operation example of a first logic circuit illustrated in FIG. 21.

FIG. 34 is a truth table illustrating an operation example of a second logic circuit illustrated in FIG. 21.

FIG. 35 is an explanatory diagram illustrating an operation example of the imaging device illustrated in FIG. 30.

FIG. 36 is an explanatory diagram illustrating a configuration example of an imaging device according to a fourth embodiment.

FIG. 37 is a circuit diagram illustrating a configuration example of a pixel circuit corresponding to a pixel illustrated in FIG. 36.

FIG. 38 is a block diagram illustrating a configuration example of a pixel array and a pixel driver illustrated in FIG. 36.

FIG. 39A is a truth table illustrating an operation example of a first logic circuit illustrated in FIG. 37.

FIG. 39B is another truth table illustrating the operation example of the first logic circuit illustrated in FIG. 37.

FIG. 40A is a truth table illustrating an operation example of a second logic circuit illustrated in FIG. 37.

FIG. 40B is another truth table illustrating the operation example of the second logic circuit illustrated in FIG. 37.

FIG. 41 is an explanatory diagram illustrating an operation example of the imaging device illustrated in FIG. 36.

FIG. 42 is a timing waveform diagram illustrating another operation example of the imaging device illustrated in FIG. 36.

FIG. 43 is an explanatory diagram illustrating another operation example of the imaging device illustrated in FIG. 36.

FIG. 44 is an explanatory diagram illustrating an operation example of an imaging device according to a modification example of the fourth embodiment.

FIG. 45 is a timing waveform diagram illustrating another operation example of the imaging device according to the modification example of the fourth embodiment.

FIG. 46 is a block diagram depicting an example of schematic configuration of a vehicle control system.

FIG. 47 is a diagram of assistance in explaining an example of installation positions of an outside-vehicle information detecting section and an imaging section.

### MODES FOR CARRYING OUT THE INVENTION

In the following, some embodiments of the present disclosure are described in detail with reference to the drawings. It is to be noted that description is given in the following order.
1. First Embodiment
2. Second Embodiment
3. Third Embodiment
4. Fourth Embodiment
5. Application Example to Mobile Body

### 1. First Embodiment

### Configuration Example

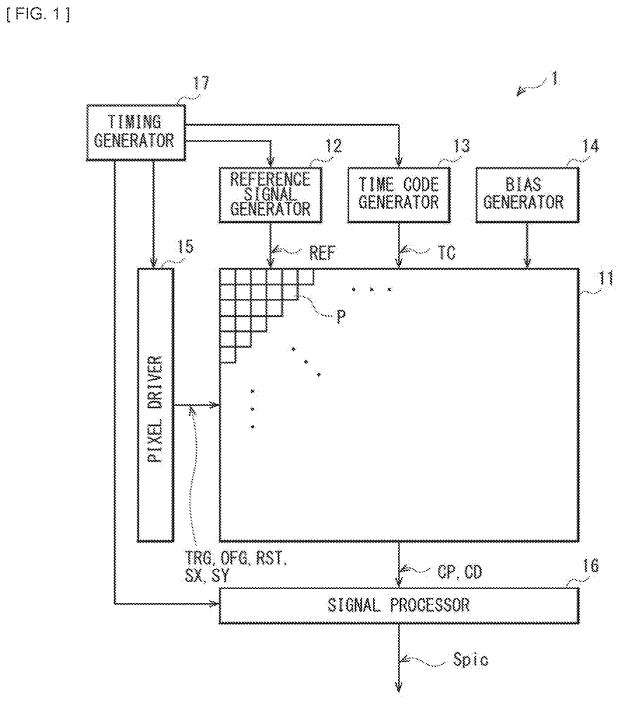

FIG. 1 illustrates a configuration example of an imaging device (imaging device 1) according to an embodiment. The imaging device 1 includes a pixel array 11, a reference signal generator 12, a time code generator 13, a bias generator 14, a pixel driver 15, a signal processor 16, and a timing generator 17. In this example, the imaging device 1 is formed on two semiconductor substrates.

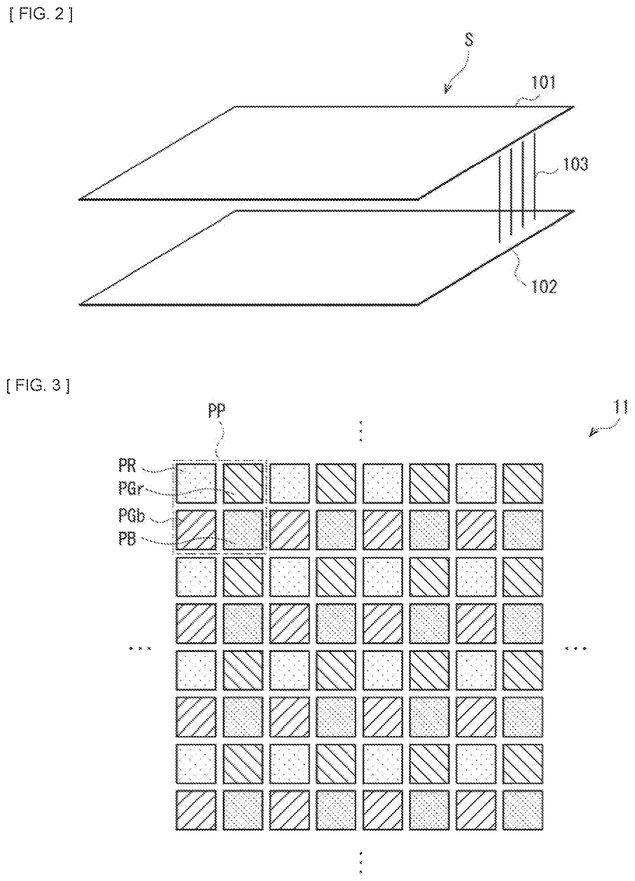

FIG. 2 illustrates an implementation example of the imaging device 1. In this example, the imaging device 1 is formed on two semiconductor substrates 101 and 102. The semiconductor substrate 101 is disposed on side of an imaging surface S in the imaging device 1, and the semiconductor substrate 102 is disposed on side opposite to the imaging surface S of the imaging device 1. The semiconductor substrates 101 and 102 are superimposed on each other. A wiring line of the semiconductor substrate 101 and a wiring line of the semiconductor substrate 102 are coupled to each other by a wiring line 103. It is possible to use, for example, a metallic bond such as Cu—Cu for the wiring line 103.

The pixel array 11 (FIG. 1) includes a plurality of pixels P arranged in a matrix form. Each of the pixels P includes a photodiode PD, and is configured to generate a pixel signal SIG including a pixel voltage Vpix corresponding to an amount of received light and perform AD conversion on the basis of the pixel signal SIG.

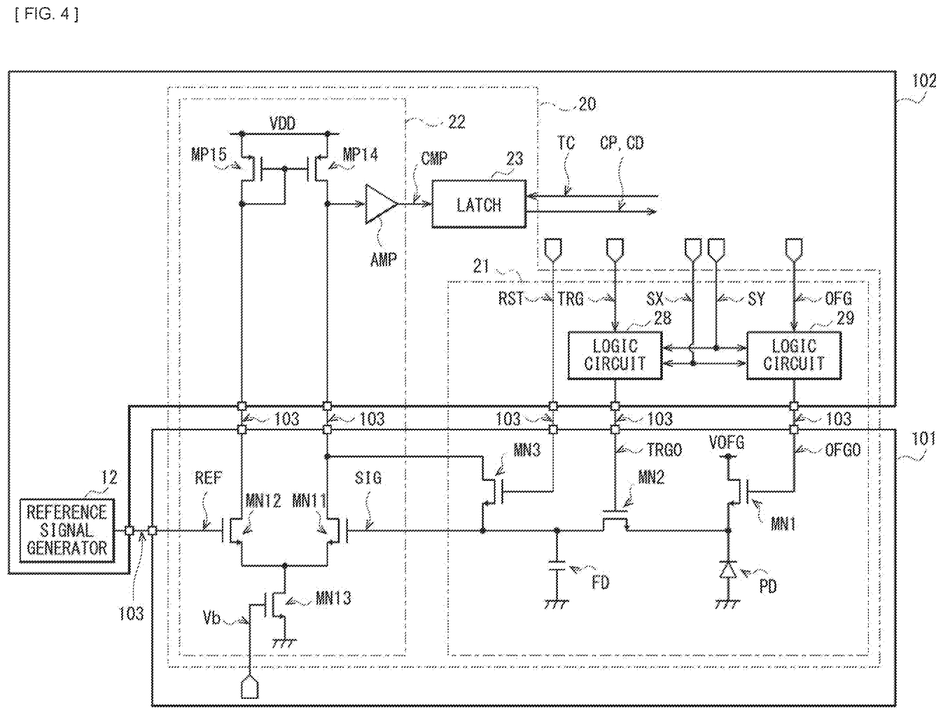

FIG. 3 illustrates a configuration example of the pixel array 11. In the pixel array 11, unit pixels PP including four pixels P (pixels PR, PGr, PGb, and PB) are provided side by side. The pixel PR includes a red (R) color filter, and is configured to receive red light. The pixels PGr and PGb each include a green (G) color filter, and are configured to receive green light. The pixel PB includes a blue (B) color filter, and is configured to receive blue light. In the unit pixel PP, the pixel PR is disposed on the upper left, the pixel PGr is disposed on the upper right, the pixel PGb is disposed on the lower left, and the pixel PB is disposed on the lower right. Thus, the four pixels PR, PGr, PGb, and PB are disposed in a so-called Bayer arrangement.

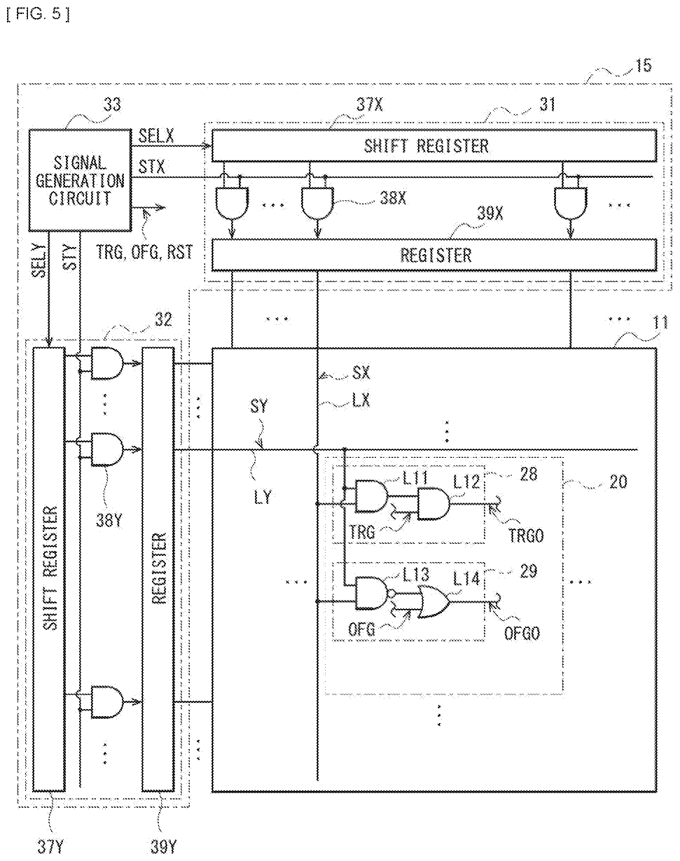

FIG. 4 illustrates a configuration example of a pixel circuit 20 related to the pixel P. The pixel circuit 20 includes a light reception circuit 21, a comparator circuit 22, and a latch 23.

The light reception circuit 21 is configured to generate the pixel signal SIG including the pixel voltage Vpix corresponding to the amount of received light. The light reception circuit 21 includes the photodiode PD, transistors MN1 to MN3, a floating diffusion FD, and logic circuits 28 and 29. The transistors MN1 to MN3 are N-type MOS (Metal Oxide Semiconductor) transistors. The light reception circuit 21 is disposed over the two semiconductor substrates 101 and 102, as illustrated in FIG. 4. Specifically, the photodiode PD, the transistors MN1 to MN3, and the floating diffusion FD are disposed on the semiconductor substrate 101, and the logic circuits 28 and 29 are disposed on the semiconductor substrate 102.

The photodiode PD is a photoelectric conversion element that generates and accumulates electric charge in an amount corresponding to the amount of received light. The photodiode PD has an anode grounded, and a cathode coupled to sources of the transistors MN1 and MN2.

The transistor MN1 has a gate to be supplied with a control signal OFG0 from the logic circuit 29 via the wiring line 103 between the semiconductor substrates 101 and 102, a drain to be supplied with a voltage VOFG, and the source coupled to the cathode of the photodiode PD and the source of the transfer transistor MN2.

The transistor MN2 has a gate to be supplied with a control signal TRG0 from the logic circuit 28 via the wiring line 103 between the semiconductor substrates 101 and 102, the source coupled to the cathode of the photodiode PD and the source of the transistor MN1, a drain coupled to the floating diffusion FD, a source of the transistor MN3, and a gate of a transistor MN11 (to be described later) in the comparator circuit 22.

The floating diffusion FD is configured to accumulate electric charge transferred from the photodiode PD. The floating diffusion FD is configured with use of, for example, a diffusion layer formed on a surface of the semiconductor substrate 101. FIG. 4 illustrates the floating diffusion FD by using a symbol of a capacitor.

The transistor MN3 has a gate to be supplied with a control signal RST from the pixel driver 15 (FIG. 1) via the wiring line 103 between the semiconductor substrates 101 and 102, a drain coupled to a drain of the transistor MN11 (to be described later) of the comparator circuit 22, the source coupled to the floating diffusion FD, the drain of the transistor MN2, the gate of the transistor MN11 (to be described later) of the comparator circuit 22.

With this configuration, in the light reception circuit 21, the electric charge accumulated in the photodiode PD is discharged by turning on the transistor MN1 on the basis of the control signal OFG0. The transistor MN1 is then turned off to start a light exposure period TE, and electric charge in the amount corresponding to the amount of received light is accumulated in the photodiode PD. Thereafter, after the light exposure period TE ends, the light reception circuit 21 supplies the pixel signal SIG including a reset voltage Vreset and the pixel voltage Vpix to the comparator circuit 22. Specifically, as described later, in a P-phase (Pre-charge phase) period TP after the voltage of the floating diffusion FD is reset, the light reception circuit 21 supplies the voltage of the floating diffusion FD at that time as the reset voltage Vreset to the comparator circuit 22. In addition, in a D-phase (Data phase) period TD after electric charge is transferred from the photodiode PD to the floating diffusion FD, the light reception circuit 21 supplies the voltage of the floating diffusion FD at that time as the pixel voltage Vpix to the comparator circuit 22.

The logic circuit 28 is configured to generate the control signal TRG0 on the basis of a control signal TRG and selection signals SX and SY supplied from the pixel driver 15 (FIG. 1).

The logic circuit 29 is configured to generate the control signal OFG0 on the basis of a control signal OFG and the selection signals SX and SY supplied from the pixel driver 15 (FIG. 1).

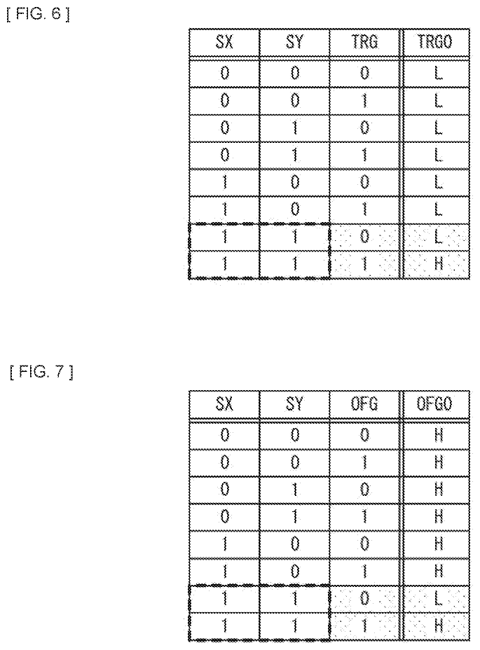

FIG. 5 illustrates a configuration example of the pixel driver 15 and the logic circuits 28 and 29. The pixel array 11 includes a plurality of selection signal lines LX and a plurality of selection signal lines LY. The plurality of selection signal lines LX extends in a longitudinal direction (vertical direction) in FIG. 5, and is provided side by side in a lateral direction (horizontal direction). The plurality of selection signal lines LX is each configured to transmit a corresponding one of a plurality of selection signals SX supplied from the pixel driver 15. The plurality of selection signal lines LY extends in the lateral direction (horizontal direction) in FIG. 5, and is provided side by side in the longitudinal direction (vertical direction). The plurality of selection signal lines LY is each configured to transmit a corresponding one of a plurality of selection signals SY supplied from the pixel driver 15.

The logic circuit 28 includes AND circuits (AND) L11 and L12. The AND circuit L11 has two input terminals each coupled to a corresponding one of the selection signal line LX and the selection signal line LY. The AND circuit L11 is configured to find AND of the selection signal SX and the selection signal SY. The AND circuit L12 is configured to find AND of an output signal of the AND circuit L11 and the control signal TRG supplied from the pixel driver 15 and output a result of the AND as the control signal TRG0.

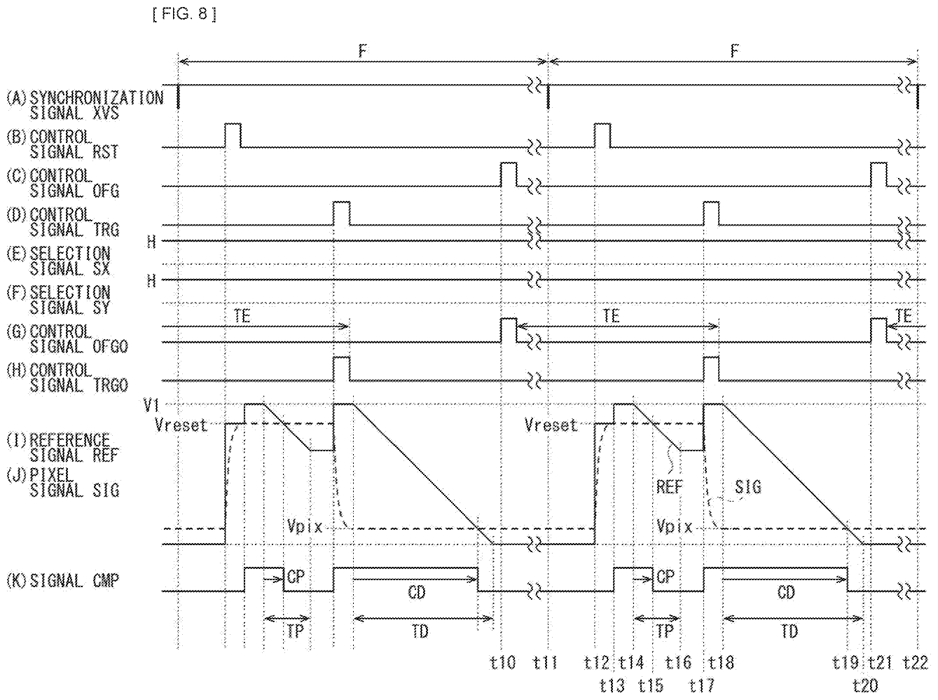

FIG. 6 illustrates an example of a truth table of the logic circuit 28. As indicated by a broken line, the logic circuit 28 outputs the control signal TRG as the control signal TRG0 in a case where both the selection signals SX and SY are at a high level, and changes the control signal TRG0 to a low level in other cases.

The logic circuit 29 (FIG. 5) includes a NAND circuit (NAND) L13 and an OR circuit (OR) L14. The NAND circuit L13 has two input terminals each coupled to a corresponding one of the selection signal line LX and the selection signal line LY. The NAND circuit L13 is configured to find NAND of the selection signal SX and the selection signal SY. The OR circuit L14 is configured to find OR of an output signal of the NAND circuit L13 and the control signal OFG supplied from the pixel driver 15 and output a result of the OR as the control signal OFG0.

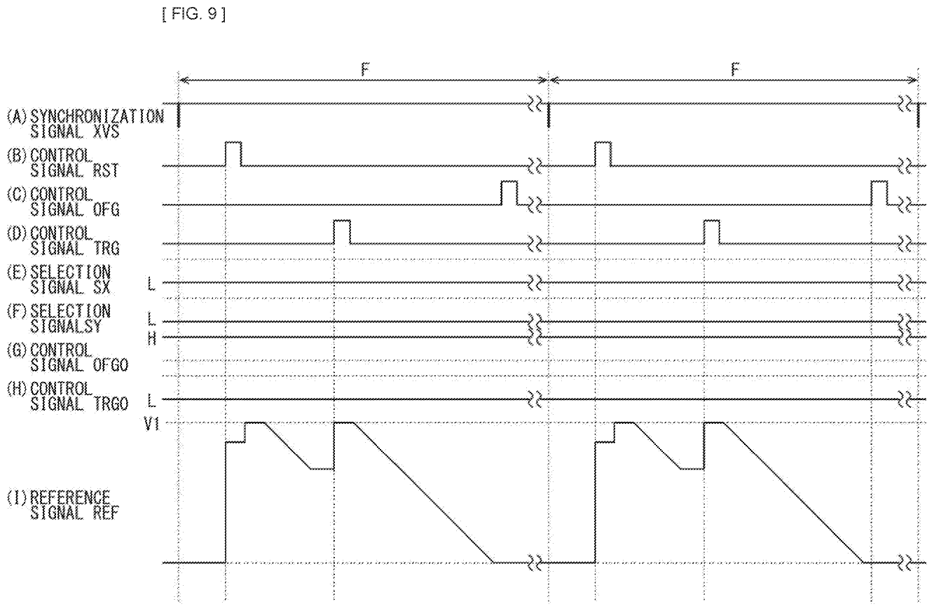

FIG. 7 illustrates an example of a truth table of the logic circuit 29. As indicated by a broken line, the logic circuit 29 outputs the control signal OFG as the control signal OFG0 in a case where both the selection signals SX and SY are at the high level, and changes the control signal OFG0 to the high level in other cases.

Thus, in a case where both the selection signals SX and SY are at the high level, the pixel circuit 20 is changed to a selected state. In the pixel circuit 20 that is in such a selected state, the logic circuit 28 outputs the control signal TRG as the control signal TRG0, and the logic circuit 29 outputs the control signal OFG as the control signal OFG0. Further, in other cases, the pixel circuit 20 is changed to an unselected state. In the pixel circuit 20 that is in such an unselected state, the logic circuit 28 changes the control signal TRG0 to the low level, and changes the control signal OFG0 to the high level.

The comparator circuit 22 (FIG. 4) is configured to generate a signal CMP by comparing a reference signal REF with the pixel signal SIG (the pixel voltage Vpix and the reset voltage Vreset). The comparator circuit 22 changes the signal CMP to the high level in a case where a voltage of the reference signal REF is higher than a voltage of the pixel signal SIG, and changes the signal CMP to the low level in a case where the voltage of the reference signal REF is lower than the voltage of the pixel signal SIG. The comparator circuit 22 includes transistors MN11, MN12, MN13, MP14, and MP15, and an amplifier AMP. The transistors MN11, MN12, and MN13 are N-type MOS transistors, and the transistors MP14 and MP15 are P-type MOS transistors. The comparator circuit 22 is disposed over the two semiconductor substrates 101 and 102, as illustrated in FIG. 4. Specifically, the transistors MN11 to MN13 are disposed on the semiconductor substrate 101, and the transistors MP14 and MP15 and the amplifier AMP are disposed on the semiconductor substrate 102.

The transistor MN11 has a gate to be supplied with the pixel signal SIG, the drain coupled to the drain of the transistor MN3 in the light reception circuit 21, and coupled to a drain of the transistor MP14 and an input terminal of the amplifier AMP via the wiring line 103 between the semiconductor substrates 101 and 102, and a source coupled to a source of the transistor MN12 and a drain of the transistor MN13. The transistor MN12 has a gate to be supplied with the reference signal REF from the reference signal generator 12 via the wiring line 103 between the semiconductor substrates 101 and 102, a drain coupled to a drain of the transistor MP15 and gates of the transistors MP14 and MP15 via the wiring line 103 between the semiconductor substrates 101 and 102, and the source coupled to the source of the transistor MN11 and the drain of the transistor MN13. As described in detail later, the reference signal REF is a signal having a so-called ramp waveform in which a voltage level gradually changes with a lapse of time in the P-phase period TP and the D-phase period TD. The transistor MN13 has a gate to be supplied with a bias voltage Vb from the bias generator 14 (FIG. 1), the drain coupled to the sources of the transistors MN11 and MN12, and a source grounded. The transistors MN11 and MN12 configure a differential pair, and the transistor MN13 configures a constant current source.

The transistor MP14 has the gate coupled to the gate and the drain of the transistor MP15, and coupled to the drain of the transistor MN12 via the wiring line 103 between the semiconductor substrates 101 and 102, a source to be supplied with a power supply voltage VDD, and the drain coupled to the input terminal of the amplifier AMP, and coupled to the drain of the transistor MN11, and the drain of the transistor MN3 in the light reception circuit 21 via the wiring line 103 between the semiconductor substrates 101 and 102. The transistor MP15 has the gate coupled to the gate of the transistor MP14 and the drain of the transistor MP15, and coupled to the drain of the transistor MN12 via the wiring line 103 between the semiconductor substrates 101 and 102, a source to be supplied with the power supply voltage VDD, and the drain coupled to the gates of the transistors MP14 and MP15, and coupled to the drain of the transistor MN12 via the wiring line 103 between the semiconductor substrates 101 and 102. The transistors MP14 and MP15 configure active loads of the transistors MN11 and MN12.

The amplifier AMP has the input terminal coupled to the drain of the transistor MP14, and coupled to the drain of the transistor MN11, and the drain of the transistor MN3 in the light reception circuit 21 via the wiring line 103 between the semiconductor substrates 101 and 102, and an output terminal coupled to the latch 23. The amplifier AMP supplies, to the latch 23, the signal CMP that is an output signal of the comparator circuit 22.

With this configuration, the comparator circuit 22 generates the signal CMP by comparing the reference signal REF with the pixel signal SIG.

The latch 23 is configured to latch a time code TC supplied from the time code generator 13 (FIG. 1) on the basis of the signal CMP supplied from the comparator circuit 22. The time code TC changes with a lapse of time. It is possible to use, for example, a gray code for the time code TC. As described later, the latch 23 latches the time code TC at a transition timing of the signal CMP in the P-phase period TP to obtain time (code value CP) from the start of the P-phase period TP until transition of the signal CMP takes place. In addition, the latch 23 latches the time code TC at the transition timing of the signal CMP in the D-phase period TD to obtain time (code value CD) from the start of the D-phase period TD until transition of the signal CMP takes place. A difference (CD-CP) between these two code values corresponds to a pixel value corresponding to the amount of received light. The latch 23 then supplies the two code values CD and CP to the signal processor 16.

Thus, the pixel circuit 20 generates the pixel signal SIG including the pixel voltage Vpix corresponding to the amount of received light, and performs AD conversion on the basis of the pixel signal SIG to generate the code values CP and CD.

The reference signal generator 12 (FIG. 1) is configured to generate the reference signal REF on the basis of an instruction from the timing generator 17. The reference signal REF is a signal having a so-called ramp waveform in which a voltage level gradually changes with a lapse of time in the P-phase period TP and the D-phase period TD. The reference signal generator 12 then supplies the generated reference signal REF to a plurality of pixel circuits 20 in the pixel array 11. The reference signal generator 12 is disposed on the semiconductor substrate 102, as illustrated in FIG. 4.

The time code generator 13 is configured to generate the time code TC on the basis of an instruction from the timing generator 17. The time code TC is a code having a plurality of bits that changes with a lapse of time, and it is possible to use, for example, a gray code for the time code TC. The time code generator 13 then supplies the generated time code TC to the plurality of pixel circuits 20 in the pixel array 11. The time code generator 13 is disposed on the semiconductor substrate 102 (FIG. 2), for example.

The bias generator 14 is configured to generate various bias voltages and bias currents to be used in the imaging device 1. For example, the bias generator 14 generates a bias voltage Vb, and supplies the bias voltage Vb to the comparator circuit 22 (FIG. 4) of the pixel circuit 20.

The pixel driver 15 is configured to control operations of the plurality of pixel circuits 20 in the pixel array 11. Specifically, the pixel driver 15 generates the control signals TRG, OFG, and RST, the plurality of selection signals SX, and the plurality of selection signals SY, and supplies these signals to the pixel array 11 to control the operations of the pixel circuits 20. The pixel driver 15 is disposed on the semiconductor substrate 102 (FIG. 2), for example.

As illustrated in FIG. 5, the pixel driver 15 includes selection control circuits 31 and 32, and a signal generation circuit 33.

The selection control circuit 31 is configured to generate the plurality of selection signals SX on the basis of a selection signal SELX and a trigger signal STX supplied from the signal generation circuit 33. The selection control circuit 31 includes a shift register 37X, a plurality of AND circuits 38X, and a register 39X. The shift register 37X is configured with use of, for example, a plurality of D-type flip-flop circuits coupled by daisy chain coupling, and is configured to generate a plurality of signals to be supplied to the plurality of AND circuits 38X, on the basis of the selection signal SELX supplied from the signal generation circuit 33. Specifically, the shift register 37X converts the selections signal SELX that is a serial signal into a plurality of signals that are parallel signals. The plurality of AND circuits 38X is each configured to find AND of the trigger signal STX supplied from the signal generation circuit 33 and each of the plurality of signals supplied from the shift register 37X. Specifically, the plurality of AND circuits 38X supplies the plurality of signals supplied from the shift register 37X to the register 39X in a period in which the trigger signal STX is at the high level. In addition, the plurality of AND circuits 38X changes a plurality of output signals to the low level in a period in which the trigger signal STX is at the low level. The register 39X stores each of output signals of the plurality of AND circuits 38X in the period in which the trigger signal STX is at the high level, and supplies each of the plurality of signals as the plurality of selection signals SX to the pixel array 11 via a corresponding one of the plurality of selection signal lines LX.

The selection control circuit 32 is configured to generate the plurality of selection signals SY on the basis of the selection signal SELY and the trigger signal STY supplied from the signal generation circuit 33, as with the selection control circuit 31. The selection control circuit 32 includes a shift register 37Y, a plurality of AND circuits 38Y, and a register 39Y. The shift register 37Y is configured with use of, for example, a plurality of D-type flip-flop circuits coupled by daisy chain coupling, and is configured to generate a plurality of signals to be supplied to the plurality of AND circuits 38Y, on the basis of the selection signal SELY supplied from the signal generation circuit 33. The plurality of AND circuits 38Y is each configured to find AND of the trigger signal STY supplied from the signal generation circuit 33 and each of the plurality of signals supplied from the shift register 37Y. The register 39Y stores each of output signals of the plurality of AND circuits 38Y in a period in which the trigger signal STY is at the high level, and supplies each of the plurality of signals as the plurality of selection signals SY to the pixel array 11 via a corresponding one of the plurality of selection signal lines LY.

The signal generation circuit 33 is configured to generate the control signals TRG, OFG, and RST, the selection signals SELX and SELY, and the trigger signals STX and STY.

With this configuration, the pixel driver 15 generates the control signals TRG, OFG, and RST, the plurality of selection signals SX, and the plurality of selection signals SY, and supplies these signals to the pixel array 11.

The signal processor 16 (FIG. 1) is configured to generate an image signal Spic by performing predetermined image processing on the basis of the code values CP and CD generated by each of the plurality of pixel circuits 20. Examples of the predetermined image processing include processing for generating a pixel value with use of the principle of correlated double sampling (DCS; Correlated Double Sampling) on the basis of the two code values CP and CD, and black level correction processing for correcting a black level. The signal processor 16 is disposed on the semiconductor substrate 102 (FIG. 2), for example.

The timing generator 17 is configured to control the operation of the imaging device 1 by generating various timing signals and supplying the various generated timing signals to the reference signal generator 12, the time code generator 13, the pixel driver 15, and the signal processor 16. The timing generator 17 is disposed on the semiconductor substrate 102 (FIG. 2), for example.

Here, the signal generation circuit 33 corresponds to a specific example of a “signal generation circuit” in the present disclosure. The control signal TRG corresponds to a specific example of a “first control signal” in the present disclosure. The control signal OFG corresponds to a specific example of a “second control signal” in the present disclosure. The selection control circuit 32 corresponds to a specific example of a “first selection control circuit” in the present disclosure. The plurality of selection signals SY corresponds to a specific example of a “plurality of first selection signals” in the present disclosure. The selection control circuit 31 corresponds to a specific example of a “second selection control circuit” in the present disclosure. The plurality of selection signals SX corresponds to a specific example of a “plurality of second selection signals” in the present disclosure. The plurality of pixel circuits 20 corresponds to a specific example of a “plurality of pixel circuits” in the present disclosure. The photodiode PD corresponds to a specific example of a “light-receiving element” in the present disclosure. The floating diffusion FD corresponds to a specific example of an “accumulation section” in the present disclosure. The transistor MN2 corresponds to a specific example of a “first switch” in the present disclosure. The logic circuit 28 corresponds to a specific example of a “first circuit” in the present disclosure. The transistor MN1 corresponds to a specific example of a “second switch” in the present disclosure. The logic circuit 29 corresponds to a specific example of a “second circuit” in the present disclosure. The comparator circuit 22 corresponds to a specific example of a “comparator circuit” in the present disclosure. The pixel signal SIG corresponds to a specific example of a “pixel signal” in the present disclosure. The reference signal REF corresponds to a specific example of a “reference signal” in the present disclosure. The selection signal lines LY correspond to a specific example of a “plurality of first selection signal lines” in the present disclosure. The selection signal lines LX correspond to a specific example of a “plurality of second selection signal lines” in the present disclosure.

### [Operation and Workings]

Next, description is given of the operation and workings of the imaging device 1 according to the present embodiment.

### (Overview of Overall Operation)

First, an overview of an overall operation of the imaging device 1 is described with reference to FIG. 1. The reference signal generator 12 generates the reference signal REF. The time code generator 13 generates the time code TC. The pixel driver 15 controls the operations of the plurality of pixel circuits 20 in the pixel array 11. Each of the plurality of pixel circuits 20 in the pixel array 11 generates the pixel signal SIG including the pixel voltage Vpix corresponding to the amount of received light, and performs AD conversion on the basis of the pixel signal SIG to generate the code values CP and CD. The signal processor 16 performs predetermined image processing on the basis of the code values CP and CD generated by each of the plurality of pixel circuits 20 to generate the image signal Spic. The timing generator 17 generates various timing signals, and supplies the various generated timing signals to the reference signal generator 12, the time code generator 13, the pixel driver 15, and the signal processor 16 to control the operation of the imaging device 1.

### (Detailed Operation)

As illustrated in FIG. 5, in the pixel driver 15, the signal generation circuit 33 generates the control signals TRG, OFG, and RST, the selection signals SELX and SELY, and the trigger signals STX and STY. The selection control circuit 31 generates the plurality of selection signals SX on the basis of the selection signal SELX and the trigger signal STX supplied from the signal generation circuit 33, and the selection control circuit 32 generates the plurality of selection signals SY on the basis of the selection signal SELY and the trigger signal STY supplied from the signal generation circuit 33. Of the plurality of pixel circuits 20 in the pixel array 11, the pixel circuits 20 that are changed to the selected state by the selection signals SX and SY each perform an operation on the basis of the control signals TRG, OFG, and RST.

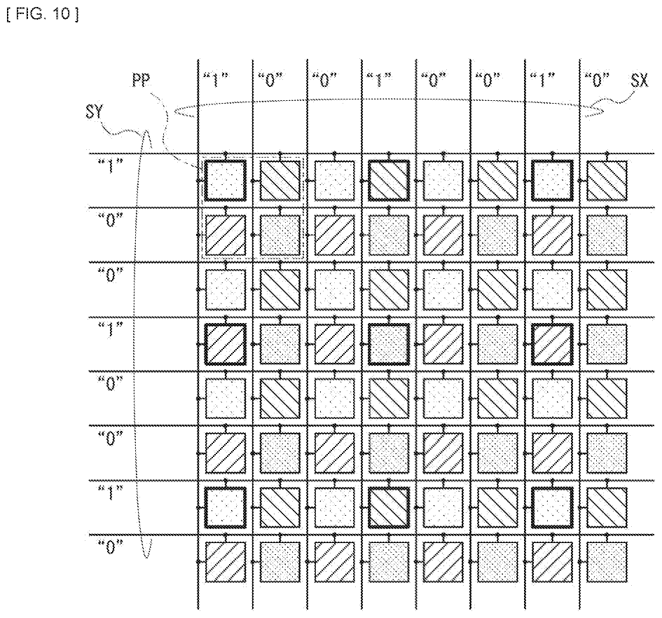

FIG. 8 illustrates an operation example of the pixel circuit 20 that is in the selected state, where (A) indicates a waveform of a synchronization signal XVS, (B) indicates a waveform of the control signal RST, (C) indicates a waveform of the control signal OFG, (D) indicates a waveform of the control signal TRG, (E) indicates a waveform of the selection signal SX, (F) indicates a waveform of the selection signal SY, (G) indicates a waveform of the control signal OFG0, (H) indicates a waveform of the control signal TRG0, (I) indicates a waveform of the reference signal REF, (J) indicates a waveform of the pixel signal SIG, and (K) indicates a waveform of the signal CMP. (I) and (J) of FIG. 8 illustrate the waveforms of the reference signal REF and the pixel signal SIG on the same voltage axis. As illustrated in (E) and (F) of FIG. 8, both the selection signals SX and SY are at the high level. Accordingly, the pixel circuit 20 are in the selected state.

First, at a timing t10, the pixel driver 15 changes the control signal OFG from the low level to the high level ((C) of FIG. 8). Both the selection signals SX and SY are at the high level ((E) and (F) of FIG. 8); therefore, the logic circuit 29 of the pixel circuit 20 outputs the control signal OFG as the control signal OFG0. Accordingly, the logic circuit 29 changes the control signal OFG0 from the low level to the high level in response to change in the control signal OFG ((G) of FIG. 8). Accordingly, in the pixel circuit 20, the transistor MN1 is turned on, and electric charge generated by the photodiode PD is discharged. The pixel driver 15 then changes the control signal OFG from the high level to the low level after a lapse of a predetermined time from the timing t10 ((C) of FIG. 8). Accordingly, the logic circuit 29 changes the control signal OFG0 from the high level to the low level ((G) of FIG. 8). This turns off the transistor MN1. Thus, the light exposure period TE in the pixel circuit 20 starts. Thereafter, the photodiode PD generates and accumulates electric charge in an amount corresponding to the amount of received light.

Next, at a timing t11, a pulse is generated in the synchronization signal XVS, and a frame period F starts ((A) of FIG. 8).

Next, at a timing t12, the pixel driver 15 changes the control signal RST from the low level to the high level ((B) of FIG. 8). Accordingly, in the pixel circuit 20, the transistor MN3 is turned on, the floating diffusion FD is reset, and the voltage of the pixel signal SIG is changed to the reset voltage Vreset ((J) of FIG. 8). The pixel driver 15 then changes the control signal RST from the high level to the low level after a lapse of a predetermined time from the timing t12 ((B) of FIG. 8). This turns off the transistor MN3.

Next, at a timing t13, the reference signal generator 12 changes the voltage of the reference signal REF from the reset voltage Vreset to a voltage V1 ((I) of FIG. 8). This causes the voltage of the reference signal REF to be higher than the voltage of the pixel signal SIG; therefore, the comparator circuit 22 changes the signal CMP to the high level ((K) of FIG. 8).

Next, in a period from a timing t14 to a timing t16 (P-phase period TP), the pixel circuit 20 performs AD conversion on the basis of the voltage (the reset voltage Vreset) of the pixel signal SIG. Specifically, at the timing t14, the reference signal generator 12 starts to decrease the voltage of the reference signal REF from the voltage V1 by a predetermined degree of change ((I) of FIG. 8). In addition, at the timing t14, the time code generator 13 starts an increment operation on the time code TC. Thus, the latch 23 is supplied with the time code TC that changes with a lapse of time.

At a timing t15, the voltage of the reference signal REF then falls below the voltage (reset voltage Vreset) of the pixel signal SIG ((I) and (J) of FIG. 8). Accordingly, the comparator circuit 22 changes the signal CMP from the high level to the low level ((K) of FIG. 8). The latch 23 latches the time code TC on the basis of transition of this signal CMP. The code value CP of the time code TC latched by the latch 23 is a code value corresponding to a length of time from the timing t14 to the timing t15, as well as a code value corresponding to the reset voltage Vreset.

At the timing t16, the reference signal generator 12 then stops changing the voltage of the reference signal REF at the end of the P-phase period TP ((I) of FIG. 8), and the time code generator 13 ends the increment operation on the time code TC.

Next, at a timing t17, the reference signal generator 12 changes the voltage of the reference signal REF to the voltage V1 ((I) of FIG. 8). This causes the voltage of the reference signal REF to be higher than the voltage of the pixel signal SIG; therefore, the comparator circuit 22 changes the signal CMP to the high level ((K) of FIG. 8). In addition, at the timing t17, the pixel driver 15 changes the control signal TRG from the low level to the high level ((D) of FIG. 8). Both the selection signals SX and SY are at the high level ((E) and (F) of FIG. 8); therefore, the logic circuit 28 of the pixel circuit 20 outputs the control signal TRG as the control signal TRG0. Accordingly, the logic circuit 28 changes the control signal TRG0 from the low level to the high level in response to change in the control signal TRG ((H) of FIG. 8). Accordingly, in the pixel circuit 20, the transistor MN2 is turned on, electric charge generated by the photodiode PD in the light exposure period TE is transferred to the floating diffusion FD, and the voltage of the pixel signal SIG is changed to the pixel voltage Vpix ((J) of FIG. 8). The pixel driver 15 then changes the control signal TRG from the high level to the low level after a lapse of a predetermined time from the timing t17 ((D) of FIG. 8). Accordingly, the logic circuit 28 changes the control signal TRG0 from the high level to the low level ((H) of FIG. 8). This turns off the transistor MN2. Thus, the light exposure period TE ends.

Next, in a period from a timing t18 to a timing t20 (D-phase period TD), the pixel circuit 20 performs AD conversion on the basis of the voltage (pixel voltage Vpix) of the pixel signal SIG. Specifically, at the timing t18, the reference signal generator 12 starts to decrease the voltage of the reference signal REF from the voltage V1 by a predetermined degree of change ((I) of FIG. 8). In addition, at the timing t18, the time code generator 13 starts an increment operation on the time code TC. Thus, the latch 23 is supplied with the time code TC that changes with a lapse of time.

At a timing t19, the voltage of the reference signal REF then falls below the voltage (pixel voltage Vpix) of the pixel signal SIG ((I) and (J) of FIG. 8). Accordingly, the comparator circuit 22 changes the signal CMP from the high level to the low level ((K) of FIG. 8). The latch 23 latches the time code TC on the basis of transition of this signal CMP. The code value CD of the time code TC latched by the latch 23 is a code value corresponding to a length of time from the timing t18 to the timing t19, as well as a code value corresponding to the pixel voltage Vpix.

At the timing t20, the reference signal generator 12 then stops changing the voltage of the reference signal REF at the end of the D-phase period TD ((I) of FIG. 8), and the time code generator 13 ends the increment operation on the time code TC.

In a period from the timing t20 to a timing t22, the latch 23 then supplies the code values CP and CD generated by the pixel circuit 20 to the signal processor 16.

Next, at a timing t21, the pixel driver 15 changes the control signal OFG from the low level to the high level ((C) of FIG. 8). Both the selection signals SX and SY are at the high level ((E) and (F) of FIG. 8); therefore, the logic circuit 29 of the pixel circuit 20 outputs the control signal OFG as the control signal OFG0. Accordingly, the logic circuit 29 changes the control signal OFG0 from the low level to the high level in response to change in the control signal OFG ((G) of FIG. 8). Accordingly, in the pixel circuit 20, the transistor MN1 is turned on, and electric charge generated by the photodiode PD is discharged. The pixel driver 15 then changes the control signal OFG from the high level to the low level after a lapse of a predetermined time from the timing t21 ((C) of FIG. 8). Accordingly, the logic circuit 29 changes the control signal OFG0 from the high level to the low level ((G) of FIG. 8). This turns off the transistor MN1. Thus, the next light exposure period TE starts.

The pixel circuit 20 that is in the selected state repeats such an operation from the timing t11 to the timing t22.

Next, an operation of the pixel circuit 20 that is in the unselected state is described in detail.

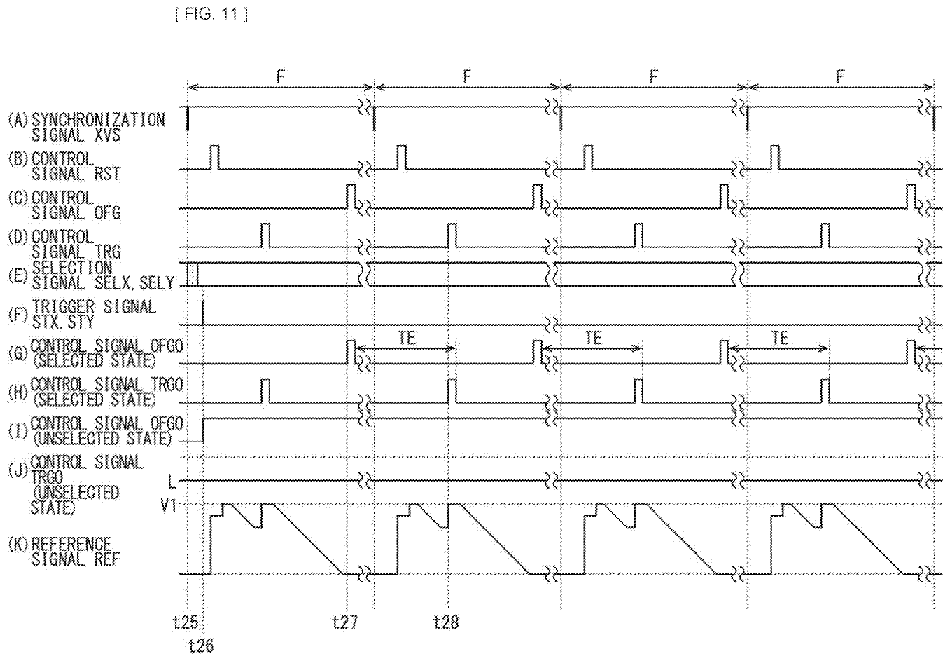

FIG. 9 illustrates an operation example of the pixel circuit 20 that is in the unselected state, where (A) indicates a waveform of the synchronization signal XVS, (B) indicates a waveform of the control signal RST, (C) indicates a waveform of the control signal OFG, (D) indicates a waveform of the control signal TRG, (E) indicates a waveform of the selection signal SX, (F) indicates a waveform of the selection signal SY, (G) indicates a waveform of the control signal OFG0, (H) indicates a waveform of the control signal TRG0, and (I) indicates a waveform of the reference signal REF. In this example as illustrated in (E) and (F) of FIG. 9, both the selection signals SX and SY are at the low level. Accordingly, the pixel circuit 20 is in the unselected state. It is to be noted that, in this example, both the selection signals SX and SY are at the low level; however, the pixel circuit 20 is changed to the unselected state in a case where at least one of the selection signal SX or SY is at the low level.

The reference signal generator 12 supplies the reference signal REF to the pixel circuit 20 ((I) of FIG. 9). In addition, the pixel driver 15 supplies the control signals RST, OFG, and TRG to the pixel circuit 20 ((B), (C), and (D) of FIG. 9). Both the selection signals SX and SY are at the low level ((E) and (F) of FIG. 8); therefore, in the pixel circuit 20, the logic circuit 29 maintains the control signal OFG0 at the high level, and the logic circuit 28 maintains the control signal TRG0 at the low level ((G) and (H) of FIG. 9). The control signal OFG0 is at the high level; therefore, in the pixel circuit 20, the transistor MN1 is maintained on, and electric charge generated by the photodiode PD is discharged. In addition, the control signal TRG0 is at the low level; therefore, in the pixel circuit 20, the transistor MN2 is maintained off. Thus, the pixel circuit 20 that is in the unselected state does not perform a light exposure operation.

The signal processor 16 performs predetermined image processing on the basis of the code values CP and CD generated by each of a plurality of pixel circuits 20 that is in the selected state. For example, the signal processor 16 generates a pixel value with use of the principle of correlated double sampling on the basis of the code value CP and the code value CD. Specifically, for example, the signal processor 16 subtracts the code value CP from the code value CD to generate a pixel value. In addition, the signal processor 16 performs black level correction processing for correcting a black level, and the like. Thus, the signal processor 16 generates the image signal Spic.

In the imaging device 1, it is possible to set each of the plurality of pixel circuits 20 to the selected state or the unselected state with use of the plurality of selection signals SX and the plurality of selection signals SY. This makes it possible to enhance a degree of freedom in an operation in the imaging device 1. The operation of the imaging device 1 is described in detail below with reference to some examples.

### (Operation Example E11)

The imaging device 1 performs an imaging operation with use of all the pixels P in the pixel array 11, which makes it possible to obtain a captured image having high resolution.

Specifically, the selection control circuit 31 sets all the plurality of selection signals SX to “1”, and the selection control circuit 32 sets all the plurality of selection signals SY to “1”. Accordingly, all the pixels P (pixel circuits 20) in the pixel array 11 are changed to the selected state. Thus, in all the pixel circuits 20, the logic circuits 28 each output the control signal TRG as the control signal TRG0, and the logic circuits 29 each output the control signal OFG as the control signal OFG0.

Accordingly, all the pixel circuits 20 in the pixel array 11 each perform the light exposure operation as illustrated in FIG. 8, and generate the pixel signal SIG including the pixel voltage Vpix corresponding to the amount of received light. Thereafter, the pixel circuits 20 each perform AD conversion on the basis of the pixel signal SIG to generate the code values CP and CD.

The signal processor 16 generates image data of a captured image on the basis of the code values CP and DC generated in the plurality of pixel circuits 20 that is in the selected state. This makes it possible for the imaging device 1 to obtain a captured image having high resolution.

### (Operation Example E12)

The imaging device 1 performs an imaging operation with use of some pixels P of the plurality of pixels P in the pixel array 11, which makes it possible to obtain a captured image having low resolution in which the pixel values are thinned out. This operation is described in detail below.

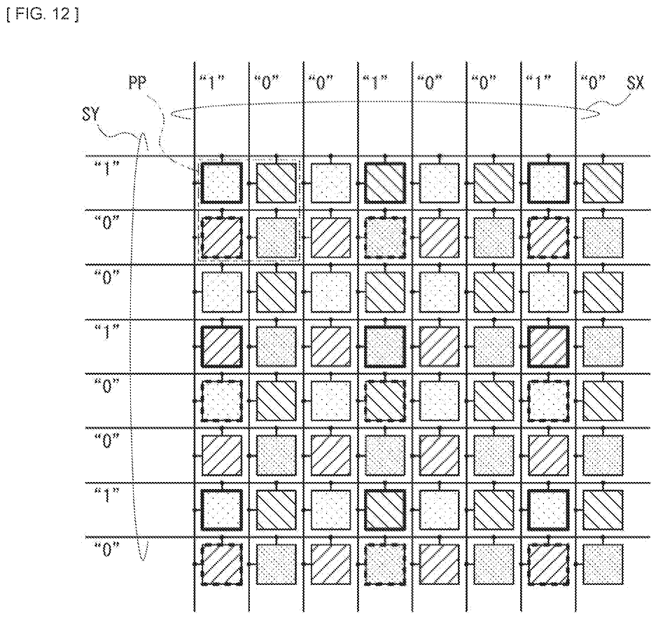

FIG. 10 illustrates an example of the pixels P related to the imaging operation in the pixel array 11. In FIG. 10, the pixels P each indicated by a thick line indicate the pixels P that are in the selected state, and the other pixels P indicate the pixels P that are in the unselected state.

As illustrated in FIG. 10, the selection control circuit 31 sets the plurality of selection signals SX such that “1” appears at a ratio of one to three such as . . . , “1”, “0”, “0”, “1”, “0”, “0”, . . . . Likewise, the selection control circuit 32 sets the plurality of selection signals SY such that “1” appears at a ratio of one to three such as . . . , “1”, “0”, “0”, “1”, “0”, “0”, . . . . Accordingly, the pixels P supplied with the selection signal SX that is at the high level and the selection signals SY that is at the high level are changed to the selected state, and the other pixels P are changed to the unselected state. In this example, the pixels P are changed to the selected state at a ratio of one to three in the lateral direction (horizontal direction) in accordance with the plurality of selection signals SX, and the pixels P are changed to the selected state at a ratio of one to three in the longitudinal direction (vertical direction) in accordance with the plurality of selection signals SY. Thus, in the pixel array 11, the pixels P (pixel circuits 20) are changed to the selected state at a ratio of one to nine.

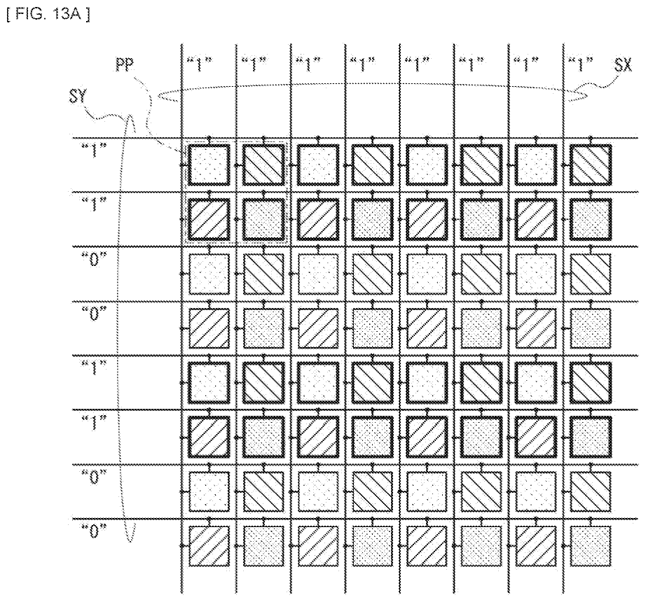

FIG. 11 illustrates an operation example of the pixel circuits 20 in the operation example E12, where (A) indicates a waveform of the synchronization signal XVS, (B) indicates a waveform of the control signal RST, (C) indicates a waveform of the control signal OFG, (D) indicates a waveform of the control signal TRG, (E) indicates the selection signals SELX and SELY, (F) indicates waveforms of the trigger signals STX and STY, (G) indicates a waveform of the control signal OFG0 in the pixel circuit 20 that is in the selected state, (H) indicates a waveform of the control signal TRG0 in the pixel circuit 20 that is in the selected state, (I) indicates a waveform of the control signal OFG0 in the pixel circuit 20 that is in the unselected state, (J) indicates a waveform of the control signal TRG0 in the pixel circuit 20 that is in the unselected state, and (K) indicates a waveform of the reference signal REF.

For example, in a case of setting to this operation mode, first, in a frame period F starting from a timing t25, the signal generation circuit 33 of the pixel driver 15 supplies the selection signal SELX that is a serial signal to the selection control circuit 31, and supplies the selection signal SELY that is a serial signal to the selection control circuit 32 ((E) of FIG. 11).

Thereafter, at a timing t26 after the signal generation circuit 33 finishes supplying the selection signals SELX and SELY, the signal generation circuit 33 generates the trigger signals STX and STY ((F) of FIG. 11). Accordingly, the selection control circuit 31 supplies the plurality of selection signals SX corresponding to the selection signal SELX to the pixel array 11 via the plurality of selection signal lines LX, and the selection control circuit 32 supplies the plurality of selection signals SY corresponding to the selection signal SELY to the pixel array 11 via the plurality of selection signal lines LY.

Of the plurality of pixel circuits 20 in the pixel array 11, the pixel circuits 20 in which both the selection signals SX and SY are set at the high level are set to the selected state. In each of the pixel circuits 20 that are in the selected state, the logic circuit 28 outputs the control signal TRG as the control signal TRG0 ((D) and (H) of FIG. 11), and the logic circuit 29 outputs the control signal OFG as the control signal OFG0 ((C) and (G) of FIG. 11). For example, the logic circuit 29 changes the control signal OFG0 from the low level to the high level at a timing t27, and changes the control signal OFG0 from the high level to the low level after a lapse of a predetermined time from the timing t27 ((G) of FIG. 11). In addition, the logic circuit 28 changes the control signal TRG0 from the low level to the high level at a timing t28, and changes the control signal TRG0 from the high level to the low level after a lapse of a predetermined time from the timing t28 ((H) of FIG. 11). Thus, the light exposure period TE is set. The pixel circuits 20 that are in the selected state each perform a light exposure operation on the basis of such control signals TRG0 and OFG0, and generate the pixel signal SIG including the pixel voltage Vpix corresponding to the amount of received light as illustrated in FIG. 8. Thereafter, the pixel circuits 20 each perform AD conversion on the basis of the pixel signal SIG to generate the code values CP and CD.

In addition, of the plurality of pixel circuits 20 in the pixel array 11, the pixel circuits 20 in which at least one of the selection signal SX or SY is set at the low level are set to the unselected state. In each of the pixel circuits 20 that are in the unselected state, the logic circuit 28 maintains the control signal TRG0 at the low level ((J) of FIG. 11), and the logic circuit 29 maintains the control signal OFG0 at the high level ((I) of FIG. 11). Accordingly, the pixel circuits 20 that are in the unselected state do not perform the light exposure operation.

The signal processor 16 generates image data of a captured image on the basis of the code values CP and CD generated in a plurality of pixel circuits 20 that is in the selected state. This makes it possible for the imaging device 1 to obtain a captured image having low resolution.

### (Operation Example E13)

In a case where the imaging device 1 performs an imaging operation with use of some pixels P of the plurality of pixels P in the pixel array 11 as with the operation example E12, it is possible to reduce a noise component included in a pixel value with use of the code values CP and CD related to the pixel circuits 20 that are in the unselected state. This operation is described in detail below.

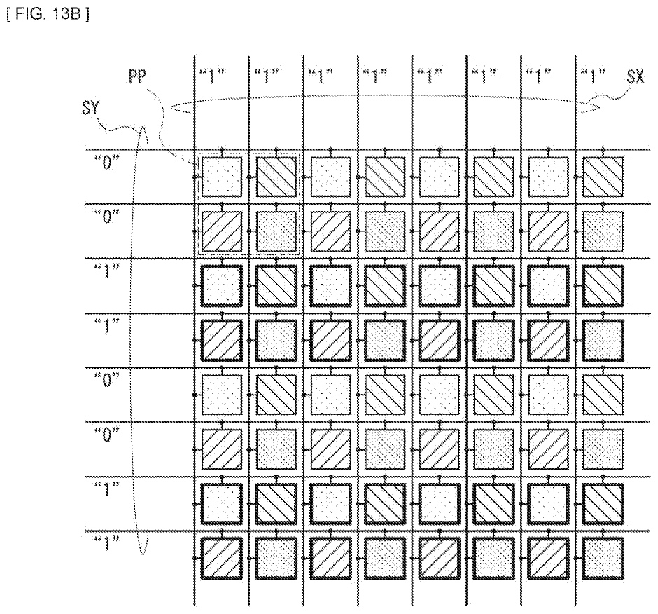

FIG. 12 illustrates an example of the pixels P related to the imaging operation in the pixel array 11. In FIG. 12, the pixels P each indicated by a thick line indicate the pixels P that are in the selected state, and the other pixels P indicate the pixels P that are in the unselected state. In this example, in the pixel array 11, as with a case of the operation example E12 (FIG. 10), the pixels P are changed to the selected state at a ratio of one to nine. The pixel circuits 20 related to the pixels P that are in the selected state each perform the light exposure operation to generate the pixel signal SIG including the pixel voltage Vpix corresponding to the amount of received light, and performs AD conversion on the basis of the pixel signal SIG to generate the code values CP and CD.

In contrast, the pixels P that are in the unselected state do not perform the light exposure operation. For example, in each of the pixel circuits 20 related to the pixels P each of which is indicated by a broken line and is in the unselected state and adjacent to the pixel P that is the selected state, as illustrated in (I) and (J) of FIG. 11, the control signal OFG0 is maintained at the high level, and the control signal TRG0 is maintained at the low level. The control signal TRG0 is maintained at the low level, which causes the transistor MN2 to be maintained off. Accordingly, the voltage of the floating diffusion FD is maintained at the reset voltage Vreset, which causes the pixel signal SIG to be maintained at the reset voltage Vreset. The pixel circuits 20 each perform AD conversion on the basis of such a pixel signal SIG to generate the code values CP and CD.

The signal processor 16 subtracts the code value CP from the code value CD on the basis of, for example, the code values CP and CD supplied from the pixel circuit 20 that is in the selected state to generate a pixel value. Likewise, the signal processor 16 subtracts the code value CP from the code value CD on the basis of, for example, the code values CP and CD supplied from the pixel circuit 20 that is in the unselected state to generate a pixel value. Thereafter, the signal processor 16 performs subtraction processing to subtract the pixel value related to the pixel circuit 20 that is in the unselected state from the pixel value related to the pixel circuit 20 that is in the selected state, on the basis of, for example, the pixel values obtained by the pixel circuit 20 that is in the selected state and the pixel circuit 20 that is in the unselected state. These pixel circuits 20 are adjacent to each other. Thus, it is possible to reduce a noise component included in the pixel value in the imaging device 1.

In other words, in an electronic apparatus including the imaging device 1, various kinds of noise may occur. Noise is superimposed on the pixel signals SIG in the plurality of pixel circuits 20 in the pixel array 11. For example, it is expected that amounts of superimposed noise in two adjacent pixel circuits 20 are substantially equal. Accordingly, performing such subtraction processing on the basis of the pixel values obtained by the adjacent pixel circuits 20 of which one is in the selected state while the other is in the unselected state makes it possible to reduce a noise component included in the pixel value.

### (Operation Example E14)

The imaging device 1 selects the plurality of pixels P in the pixel array 11 in pixel line units to perform an imaging operation, which makes it possible to perform an interlace operation. This operation is described in detail below.

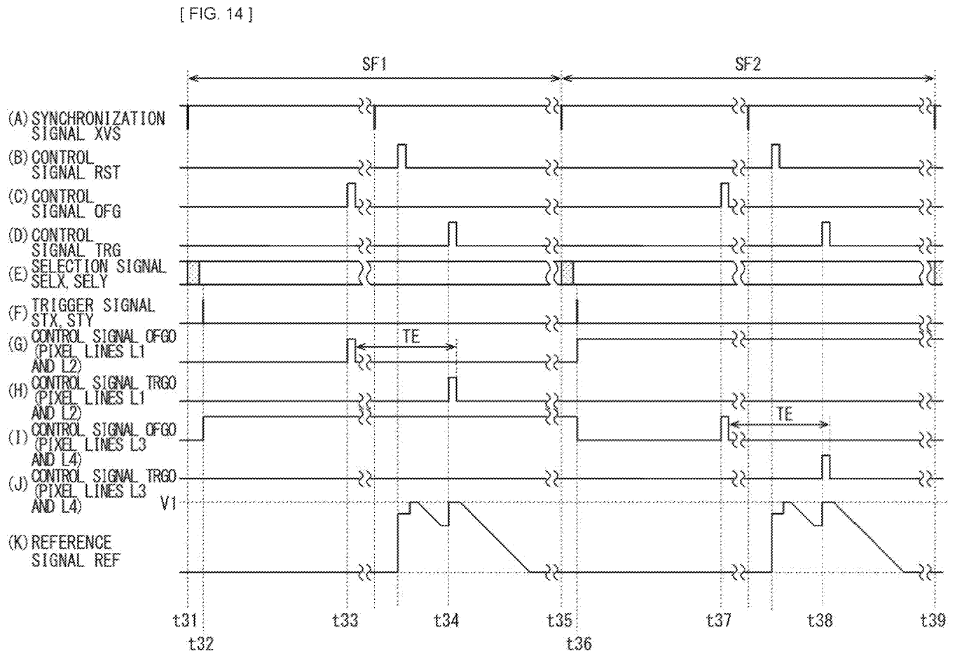

FIGS. 13A and 13B each illustrate an example of the pixels P related to the imaging operation in the pixel array 11. In FIGS. 13A and 13B, the pixels P each indicated by a thick line indicate the pixels P that are in the selected state, and the other pixels P indicate the pixels P that are in the unselected state.

In FIG. 13A, the selection control circuit 31 sets all the plurality of selection signals SX to “1”. In addition, the selection control circuit 32 sets the plurality of selection signals SY such that two “1” and two “0” are repeated, such as . . . , “1”, “1”, “0”, “0”, “1”, “1”, “0”, “0”, . . . . The pixels P supplied with the selection signal SX that is at the high level and the selection signal SY that is at the high level are changed to the selected state, and the other pixels P are changed to the unselected state. In this example, in FIG. 13A, the pixels P belonging to first and second pixel lines from top are changed to the selected state, the pixels P belonging to third and fourth pixel lines from top are changed to the unselected state, the pixels P belonging to fifth and sixth pixel lines from top are changed to the selected state, and the pixels P belonging to seventh and eighth pixel lines from top are changed to the unselected state.

In FIG. 13B, the selection control circuit 31 sets all the plurality of selection signals SX to “1”. In addition, the selection control circuit 32 sets the plurality of selection signals SY such that two “0” and two “1” are repeated, such as . . . , “0”, “0”, “1”, “1”, “0”, “0”, “1”, “1”, . . . . The plurality of selection signals SY in FIG. 13B is inverted signals of the plurality of selection signals SY in FIG. 13A. The pixels P supplied with the selection signal SX that is at the high level and the selection signal SY that is at the high level are changed to the selected state, and the other pixels P are changed to the unselected state. In this example, in FIG. 13B, the pixels P belonging to the first and second pixel lines from top are changed to the unselected state, the pixels P belonging to the third and fourth pixel lines from top are changed to the selected state, the pixels P belonging to the fifth and sixth pixel lines from top are changed to the unselected state, and the pixels P belonging to the seventh and eighth pixel lines from top are changed to the selected state.

In the interlace operation, the imaging device 1 alternately repeats a state illustrated in FIG. 13A and a state illustrated in FIG. 13B.

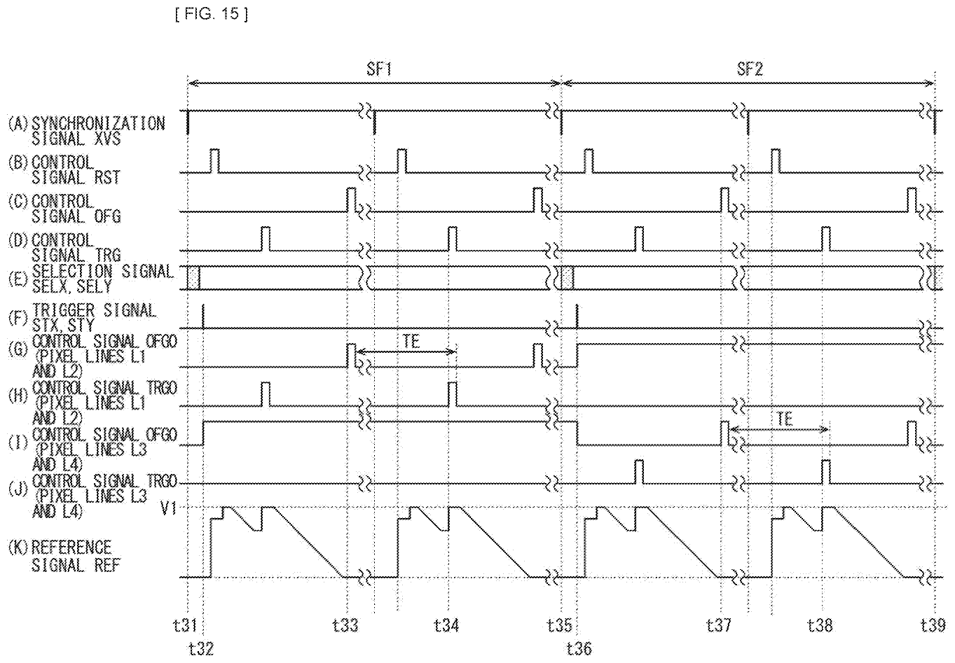

FIG. 14 illustrates an operation example of the pixel circuits 20 in the operation example E14, where (A) indicates a waveform of the synchronization signal XVS, (B) indicates a waveform of the control signal RST, (C) indicates a waveform of the control signal OFG, (D) indicates a waveform of the control signal TRG, (E) indicates the selection signals SELX and SELY, (F) indicates waveforms of the trigger signals STX and STY, (G) indicates a waveform of the control signal OFG0 in the pixel circuits 20 belonging to a first pixel line L1 and a second pixel line L2, (H) indicates a waveform of the control signal TRG0 in the pixel circuits 20 belonging to the first pixel line L1 and the second pixel line L2, (I) indicates a waveform of the control signal OFG0 in the pixel circuits 20 belonging to a third pixel line L3 and a fourth pixel line L4, (J) indicates a waveform of the control signal TRG0 in the pixel circuits 20 belonging to the third pixel line L3 and the fourth pixel line L4, and (K) indicates a waveform of the reference signal REF.

For example, in the operation example E14, in a period (sub-frame period SF1) from a timing t31 to a timing t35, the plurality of pixels P are set as illustrated in FIG. 13A, and in a period (sub-frame period SF2) from the timing t35 to a timing t39, the plurality of pixels P are set as illustrated in FIG. 13B.

First, at the timing t31, the signal generation circuit 33 of the pixel driver 15 supplies the selection signal SELX that is a serial signal to the selection control circuit 31, and supplies the selection signal SELY that is a serial signal to the selection control circuit 32 ((E) of FIG. 14).

Thereafter, at a timing t32 after the signal generation circuit 33 finishes supplying the selection signals SELX and SELY, the signal generation circuit 33 generates the trigger signals STX and STY ((F) of FIG. 14). Accordingly, the selection control circuit 31 supplies the plurality of selection signals SX corresponding to the selection signal SELX to the pixel array 11 via the plurality of selection signal lines LX, and the selection control circuit 32 supplies the plurality of selection signals SY corresponding to the selection signal SELY to the pixel array 11 via the plurality of selection signal lines LY.

Accordingly, as illustrated in FIG. 13A, for example, the pixels P (pixel circuits 20) belonging to the first pixel line L1 and the second pixel line L2 are set to the selected state, and the pixels P (pixel circuits 20) belonging to the third pixel line L3 and the fourth pixel line L4 are set to the unselected state.

In each of the pixel circuits 20 belonging to the pixel lines L1 and L2, the logic circuit 28 outputs the control signal TRG as the control signal TRG0 ((D) and (H) of FIG. 14), and the logic circuit 29 outputs the control signal OFG as the control signal OFG0 ((C) and (G) of FIG. 14). For example, the logic circuit 29 changes the control signal OFG0 from the low level to the high level at a timing t33, and changes the control signal OFG0 from the high level to the low level after a lapse of a predetermined time from the timing t33 ((G) of FIG. 14). In addition, the logic circuit 28 changes the control signal TRG0 from the low level to the high level at a timing t34, and changes the control signal TRG0 from the high level to the low level after a lapse of a predetermined time from the timing t34 ((H) of FIG. 14). Thus, the light exposure period TE is set. The pixel circuits 20 belonging to the pixel lines L1 and L2 each perform the light exposure operation on the basis of such control signals TRG0 and OFG0, and generate the pixel signal SIG including the pixel voltage Vpix corresponding to the amount of received light as illustrated in FIG. 8. Thereafter, the pixel circuits 20 each perform AD conversion on the basis of the pixel signal SIG to generate the code values CP and CD.

In addition, in each of the pixel circuits 20 belonging to the pixel lines L3 and L4, the logic circuit 28 maintains the control signal TRG0 at the low level ((J) of FIG. 14), and the logic circuit 29 maintains the control signal OFG0 at the high level ((I) of FIG. 14). Accordingly, the pixel circuits 20 belonging to the pixel lines L3 and L4 do not perform the light exposure operation.

Next, at the timing t35, the signal generation circuit 33 of the pixel driver 15 supplies the selection signal SELX that is a serial signal to the selection control circuit 31, and supplies the selection signal SELY that is a serial signal to the selection control circuit 32 ((E) of FIG. 14).

Thereafter, at a timing t36 after the signal generation circuit 33 finishes supplying the selection signals SELX and SELY, the signal generation circuit 33 generates the trigger signals STX and STY ((F) of FIG. 14). Accordingly, the selection control circuit 31 supplies the plurality of selection signals SX corresponding to the selection signal SELX to the pixel array 11 via the plurality of selection signal lines LX, and the selection control circuit 32 supplies the plurality of selection signals SY corresponding to the selection signal SELY to the pixel array 11 via the plurality of selection signal lines LY.

Accordingly, as illustrated in FIG. 13B, for example, the pixels P (pixel circuits 20) belonging to the first pixel line L1 and the second pixel line L2 are set to the unselected state, and the pixels P (pixel circuits 20) belonging to the third pixel line L3 and the fourth pixel line L4 are set to the selected state.

In each of the pixel circuits 20 belonging to the pixel lines L3 and L4, the logic circuit 28 outputs the control signal TRG as the control signal TRG0 ((D) and (J) of FIG. 14), and the logic circuit 29 outputs the control signal OFG as the control signal OFG0 ((C) and (I) of FIG. 14). For example, the logic circuit 29 changes the control signal OFG0 from the low level to the high level at a timing t37, and changes the control signal OFG0 from the high level to the low level after a lapse of a predetermined time from the timing t37 ((I) of FIG. 14). In addition, the logic circuit 28 changes the control signal TRG0 from the low level to the high level at a timing t38, and changes the control signal TRG0 from the high level to the low level after a lapse of a predetermined time from the timing t38 ((J) of FIG. 14). Thus, the light exposure period TE is set. The pixel circuits 20 belonging to the pixel lines L3 and LA each perform the light exposure operation on the basis of such control signals TRG0 and OFG0, and generate the pixel signal SIG including the pixel voltage Vpix corresponding to the amount of received light as illustrated in FIG. 8. Thereafter, the pixel circuits 20 each perform AD conversion on the basis of the pixel signal SIG to generate the code values CP and CD.

In addition, in each of the pixel circuits 20 belonging to the pixel lines L1 and L2, the logic circuit 28 maintains the control signal TRG0 at the low level ((H) of FIG. 14), and the logic circuit 29 maintains the control signal OFG0 at the high level ((G) of FIG. 14). Accordingly, the pixel circuits 20 belonging to the pixel lines L1 and L2 do not perform the light exposure operation. The imaging device 1 alternately repeats an operation from the timing t31 to the timing t35 and an operation from the timing t35 to the timing t39.

The signal processor 16 generates image data of a captured image on the basis of the code values CP and CD generated in a plurality of pixel circuits 20 that is in the selected state. This makes it possible for the imaging device 1 to perform the interlace operation.

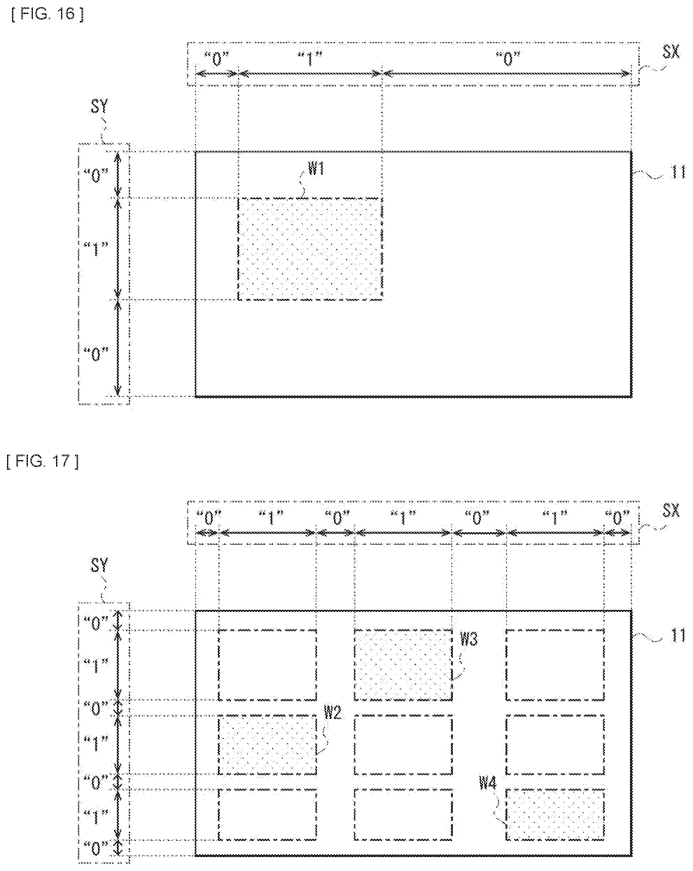

It is to be noted that, in this example, the control signals RST, OFG, and TRG, and the reference signal REF as illustrated in FIG. 14 are used, but this is not limitative. As illustrated in FIG. 15, the control signals RST, OFG, and TRG, and the reference signal REF used in the operation example E11 may be used.

### (Operation Example E15)

The imaging device 1 performs an imaging operation with use of a plurality of pixels P belonging to a certain image region of the plurality of pixels P in the pixel array 11, which makes it possible to obtain a so-called ROI (Region of Interest) image. This operation is described in detail below.

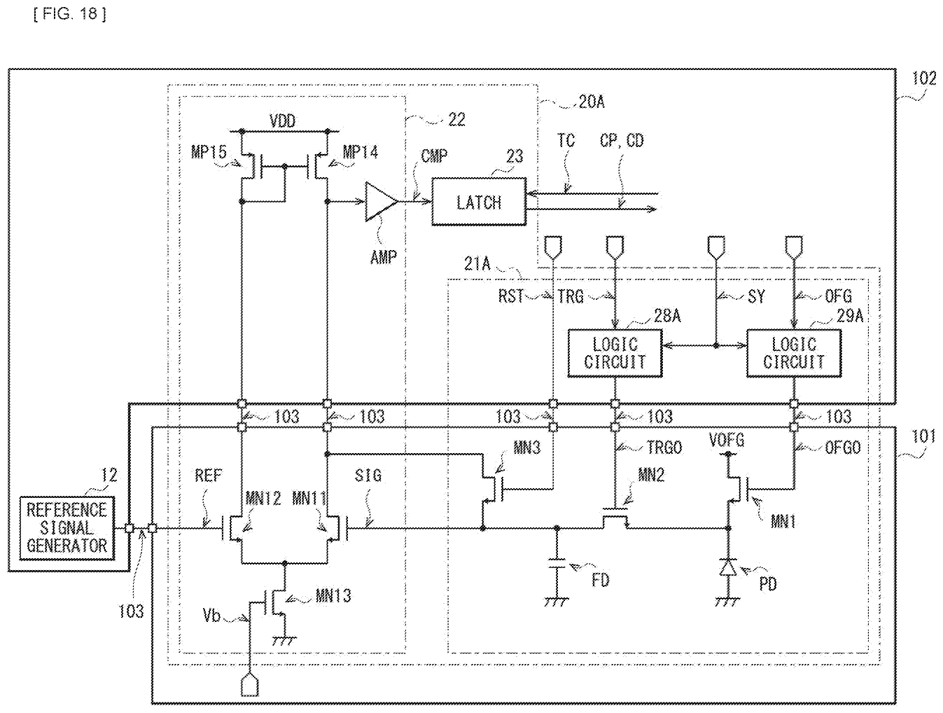

FIG. 16 illustrates an example of a region of the plurality of pixels P related to the imaging operation in the pixel array 11. A region W1 indicates a region where a ROI image is desired to be obtained in the pixel array 11.

As illustrated in FIG. 16, the selection control circuit 31 sets the selection signals SX related to the region W1 of the plurality of selection signals SX to “1”, and sets the other election signals SX to “0”. Likewise, the selection control circuit 32 sets the selection signals SY related to the region W1 of the plurality of selection signals SY to “1”, and sets the other selection signals SY to “0”. Thus, in the pixel array 11, a plurality of pixels P belonging to the region W1 is changed to the selected state.

The pixel circuits 20 corresponding to the pixels P belonging to the region W1 each generate the pixel signal SIG including the pixel voltage Vpix corresponding to the amount of received light, and perform AD conversion on the basis of the pixel signal SIG to generate the code values CP and CD. The signal processor 16 generates image data of a captured image on the basis of the code values CP and CD generated in a plurality of pixel circuits 20 belonging to the region W1. This makes it possible for the imaging device 1 to obtain a ROI image.

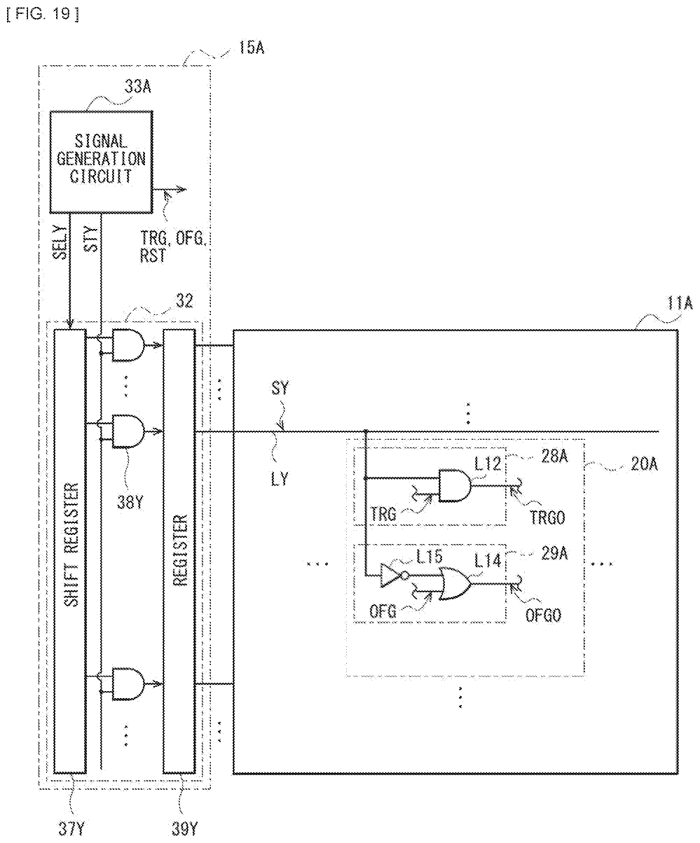

FIG. 17 illustrates another example of regions of the plurality of pixels P related to the imaging operation in the pixel array 11. Regions W2, W3, and W4 each indicate a region where a ROI image is desired to be obtained in the pixel array 11. In this example, in the pixel array 11, the region W2 is set at the lower left, the region W3 is set in an upper middle in a left-right direction, and the region W3 is set at the lower right.

As illustrated in FIG. 17, the selection control circuit 31 sets the selection signals SX related to the regions W2, W3, and W4 of the plurality of selection signals SX to “1”, and sets the other selection signals SX to “0”. In this example, the regions W2 to W4 are not superimposed on each other in the lateral direction; therefore, the selection signals SX belonging to three portions corresponding to three regions W2 to W4 of the plurality of selection signals SX are set to “1”. Likewise, the selection control circuit 32 sets the selection signals SY related to the regions W2, W3, and W4 of the plurality of selection signals SY to “1”, and sets the other selection signals SY to “O”. In this example, the regions W2 to W4 are not superimposed on each other in the longitudinal direction; therefore, the selection signals SY belonging to the three portions corresponding to the three regions W2 to W4 of the plurality of selection signals SY are set to “1”. As a result, in the pixel array 11, nine regions in which the pixel circuits 20 are changed to the selected state are set.

The pixel circuits 20 corresponding to the pixels P belonging to these nine regions each generate the pixel signal SIG including the pixel voltage Vpix corresponding to the amount of received light, and perform AD conversion on the basis of the pixel signal SIG to generate the code values CP and CD. The signal processor 16 generates image data of a captured image on the basis of the code values CP and CD generated in a plurality of pixel circuits 20 belonging to the three regions W2 to W4 of the code values CP and CD generated in these pixel circuits 20. This makes it possible for the imaging device 1 to obtain three ROI images.

Thus, the imaging device 1 includes the signal generation circuit 33 that generates a first control signal (control signal TRG), a first selection control circuit (selection control circuit 32) that generates a plurality of first selection signals (selection signals SY), and the plurality of pixel circuits 20. Each of the plurality of pixel circuits 20 includes the photodiode PD that generates electric charge corresponding to the amount of received light, the floating diffusion FD that accumulates the electric charge generated by the photodiode PD, a first switch (transistor MN2) that couples the photodiode PD to the floating diffusion FD by being turned on, a first circuit (logic circuit 28) that controls an operation of the first switch (transistor MN2) on the basis of one of the plurality of first selection signals (selection signals SY) and the first control signal (control signal TRG), and the comparator circuit 22 that compares the pixel signal SIG including a voltage in the floating diffusion FD with the reference signal REF having a ramp waveform. Accordingly, in the imaging device 1, for example, as with the operation example E11, it is possible to change all the pixels P to the selected state, or as with the operation example E14, it is possible to change the pixels P to the selected state or the unselected state in pixel line units, which makes it possible to enhance a degree of freedom in the imaging operation.

In addition, in the imaging device 1, the signal generation circuit 33 generates a second control signal (control signal OFG), and each of the plurality of pixel circuits 20 is supplied with a first signal that is one of the plurality of first selection signals (selection signals SY). The first circuit (logic circuit 28) controls the operation of the first switch (transistor MN2) on the basis of the first signal (selection signal SY) and the first control signal (control signal TRG). Each of the plurality of pixel circuits 20 includes a second switch (transistor MN1) that is able to apply a predetermined voltage VOFG to the photodiode PD by being turned on, and a second circuit (logic circuit 29) that controls an operation of the second switch (transistor MN1) on the basis of the first signal (selection signal SY) and the second control signal (control signal OFG). This makes it possible to enhance the degree of freedom in the imaging operation, for example, while appropriately discharging electric charge of the photodiode PD.

In addition, the imaging device 1 includes selection control circuit (selection control circuit 31) that generates a plurality of second selection signals (selection signals SX). Further, each of the plurality of pixel circuits 20 is supplied with a second signal that is one of the plurality of second selection signal (selection signal SX), the first circuit (logic circuit 28) controls the operation of the first switch (transistor MN2) on the basis of the first signal (selection signal SY), the second signal (selection signal SX), and the first control signal (control signal TRG), and the second circuit (logic circuit 29) controls the operation of the second switch (transistor MN1) on the basis of the first signal (selection signal SY), the second signal (selection signal SX), and the second control signal (control signal OFG). This makes it possible to change the pixel P to the selected state or the unselected state in units of pixels P, for example, as with the operation examples E12, E13, and E15, which makes it possible to enhance the degree of freedom in the imaging operation.

### [Effects]

As described above, in the present embodiment, a signal generation circuit that generates the first control signal, the first selection control circuit that generates the plurality of first selection signals, and a plurality of pixel circuits are provided. Each of the plurality of pixel circuits includes a photodiode that generates electric charge corresponding to the amount of received light, a floating diffusion that accumulates the electric charge generated by the photodiode, the first switch that couples the photodiode to the floating diffusion by being turned on, the first circuit that controls the operation of the first switch on the basis of one of the plurality of first selection signals and the first control signal, and a comparator circuit that compares a pixel signal including a voltage in the floating diffusion with a reference signal having a ramp waveform. This makes it possible to enhance a degree of freedom in an imaging operation.

In the present embodiment, the signal generation circuit generates the second control signal, and each of the plurality of pixel circuits is supplied with the first signal that is one of the plurality of first selection signals. The first circuit controls the operation of the first switch on the basis of the first signal and the first control signal. Each of the plurality of pixel circuits includes the second switch that is able to apply a predetermined voltage to the photodiode by being turned on, and the second circuit that controls the operation of the second switch on the basis of the first signal and the second control signal. This makes it possible to enhance the degree of freedom in the imaging operation while appropriately discharging electric charge of the photodiode.

In the present embodiment, the second selection control circuit that generates the plurality of second selection signals is provided. Further, each of the plurality of pixel circuits is supplied with the second signal that is one of the plurality of second selection signals, and the first circuit controls the operation of the first switch on the basis of the first signal, the second signal, and the first control signal, and the second circuit controls the operation of the second switch on the basis of the first signal, the second signal, and the second control signal. This makes it possible to enhance the degree of freedom in the imaging operation.

### Modification Example 1

In the embodiment described above, both the selection control circuit 31 that generates the plurality of selection signals SX and the selection control circuit 32 that generates the plurality of selection signals SY are provided, but this is not limitative. For example, only one of selection control circuits 31 and 32 may be provided. The present modification example is described in detail below.

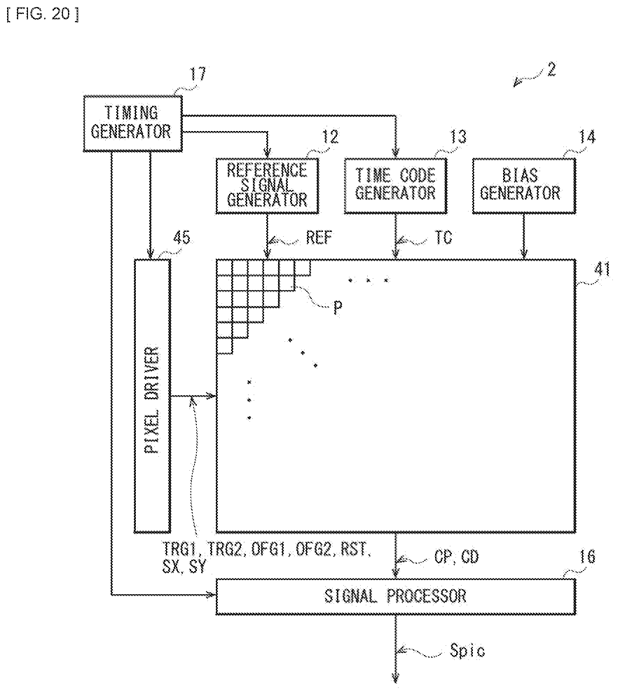

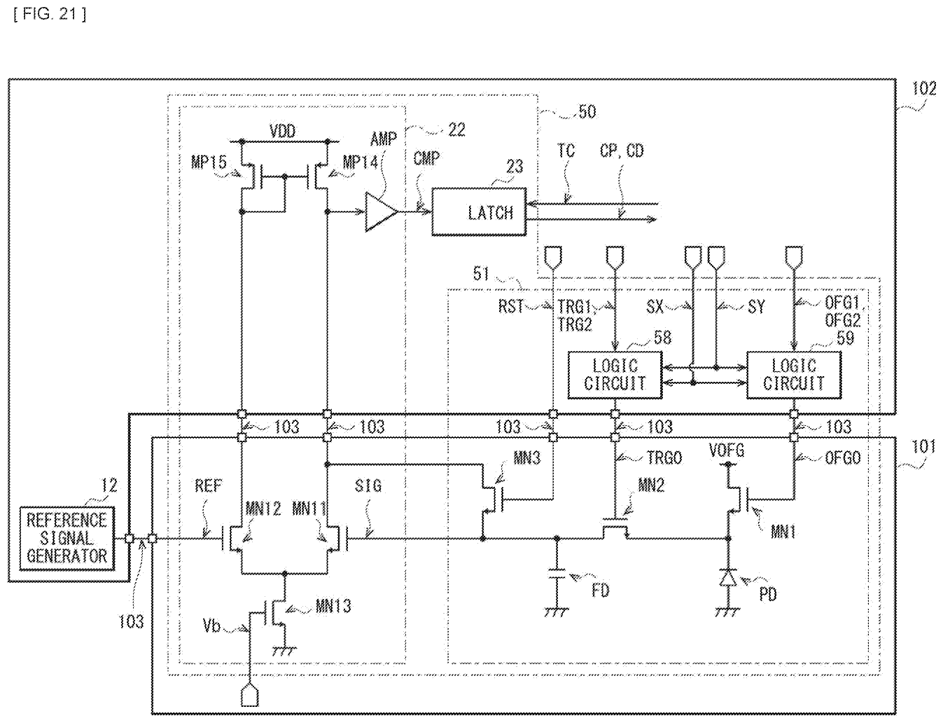

FIG. 18 illustrates a configuration example of a pixel circuit 20A according to the present modification example. FIG. 19 illustrates a configuration example of a pixel driver 15A and logic circuits 28A and 29A according to the present modification example. The pixel circuit 20A includes a light reception circuit 21A. The light reception circuit 21A includes the logic circuits 28A and 29A.

The logic circuit 28A is configured to generate the control signal TRG0 on the basis of the control signal TRG and the selection signal SY supplied from the pixel driver 15A. The logic circuit 28A includes an AND circuit L12. The AND circuit L12 is configured to find AND of the selection signal SY supplied from the selection control circuit 32 and the control signal TRG supplied from the pixel driver 15A and output a result of the AND as the control signal TRG0.

The logic circuit 29A is configured to generate the control signal OFG0 on the basis of the control signal OFG and the selection signal SY supplied from the pixel driver 15A. The logic circuit 29A includes an inverter L15 and an OR circuit L14. The inverter L15 is configured to generate an inverted signal of the selection signal SY supplied from the selection control circuit 32. The OR circuit L14 is configured to find OR of an output signal of the inverter L15 and the control signal OFG supplied from the pixel driver 15A and outputs a result of the OR as the control signal OFG0.

The pixel driver 15A includes the selection control circuit 32 and a signal generation circuit 33A. The signal generation circuit 33A is configured to generate the control signals TRG, OFG, and RST, the selection signal SELY, and the trigger signal STY.

With this configuration, in the imaging device according to the modification example, for example, as with the operation example E14 (FIGS. 13A and 13B), it is possible to change the pixels P to the selected state or the unselected state in pixel line units, which makes it possible to enhance the degree of freedom in the imaging operation.

### 2. Second Embodiment

Next, description is given of an imaging device 2 according to a second embodiment. In the present embodiment, two control signals TRG and two control signals OFG are provided, and one of the two control signals TRG and one of the two control signals OFG are supplied to a pixel circuit. It is to be noted that components substantially the same as those of the imaging device 1 according to the first embodiment described above are denoted by the same reference numerals, and description thereof is omitted as appropriate.

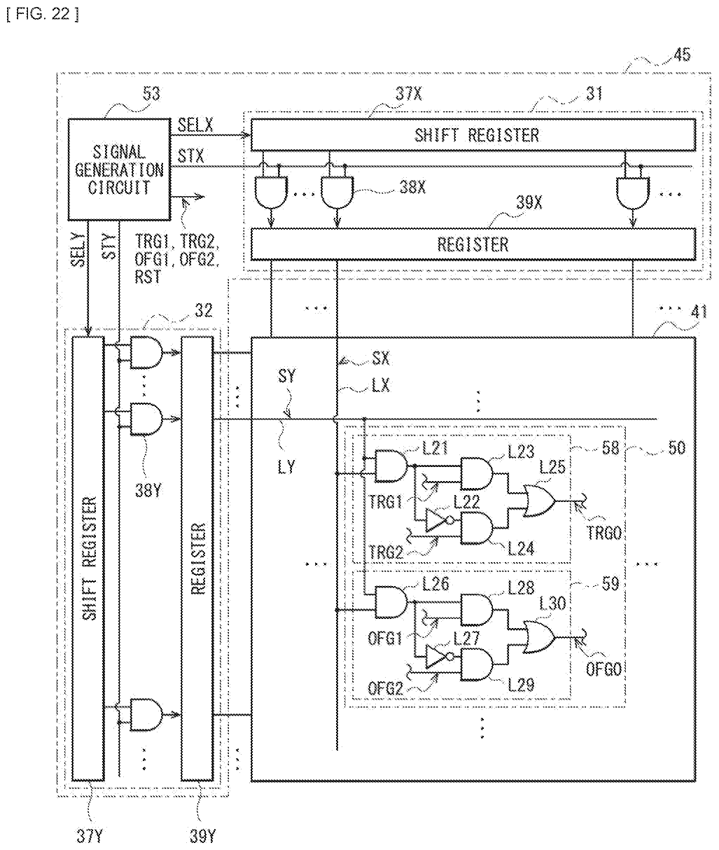

FIG. 20 illustrates a configuration example of the imaging device 2. The imaging device 2 includes a pixel array 41 and a pixel driver 45.

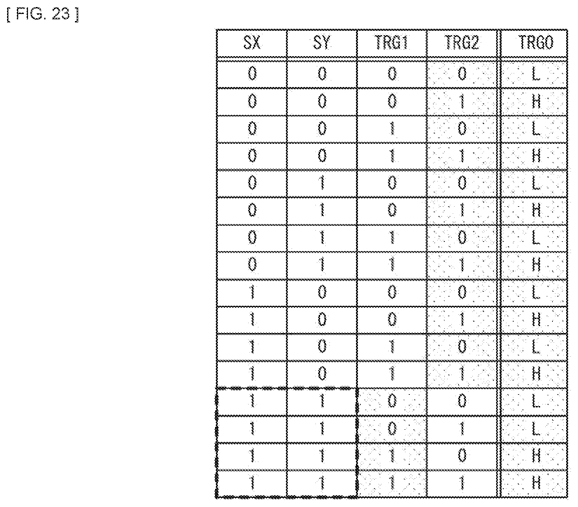

FIG. 21 illustrates a configuration example of a pixel circuit 50 related to the pixel P. The pixel circuit 50 includes a light reception circuit 51. The light reception circuit 51 includes logic circuits 58 and 59.

The logic circuit 58 is configured to generate the control signal TRG0 on the basis of control signals TRG1 and TRG2 and the selection signals SX and SY supplied from the pixel driver 45 (FIG. 20).

The logic circuit 59 is configured to generate the control signal OFG0 on the basis of control signals OFG1 and OFG2 and the selection signals SX and SY supplied from the pixel driver 45 (FIG. 20).

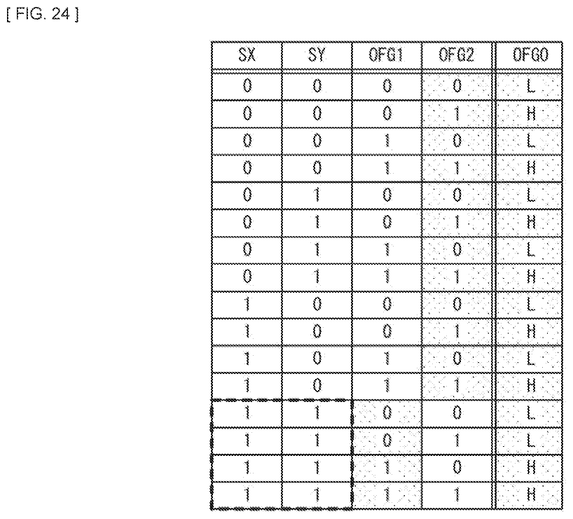

FIG. 22 illustrates a configuration example of the pixel driver 45 and the logic circuits 58 and 59.

The logic circuit 58 includes an AND circuit L21, an inverter L22, AND circuits L23 and L24, and an OR circuit L25. The AND circuit L21 has two input terminals each coupled to a corresponding one of the selection signal line LX and the selection signal line LY. The AND circuit L21 is configured to find AND of the selection signal SX and the selection signal SY. The inverter L22 is configured to generate an inverted signal of an output signal of the AND circuit L21. The AND circuit L23 is configured to find AND of the output signal of the AND circuit L21 and the control signal TRG1 supplied from the pixel driver 45. The AND circuit L24 is configured to find AND of an output signal of the inverter L22 and the control signal TRG2 supplied from the pixel driver 45. The OR circuit L25 is configured to find OR of an output signal of the AND circuit L23 and an output signal of the AND circuit L24 and output a result of the OR as the control signal TRG0.

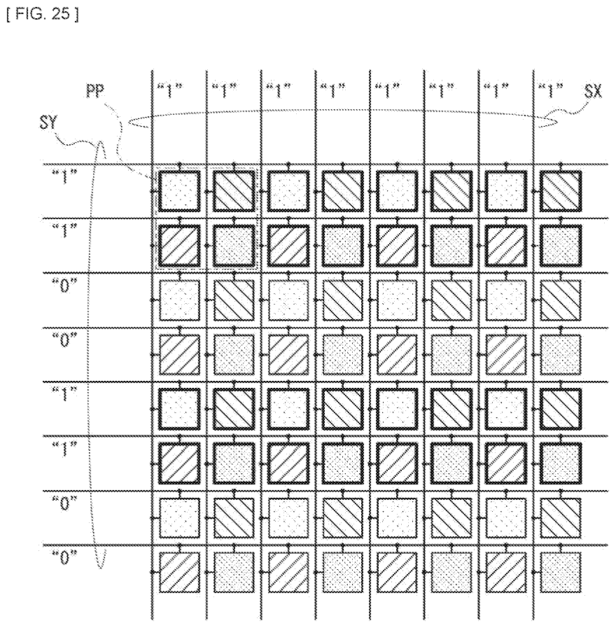

FIG. 23 illustrates an example of a truth table of the logic circuit 58. As indicated by a broken line, the logic circuit 58 outputs the control signal TRG1 as the control signal TRG0 in a case where both the selection signals SX and SY are at the high level, and outputs the control signal TRG2 as the control signal TRG0 in other cases.

The logic circuit 59 (FIG. 22) includes an AND circuit L26, an inverter L27, AND circuits L28 and L29, and an OR circuit L30. The AND circuit L26 has two input terminals each coupled to a corresponding one of the selection signal line LX and the selection signal line LY. The AND circuit L26 is configured to find AND of the selection signal SX and the selection signal SY. The inverter L27 is configured to generate an inverted signal of an output signal of the AND circuit L26. The AND circuit L28 is configured to find AND of an output signal of the AND circuit L26 and the control signal OFG1 supplied from the pixel driver 45. The AND circuit L29 is configured to find AND of an output signal of the inverter L27 and the control signal OFG2 supplied from the pixel driver 45. The OR circuit L30 is configured to find OR of an output signal of the AND circuit L28 and an output signal of the AND circuit L29 and output a result of the OR as the control signal OFG0.

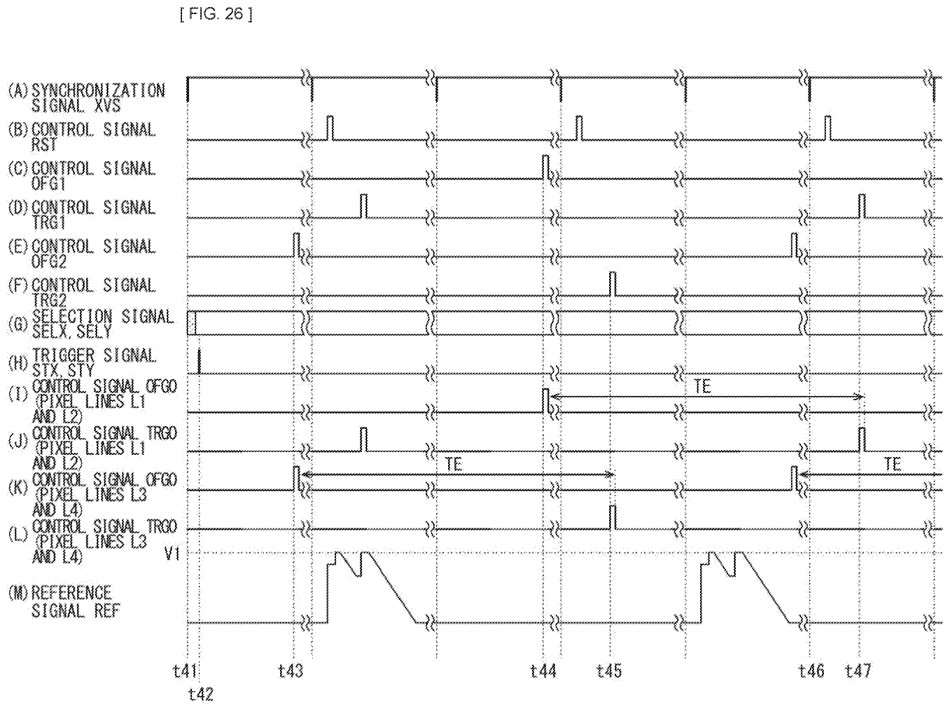

FIG. 24 illustrates an example of a truth table of the logic circuit 59. As indicated by a broken line, the logic circuit 59 outputs the control signal OFG1 as the control signal OFG0 in a case where both the selection signals SX and SY are at the high level, and outputs the control signal OFG2 as the control signal OFG0 in other cases.

The pixel driver 45 (FIGS. 20 and 22) generates the control signals TRG1, TRG2, OFG1, OFG2, and RST, the plurality of selection signals SX, and the plurality of selection signals SY, and supplies these signals to the pixel array 41 to control the operations of the pixel circuits 50.

As illustrated in FIG. 22, the pixel driver 45 includes a signal generation circuit 53. The signal generation circuit 53 is configured to generate the control signals TRG1, TRG2, OFG1, OFG2, and RST, the selection signals SELX and SELY, and the trigger signals STX and STY.

Here, the signal generation circuit 53 corresponds to a specific example of a “signal generation circuit” in the present disclosure. The control signal TRG1 corresponds to a specific example of a “first control signal” in the present disclosure. The control signal OFG1 corresponds to a specific example of a “second control signal” in the present disclosure. The control signal TRG2 corresponds to a specific example of a “third control signal” in the present disclosure. The control signal OFG2 corresponds to a specific example of a “fourth control signal” in the present disclosure. A plurality of pixel circuits 50 corresponds to a specific example of a “plurality of pixel circuits” in the present disclosure. The logic circuit 58 corresponds to a specific example of a “first circuit” in the present disclosure. The logic circuit 59 corresponds to a specific example of a “second circuit” in the present disclosure.

### (Operation Example E21)

The imaging device 2 performs an imaging operation with use of all the pixels P in the pixel array 41 as with the operation example E11 of the imaging device 1, which makes it possible to obtain a captured image having high resolution.

Specifically, the selection control circuit 31 sets all the plurality of selection signals SX to “1”, and the selection control circuit 32 sets all the plurality of selection signals SY to “1”. Accordingly, all the pixels P (pixel circuits 50) in the pixel array 41 are changed to the selected state.

In addition, the signal generation circuit 53 generates the control signals TRG1, OFG1, and RST, as with the control signals TRG, OFG, and RST in a case of the first embodiment (FIG. 8). In addition, for example, the signal generation circuit 53 maintains the control signal TRG2 at the low level, and maintains the control signal OFG2 at the high level.

In the pixel array 41, all the pixel circuits 50 are in the selected state. In all the pixel circuits 50, the logic circuits 58 each output the control signal TRG1 as the control signal TRG0, and the logic circuits 59 each output the control signal OFG1 as the control signal OFG0.

Accordingly, all the pixel circuits 50 in the pixel array 41 each perform the light exposure operation as illustrated in FIG. 8, and generate the pixel signal SIG including the pixel voltage Vpix corresponding to the amount of received light. Thereafter, the pixel circuits 50 each perform AD conversion on the basis of the pixel signal SIG to generate the code values CP and CD.

The signal processor 16 generates image data of a captured image on the basis of the code values CP and CD generated in the plurality of pixel circuits 50 that is in the selected state. This makes it possible for the imaging device 2 to obtain a captured image having high resolution.

### (Operation Example E22)

The imaging device 2 performs an imaging operation with use of some pixels P of the plurality of pixels P in the pixel array 41 as with the operation example E12 of the imaging device 1, which makes it possible to obtain a captured image having low resolution in which the pixel values are thinned out.

Specifically, the selection control circuit 31 sets the plurality of selection signals SX such that “1” appears at a ratio of one to three such as . . . , “1”, “0”, “0”, “1”, “0”, “0”, . . . , as with the case of the first embodiment (FIG. 10). In addition, the selection control circuit 32 sets the plurality of selection signals SY such that “1” appears at a ratio of one to three such as . . . , “1”, “0”, “0”, “1”, “0”, “0”, . . . , as with the case of the first embodiment (FIG. 10).

The signal generation circuit 53 generates the control signals TRG1, OFG1, and RST, as with the control signals TRG, OFG, and RST in the case of the first embodiment (FIG. 8). In addition, for example, the signal generation circuit 53 maintains the control signal TRG2 at the low level, and maintains the control signal OFG2 at the high level.

Of the plurality of pixel circuits 50 in the pixel array 41, the pixel circuits 50 in which both the selection signals SX and SY are set at the high level are set to the selected state. In each of the pixel circuits 50 that are in the selected state, the logic circuit 58 outputs the control signal TRG1 as the control signal TRG0, and the logic circuit 59 outputs the control signal OFG1 as the control signal OFG0. The pixel circuits 50 that are in the selected state each perform the light exposure operation on the basis of such control signals TRG0 and OFG0, and generate the pixel signal SIG including the pixel voltage Vpix corresponding to the amount of received light as illustrated in FIG. 8. Thereafter, the pixel circuits 50 each perform AD conversion on the basis of the pixel signal SIG to generate the code values CP and CD.

In addition, of the plurality of pixel circuits 50 in the pixel array 41, the pixel circuits 50 in which at least one of the selection signal SX or SY is set at the low level are set to the unselected state. In each of the pixel circuits 50 that are in the unselected state, the logic circuit 58 outputs the control signal TRG2 as the control signal TRG0, and the logic circuit 59 outputs the control signal OFG2 as the control signal OFG0. The control signal TRG2 is maintained at the low level, and the control signal OFG2 is maintained at the high level; therefore, the logic circuit 58 maintains the control signal TRG0 at the low level, and the logic circuit 59 maintains the control signal OFG0 at the high level. Accordingly, the pixel circuits 50 that are in the unselected state do not perform the light exposure operation.

The signal processor 16 generates image data of a captured image on the basis of the code values CP and CD generated in a plurality of pixel circuits 50 that is in the selected state. This makes it possible for the imaging device 2 to obtain a captured image having low resolution.

### (Operation Example E23)

As with the operation example E13 of the imaging device 1, in a case where the imaging device 2 performs an imaging operation with use of some pixels P of the plurality of pixels P in the pixel array 41, it is possible to reduce a noise component included in a pixel value with use of the code values CP and CD related to the pixel circuits 50 that are in the unselected state.

### (Operation Example E24)

The imaging device 2 selects the plurality of pixel P in the pixel array 41 in pixel line units to perform an imaging operation, which makes it possible to perform an interlace operation. Specifically, in the imaging device 2, it is possible to cause the light exposure periods to overlap each other between sub-frames. This operation is described in detail below.

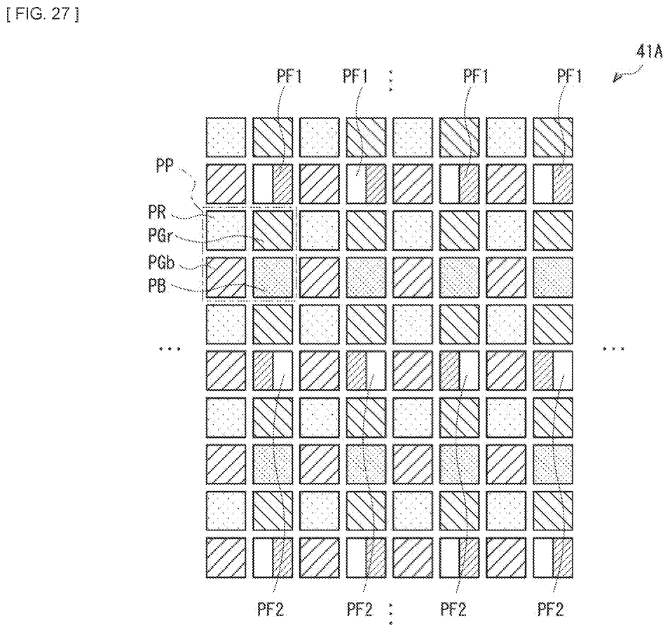

FIG. 25 illustrates an example of the pixels P related to the imaging operation in the pixel array 41. In FIG. 25, the pixels P each indicated by a thick line indicate the pixels P that are in the selected state, and the other pixels P indicate the pixels P that are in the unselected state.

The selection control circuit 31 sets all the plurality of selection signals SX to “1”. In addition, the selection control circuit 32 sets the plurality of selection signals SY such that two “1” and two “0” are repeated, such as . . . , “1”, “1”, “0”, “0”, “1”, “1”, “0”, “0”, . . . . The pixels P supplied with the selection signal SX that is at the high level and the selection signal SY that is at the high level are changed to the selected state, and the other pixels P are changed to the unselected state. In this example, in FIG. 25, the pixels P belonging to first and second pixel lines from top are changed to the selected state, the pixels P belonging to third and fourth pixel lines from top are changed to the unselected state, the pixels P belonging to fifth and sixth pixel lines from top are changed to the selected state, and the pixels P belonging to seventh and eighth pixel lines from top are changed to the unselected state.

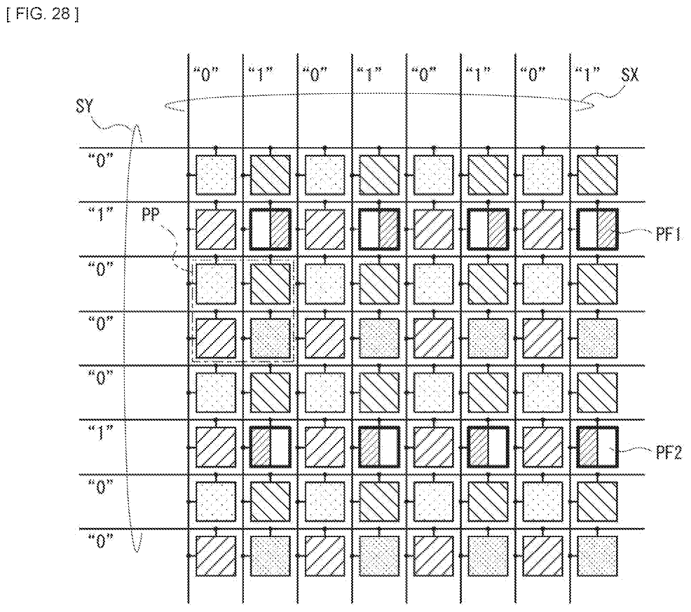

FIG. 26 illustrates an operation example of the pixel circuits 50 in the operation example E24, where (A) indicates a waveform of the synchronization signal XVS, (B) indicates a waveform of the control signal RST, (C) indicates a waveform of the control signal OFG1, (D) indicates a waveform of the control signal TRG1, (E) indicates a waveform of the control signal OFG1, (F) indicates a waveform of the control signal TRG2, (G) indicates the selection signals SELX and SELY, (H) indicates waveforms of the trigger signals STX and STY, (I) indicates a waveform of the control signal OFG0 in the pixel circuits 50 belonging to the first pixel line L1 and the second pixel line L2, (J) indicates a waveform of the control signal TRG0 in the pixel circuits 50 in the pixel circuits 50 belonging to the first pixel line L1 and the second pixel line L2, (K) indicates a waveform of the control signal OFG0 in the pixel circuits 50 belonging to the third pixel line L3 and the fourth pixel line L4, (L) indicates a waveform of the control signal TRG0 in the pixel circuits 50 belonging to the third pixel line L3 and the fourth pixel line L4, and (M) indicates a waveform of the reference signal REF.

For example, in a case of setting to this operation mode, first, at a timing t41, the signal generation circuit 53 of the pixel driver 45 supplies the selection signal SELX that is a serial signal to the selection control circuit 31, and supplies the selection signal SELY that is a serial signal to the selection control circuit 32 ((G) of FIG. 26).

Thereafter, at a timing t42 after the signal generation circuit 53 finishes supplying the selection signals SELX and SELY, the signal generation circuit 53 generates the trigger signals STX and STY ((H) of FIG. 26). Accordingly, the selection control circuit 31 supplies the plurality of selection signals SX corresponding to the selection signal SELX to the pixel array 41 via the plurality of selection signal lines LX, and the selection control circuit 32 supplies the plurality of selection signals SY corresponding to the selection signal SELY to the pixel array 41 via the plurality of selection signal lines LY.

In each of the pixel circuits 50 belonging to the pixel lines L1 and L2, the logic circuit 58 outputs the control signal TRG1 as the control signal TRG0 ((D) and (J) of FIG. 26), and the logic circuit 59 outputs the control signal OFG1 as the control signal OFG0 ((C) and (I) of FIG. 26). For example, the logic circuit 59 changes the control signal OFG0 from the low level to the high level at a timing t44, and changes the control signal OFG0 from the high level to the low level after a lapse of a predetermined time from the timing t44 ((I) of FIG. 26). In addition, the logic circuit 58 changes the control signal TRG0 from the low level to the high level at a timing t47, and changes the control signal TRG0 from the high level to the low level after a lapse of a predetermined time from the timing t47 ((J) of FIG. 26). Thus, the light exposure period TE is set. The pixel circuits 50 belonging to the pixel lines L1 and L2 each perform the light exposure operation on the basis of such control signals TRG0 and OFG0, and generate the pixel signal SIG including the pixel voltage Vpix corresponding to the amount of received light as illustrated in FIG. 8. Thereafter, the pixel circuits 50 each perform AD conversion on the basis of the pixel signal SIG to generate the code values CP and CD.

In addition, in each of the pixel circuits 50 belonging to the pixel lines L3 and L4, the logic circuit 58 outputs the control signal TRG2 as the control signal TRG0 ((F) and (L) of FIG. 26), and the logic circuit 59 outputs the control signal OFG2 as the control signal OFG0 ((E) and (K) of FIG. 26). For example, the logic circuit 59 changes the control signal OFG0 from the low level to the high level at a timing t43, and changes the control signal OFG0 from the high level to the low level after a lapse of a predetermined time from the timing t43 ((K) of FIG. 26). In addition, the logic circuit 58 changes the control signal TRG0 from the low level to the high level at a timing t45, and changes the control signal TRG0 from the high level to the low level after a lapse of a predetermined time from the timing t45 ((L) of FIG. 26). Thus, the light exposure period TE is set. The pixel circuits 50 belonging to the pixel lines L3 and L4 each perform the light exposure operation on the basis of such control signals TRG0 and OFG0, and generate the pixel signal SIG including the pixel voltage Vpix corresponding to the amount of received light as illustrated in FIG. 8. Thereafter, the pixel circuits 50 each perform AD conversion on the basis of the pixel signal SIG to generate the code values CP and CD.

In this example, a length of the light exposure period TE is longer than that in the case of the first embodiment described above (FIG. 4). The light exposure period related to the pixel circuits 50 belonging to the pixel lines L1 and L2 and the light exposure period TE related to the pixel circuits 50 belonging to the pixel lines L3 and LA partially overlap each other.

The signal processor 16 generates image data of a captured image on the basis of the code values CP and CD generated in a plurality of pixel circuits 50 that is in the selected state, and generates image data of a captured image on the basis of the code values CP and CD generated in a plurality of pixel circuits 50 that is in the unselected state. This makes it possible for the imaging device 2 to perform the interlace operation.

In the imaging device 2, unlike the case of the first embodiment described above (FIGS. 13A and 13B), it is not necessary to set a plurality of selection signals SY for each sub-frame period; therefore, it is possible to simplify an operation. In addition, it is possible to increase the length of the light exposure period TE in such a manner, as compared with the case of the first embodiment described above (FIG. 4).

### (Operation Example E25)

The imaging device 2 performs an imaging operation with use of a plurality of pixels P belonging to a certain image region of the plurality of pixels P in the pixel array 41 as with the operation example E15 of the imaging device 1, which makes it possible to obtain a ROI image.

For example, in a case where one ROI region is set, the selection control circuit 31 sets the selection signals SX related to the region W1 of the plurality of selection signals SX to “1”, and sets the other selection signals SX to “0”, as with the case of the first embodiment (FIG. 16). Likewise, the selection control circuit 32 sets the selection signals SY related to the region W1 of the plurality of selection signals SY to “1”, and sets the other selection signals SY to “0”. Thus, in the pixel array 41, a plurality of pixels P belonging to the region W1 is changed to the selected state.

The signal generation circuit 53 generates the control signals TRG1, OFG1, and RST, as with the control signals TRG, OFG, and RST in the case of the first embodiment (FIG. 8). In addition, the signal generation circuit 53 maintains the control signal TRG2 at the low level, and maintains the control signal OFG2 at the high level.

The pixel circuits 50 corresponding to the pixels P belonging to the region W1 each generate the pixel signal SIG including the pixel voltage Vpix corresponding to the amount of received light, and perform AD conversion on the basis of the pixel signal SIG to generate the code values CP and CD. The signal processor 16 generates image data of a captured image on the basis of the code values CP and CD generated by a plurality of pixel circuits 50 belonging to the region W1. This makes it possible for the imaging device 2 to obtain a ROI image.

For example, in a case where three ROI regions are set, the selection control circuit 31 sets the selection signals SX related to the regions W2, W3, and W4 of the plurality of selection signals SX to “1”, and sets the other selection signals SX to “0”, as with the case of the first embodiment (FIG. 18). Likewise, the selection control circuit 32 sets the selection signals SY related to the regions W2, W3, and W4 of the plurality of selection signals SY to “1”, and sets the other selection signals SY to “0”. As a result, in the pixel array 41, nine regions in which the pixel circuits 50 are changed to the selected state are set.

The signal generation circuit 53 generates the control signals TRG1, OFG1, and RST, as with the control signals TRG, OFG, and RST in the case of the first embodiment (FIG. 8). In addition, the signal generation circuit 53 maintains the control signal TRG2 at the low level, and maintains the control signal OFG2 at the high level.

The pixel circuits 50 corresponding to the pixels P belonging to these nine regions each generate the pixel signal SIG including the pixel voltage Vpix corresponding to the amount of received light, and perform AD conversion on the basis of the pixel signal SIG to generate the code values CP and CD. The signal processor 16 generates image data of a captured image on the basis of the code values CP and CD generated in a plurality of pixel circuits 50 belonging to the three regions W2 to W4 of the code values CP and CD generated in these pixel circuits 50. This makes it possible for the imaging device 2 to obtain three ROI images.

Thus, in the imaging device 2, the signal generation circuit 53 generates a third control signal (control signal TRG2) and a fourth control signal (control signal OFG2). Thereafter, the first circuit (logic circuit 58) controls the operation of the first switch (transistor MN2) on the basis of the first signal (selection signal SY), the second signal (selection signal SX), the first control signal (control signal TRG1), and the third control signal (control signal TRG2). In addition, the second circuit (logic circuit 59) controls the operation of the second switch (transistor MN1) on the basis of the first signal (selection signal SY), the second signal (selection signal SX), the second control signal (control signal OFG1), and the fourth control signal (control signal OFG2). Accordingly, for example, the pixel circuits 50 are selectively operable on the basis of the control signal TRG1 and OFG1 and one of the control signals TRG2 and OFG2, which makes it possible to enhance the degree of freedom in the imaging operation.

As described above, in the present embodiment, the signal generation circuit generates the third control signal and the fourth control signal. Thereafter, the first circuit controls the operation of the first switch on the basis of the first signal, the second signal, the first control signal, and the third control signal. In addition, the second circuit controls the operation of the second switch on the basis of the first signal, the second signal, the second control signal, and the fourth control signal. This makes it possible to enhance the degree of freedom in the imaging operation. [Modification Example 2]

In the embodiment described above, the plurality of pixels P is provided in the pixel array 41. The pixels P may include a pixel for obtaining a defocusing value in the imaging device 2. The present modification example is described in detail below.

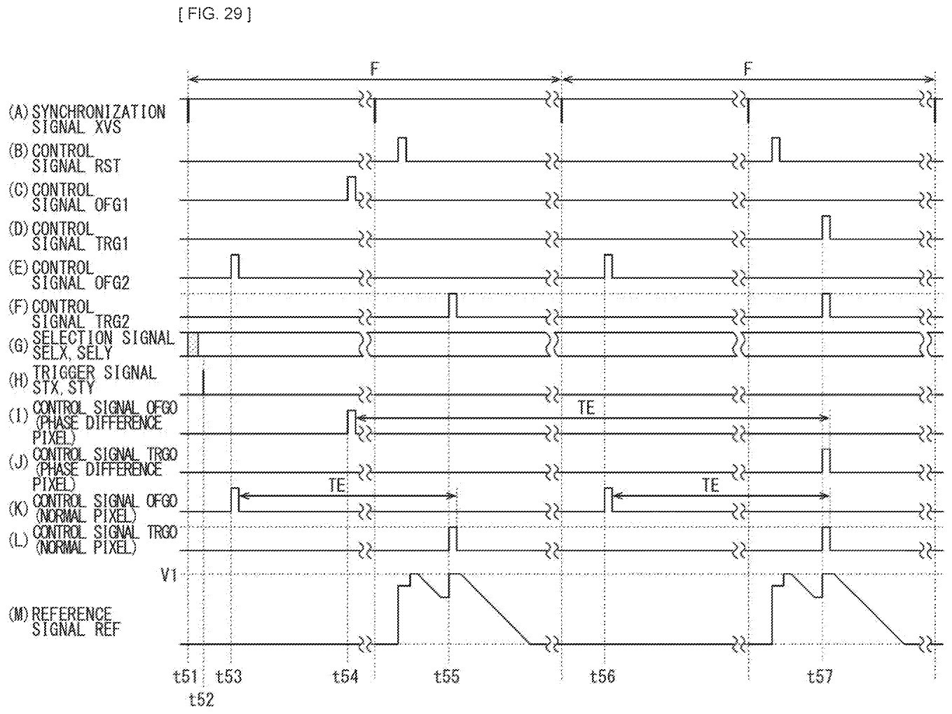

FIG. 27 illustrates a configuration example of a pixel array 41A according to the present modification example. The pixel array 41A includes six pixels P (pixels PR, PGr, PGb, PB, PF1, and PF2). The pixels PF1 and PF2 are so-called phase difference pixels for obtaining the defocusing value. In FIG. 27, shaded regions indicated in the pixels PF1 and PF2 each indicate a light-shielding film provided on a light reception surface. A right half of the pixel PF1 is light-shielded, and a left half of the pixel PF2 is light-shielded. In this example, the pixels PF1 and PF2 are disposed in place of the pixels PB. In this example, the pixels PF1 are disposed in place of the pixels PB in a second pixel line and a tenth pixel line from top. The pixels PF2 are disposed in place of the pixels PB in a sixth pixel line from top. It is to be noted that arrangement of the pixels PF1 and PF2 is not limited thereto, and the pixels PF1 and PF2 may be disposed in any of various arrangements.

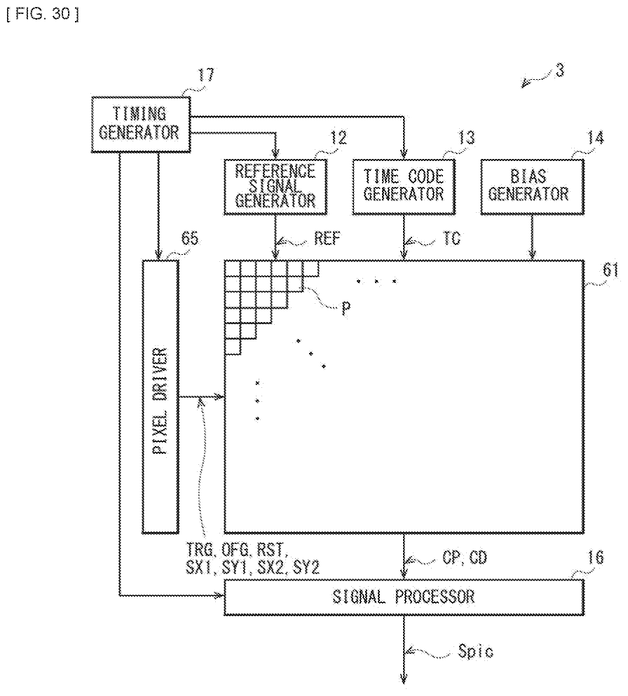

FIG. 28 illustrates an example of the pixels P related to the imaging operation in the pixel array 41A. In FIG. 28, t the pixels P each indicated by a thick line indicate the pixels P that are in the selected state, and the other pixels P indicate the pixels P that are in the unselected state.

As illustrated in FIG. 28, the selection control circuits 31 and 32 generate a plurality of selection signals SX and a plurality of selection signals SY in accordance with positions of the pixels PF1 and PF2. Specifically, in this example, the selection control circuit 31 sets the plurality of selection signals SX such as . . . , “0”, “1”, “0”, “1”, “0”, “1”, “0”, “1”, . . . , and the selection control circuit 32 sets the plurality of selection signals SY such as . . . , “0”, “1”, “0”, “0”, “0”, “1”, “0”, “0”, . . . . Accordingly, the pixels PF1 and PF2 supplied with the selection signal SX that is at the high level and the selection signal SY that is at the high level are changed to the selected state, and the other pixels P are changed to the unselected state.

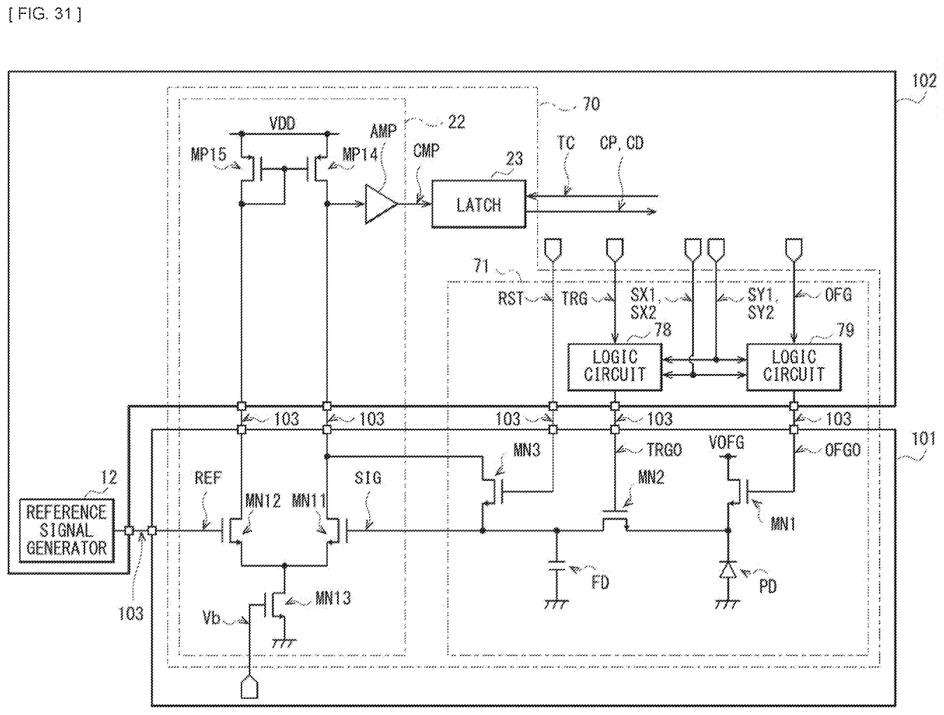

FIG. 29 illustrates an operation example of the pixel circuits 50 related to the pixels P according to the present modification example, where (A) indicates a waveform of the synchronization signal XVS, (B) indicates a waveform of the control signal RST, (C) indicates a waveform of the control signal OFG1, (D) indicates a waveform of the control signal TRG1, (E) indicates a waveform of the control signal OFG2, (F) indicates a waveform of the control signal TRG2, (G) indicates the selection signals SELX and SELY, (H) indicates waveforms of the trigger signals STX and STY, (I) indicates a waveform of the control signal OFG0 in the pixel circuits 50 of the phase difference pixels (pixels PF1 and PF2), (J) indicates a waveform of the control signal TRG0 in the pixel circuits 50 of the phase difference pixels, (K) indicates a waveform of the control signal OFG0 in the pixel circuits 50 of normal pixels (pixels PR, PGr, PGb, and PB), (L) indicates a waveform of the control signal TRG0 in the pixel circuits of the normal pixels, and (M) indicates a waveform of the reference signal REF.

For example, in a case of setting to this operation mode, first, in the frame period F starting from a timing t51, the signal generation circuit 53 of the pixel driver 45 supplies the selection signal SELX that is a serial signal to the selection control circuit 31, and supplies the selection signal SELY that is a serial signal to the selection control circuit 32 ((G) of FIG. 29).

Thereafter, at a timing t52 after the signal generation circuit 53 finishes supplying the selection signals SELX and SELY, the signal generation circuit 53 generates the trigger signals STX and STY ((H) of FIG. 29). Accordingly, the selection control circuit 31 supplies the plurality of selection signals SX corresponding to the selection signal SELX to the pixel array 41A via the plurality of selection signal lines LX, and the selection control circuit 32 supplies the plurality of selection signals SY corresponding to the selection signal SELY to the pixel array 41A via the plurality of selection signal lines LY.

In each of the pixel circuits 50 in the phase difference pixels (pixels PF1 and PF2), the logic circuit 58 outputs the control signal TRG1 as the control signal TRG0 ((D) and (J) of FIG. 29), and the logic circuit 59 outputs the control signal OFG1 as the control signal OFG0 ((C) and (I) of FIG. 29). For example, the logic circuit 59 changes the control signal OFG0 from the low level to the high level at a timing t54, and changes the control signal OFG0 from the high level to the low level after a lapse of a predetermined time from the timing t54 ((I) of FIG. 29). In addition, the logic circuit 58 changes the control signal TRG0 from the low level to the high level at a timing t57, and changes the control signal TRG0 from the high level to the low level after a lapse of a predetermined time from the timing t57 ((J) of FIG. 29). Thus, the light exposure period TE is set. The pixel circuits 50 that are in the selected state each perform the light exposure operation on the basis of such control signals TRG0 and OFG0, and generate the pixel signal SIG including the pixel voltage Vpix corresponding to the amount of received light as illustrated in FIG. 8. Thereafter, the pixel circuits 50 each perform AD conversion on the basis of the pixel signal SIG to generate the code values CP and CD.

In addition, in each of the pixel circuits 50 in the normal pixels (pixels PR, PGr, PGb, and PB), the logic circuit 58 outputs the control signal TRG2 as the control signal TRG0 ((F) and (L) of FIG. 29), and the logic circuit 59 outputs the control signal OFG2 as the control signal OFG0 ((E) and (K) of FIG. 29). For example, the logic circuit 59 changes the control signal OFG0 from the low level to the high level at a timing t53, and changes the control signal OFG0 from the high level to the low level after a lapse of a predetermined time from the timing t53 ((K) of FIG. 29). In addition, the logic circuit 58 changes the control signal TRG0 from the low level to the high level at a timing t55, and changes the control signal TRG0 from the high level to the low level after a lapse of a predetermined time from the timing t55 ((L) of FIG. 29). Thus, the light exposure period TE is set. The pixel circuits 50 that are in the selected state each perform the light exposure operation on the basis of such control signals TRG0 and OFG0, and generate the pixel signal SIG including the pixel voltage Vpix corresponding to the amount of received light as illustrated in FIG. 8. Thereafter, the pixel circuits 50 each perform AD conversion on the basis of the pixel signal SIG to generate the code values CP and CD. The same applies to a period from a timing t56 to the timing t57.

For example, the signal processor 16 generates phase difference data on the basis of the code values CP and CD generated in a plurality of pixel circuits 50 that is in the selected state, and generates image data of a captured image on the basis of the code values CP and CD generated in a plurality of pixel circuits 50 that is in the unselected state. For example, in a camera including the imaging device 2, the defocusing value is determined on the basis of this phase difference data, and a position of a shooting lens is moved on the basis of the defocusing value. Thus, it is possible to achieve autofocus in the camera.

In addition, in the imaging device 2, it is possible to individually set the length of the light exposure period TE in the phase difference pixels and the length of the light exposure period in the normal pixels. For example, in the phase difference pixels, as illustrated in FIG. 27, a half of the light reception surface is light-shielded; therefore, it is desirable that the length of the light exposure period TE in the phase difference pixels be longer than the length of the light exposure period TE in the normal pixels. In the imaging device 2, it is possible to set the light exposure period TE suitable for the phase difference pixel, which makes it possible to enhance autofocusing accuracy.

### 3. Third Embodiment

Next, description is given of an imaging device 3 according to a third embodiment. In the present embodiment, a selection control circuit that generates a plurality of selection signals SX1, a selection control circuit that generates a plurality of selection signals SY1, a selection control circuit that generates a plurality of selection signals SX2, and a selection control circuit that generates a plurality of selection signals SY2 are provided, and the control signals TRG and OFG are supplied to pixel circuits selected by the plurality of selection signals SX1 and the plurality of selection signals SY1, and the pixel circuits selected by the plurality of selection signals SX2 and the plurality of selection signals SY2. It is to be noted that components substantially the same as those of the imaging device 1 according to the first embodiment described above are denoted by the same reference numerals, and description thereof is omitted as appropriate.

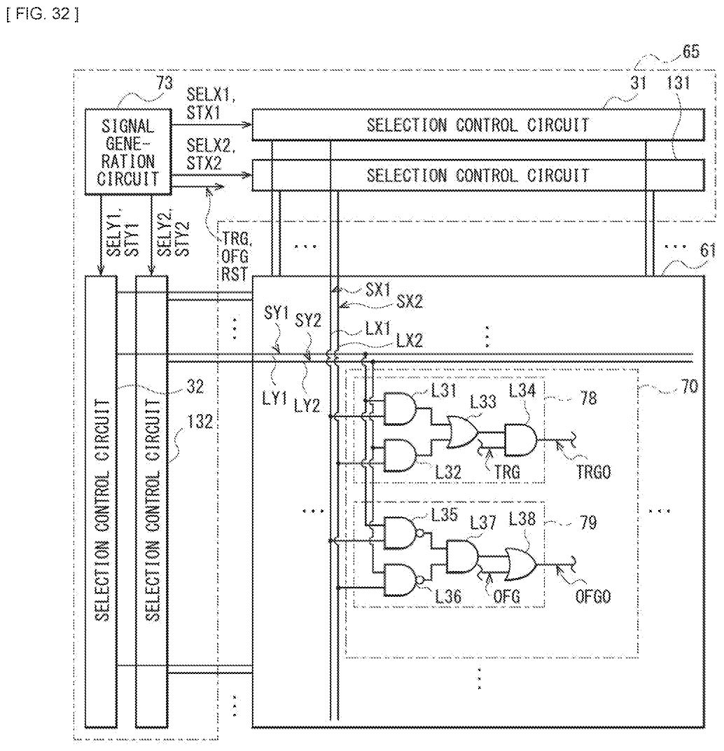

FIG. 30 illustrates a configuration example of the imaging device 3. The imaging device 3 includes a pixel array 61 and a pixel driver 65.

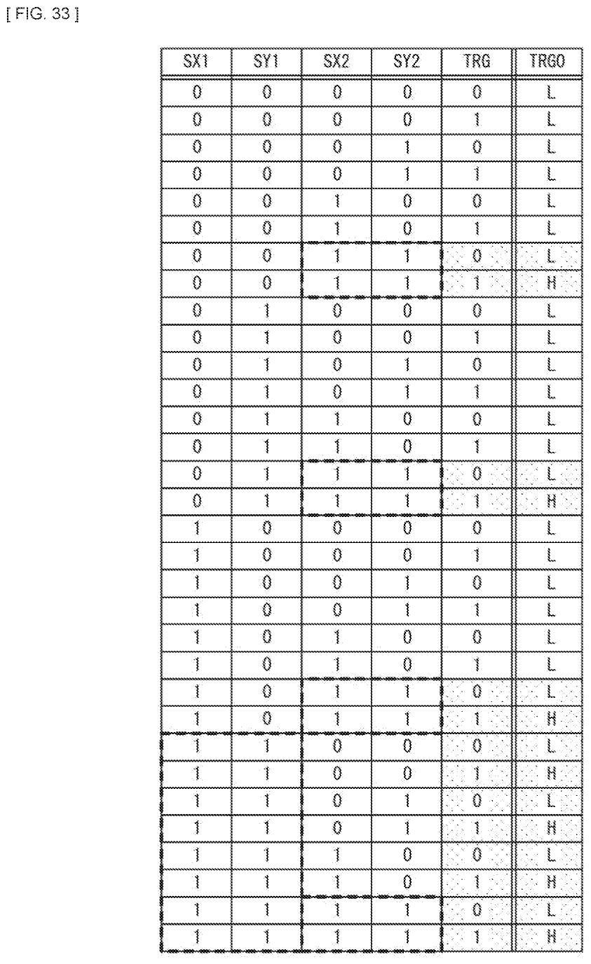

FIG. 31 illustrates a configuration example of a pixel circuit 70 related to the pixel P. The pixel circuit 70 includes a light reception circuit 71. The light reception circuit 71 includes logic circuits 78 and 79.

The logic circuit 78 is configured to generate the control signal TRG0 on the basis of the control signal TRG and the selection signals SX1, SY1, SX2, and SY2 supplied from the pixel driver 65 (FIG. 30).

The logic circuit 79 is configured to generate the control signal OFG0 on the basis of the control signal OFG and the selection signals SX1, SY1, SX2, and SY2 supplied from the pixel driver 65 (FIG. 30).

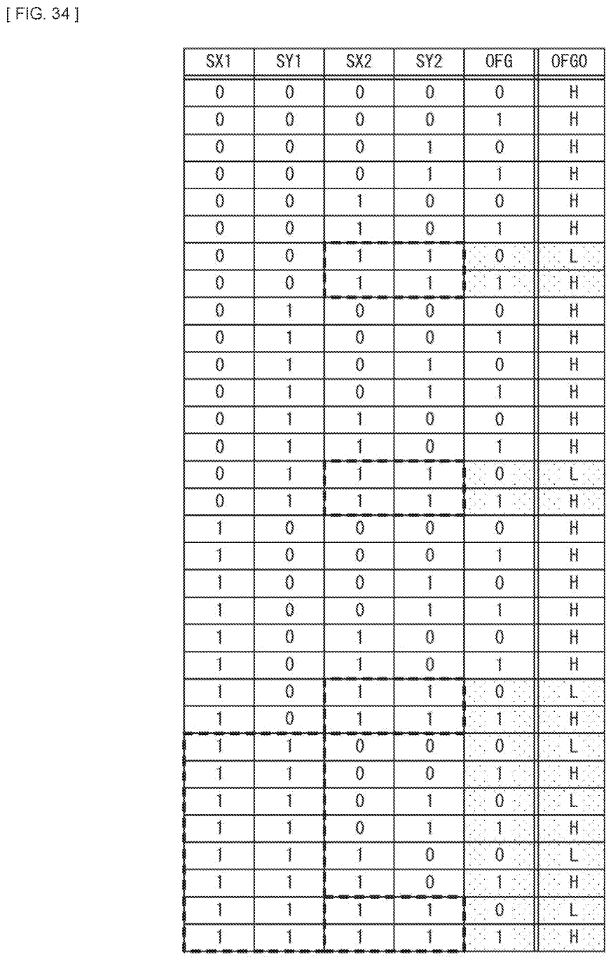

FIG. 32 illustrates a configuration example of the pixel driver 65 and the logic circuits 78 and 79. The pixel array 61 includes a plurality of selection signal lines LX1, a plurality of selection signal lines LY1, a plurality of selection signal lines LX2, and a plurality of selection signal lines LY2. The selection signal lines LX1 extend in the longitudinal direction (vertical direction) in FIG. 32, and are provided side by side in the lateral direction (horizontal direction). The plurality of selection signal lines LX1 is each configured to transmit a corresponding one of the plurality of selection signals SX1 supplied from the pixel driver 65. The selection signal lines LY1 extend in the lateral direction (horizontal direction) in FIG. 32, and are provided side by side in the longitudinal direction (vertical direction). The plurality of selection signal lines LY1 is each configured to transmit a corresponding one of the plurality of selection signals SY1 supplied from the pixel driver 65. The selection signal lines LX2 extend in the longitudinal direction in FIG. 32, and are provided side by side in the lateral direction. The plurality of selection signal lines LX2 is each configured to transmit a corresponding one of the plurality of selection signals SX2 supplied from the pixel driver 65. The selection signal lines LY2 extend in the lateral direction in FIG. 32, and are provided side by side in the longitudinal direction. The plurality of selection signal lines LY2 is each configured to transmit a corresponding one of the plurality of selection signals SY2 supplied from the pixel driver 65.

The logic circuit 78 includes AND circuits L31 and L32, an OR circuit L33, and an AND circuit L34. The AND circuit L31 has two input terminals each coupled to a corresponding one of the selection signal line LX1 and the selection signal line LY1. The AND circuit L31 is configured to find AND of the selection signal SX1 and the selection signal SY1. The AND circuit L32 has two input terminals each coupled to a corresponding one of the selection signal line LX2 and the selection signal line LY2. The AND circuit L32 is configured to find AND of the selection signal SX2 and the selection signal SY2. The OR circuit L33 is configured to find OR of an output signal of the AND circuit L31 and an output signal of the AND circuit L32. The AND circuit L34 is configured to find AND of an output signal of the OR circuit L33 and the control signal TRG supplied from the pixel driver 65 and output a result of the AND as the control signal TRG0.

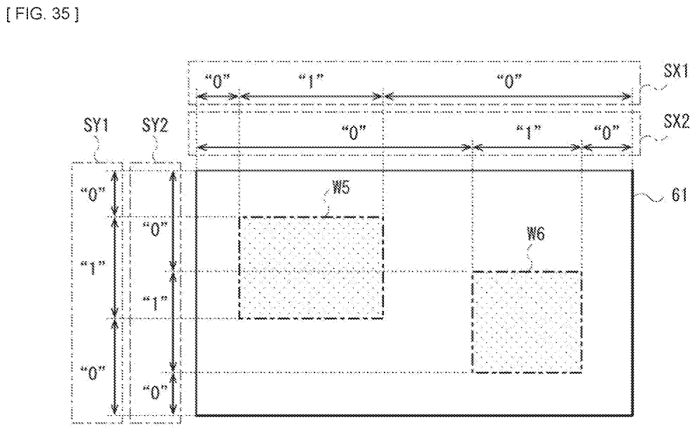

FIG. 33 illustrates an example of a truth table of the logic circuit 78. As indicated by a broken line, the logic circuit 78 outputs the control signal TRG as the control signal TRG0 in a case where at least one of a condition that both the selection signals SX1 and SY1 are at the high level or a condition that both the selection signals SX2 and SY2 are at the high level is satisfied, and changes the control signal TRG0 to the low level in other cases.

The logic circuit 79 (FIG. 32) includes NAND circuits L35 and L36, an AND circuit L37, and an OR circuit L38. The NAND circuit L35 has two input terminals each coupled to a corresponding one of the selection signal line LX1 and the selection signal line LY1. The NAND circuit L35 is configured to find NAND of the selection signal SX1 and the selection signal SY1. The NAND circuit L36 has two input terminals each coupled to a corresponding one of the selection signal line LX2 and the selection signal line LY2. The NAND circuit L36 is configured to find NAND of the selection signal SX2 and the selection signal SY2. The AND circuit L37 is configured to find AND of an output signal of the NAND circuit L35 and an output signal of the NAND circuit L36. The OR circuit L38 is configured to find OR of an output signal of the AND circuit L37 and the control signal OFG supplied from the pixel driver 65 and output a result of the OR as the control signal OFG0.

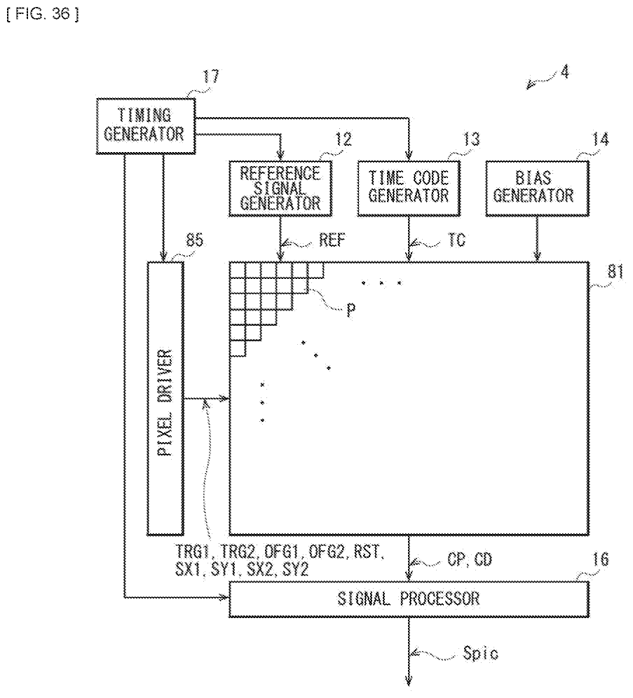

FIG. 34 illustrates an example of a truth table of the logic circuit 79. As indicated by a broken line, the logic circuit 79 outputs the control signal OFG as the control signal OFG0 in a case where at least one of a condition that both the selection signals SX1 and SY1 are at the high level or a condition that both the selection signals SX2 and SY2 is satisfied are at the high level, and changes the control signal OFG0 to the high level in other cases.

The pixel driver 65 (FIGS. 30 and 32) generates the control signals TRG, OFG, and RST, the plurality of selection signals SX1, the plurality of selection signals SY1, the plurality of selection signals SX2, and the plurality of selection signals SY2, and supplies these signals to the pixel array 61 to control the operations of the pixel circuits 70.

As illustrated in FIG. 32, the pixel driver 65 includes selection control circuits 31, 131, 32, and 132, and a signal generation circuit 73. It is to be noted that in FIG. 32, unlike FIG. 5 and the like, the selection control circuits 31 and 32 are illustrated in a simplified manner.

The selection control circuit 31 is configured to generate the plurality of selection signals SX1 on the basis of a selection signal SELX1 and a trigger signal STX1 supplied from the signal generation circuit 73. The selection control circuit 131 is configured to generate the plurality of selection signals SX2 on the basis of a selection signal SELX2 and a trigger signal STX2 supplied from the signal generation circuit 73. The selection control circuit 131 has a circuit configuration similar to a circuit configuration of the selection control circuit 31 (e.g., FIG. 5).

The selection control circuit 32 is configured to generate the plurality of selection signals SY1 on the basis of a selection signal SELY1 and a trigger signal STY1 supplied from the signal generation circuit 73. The selection control circuit 132 is configured to generate the plurality of selection signals SY2 on the basis of a selection signal SELY2 and a trigger signal STY2 supplied from the signal generation circuit 73. The selection control circuit 132 has a circuit configuration similar to a circuit configuration of the selection control circuit 32 (e.g., FIG. 5).

The signal generation circuit 73 is configured to generate the control signals TRG, OFG, and RST, the selection signals SELX1, SELX2, SELY1, and SELY2, and the trigger signals STX1, STY1, STX2, and STY2.

Here, the signal generation circuit 73 corresponds to a specific example of a “signal generation circuit” in the present disclosure. The selection control circuit 32 corresponds to a specific example of a “first selection control circuit” in the present disclosure. The plurality of selection signals SY1 corresponds to a specific example of a “plurality of first selection signals” in the present disclosure. The selection control circuit 31 corresponds to a specific example of a “second selection control circuit” in the present disclosure. The plurality of selection signals SX1 corresponds to a specific example of a “plurality of second selection signals” in the present disclosure. The selection control circuit 132 corresponds to a specific example of a “third selection control circuit” in the present disclosure. The plurality of selection signals SY2 corresponds to a specific example of a “plurality of third selection signals” in the present disclosure. The selection control circuit 131 corresponds to a specific example of a “fourth selection control circuit” in the present disclosure. The plurality of selection signals SX2 corresponds to a specific example of a “plurality of fourth selection signals” in the present disclosure. A plurality of pixel circuits 70 corresponds to a specific example of a “plurality of pixel circuits” in the present disclosure. The logic circuit 78 corresponds to a specific example of a “first circuit” in the present disclosure. The logic circuit 79 corresponds to a specific example of a “second circuit” in the present disclosure.

### (Operation Example E31)

The imaging device 3 performs an imaging operation with use of all the pixels P in the pixel array 61 as with the operation example E11 of the imaging device 1, which makes it possible to obtain a captured image having high resolution.

Specifically, for example, the selection control circuit 31 sets all the plurality of selection signals SX1 to “1”, and the selection control circuit 32 sets all the plurality of selection signals SY1 to “1”. In addition, the selection control circuit 131 sets all the plurality of selection signals SX2 to “0”, and the selection control circuit 132 sets all the plurality of selection signals SY2 to “0”. Accordingly, all the pixels P (pixel circuits 70) in the pixel array 61 are changed to the selected state. Accordingly, in all the pixel circuits 70, the logic circuits 78 each output the control signal TRG as the control signal TRG0, and the logic circuits 79 each output the control signal OFG as the control signal OFG0.

Accordingly, all the pixel circuits 70 in the pixel array 61 each perform the light exposure operation as illustrated in FIG. 8, and generate the pixel signal SIG including the pixel voltage Vpix corresponding to the amount of received light. Thereafter, the pixel circuits 70 each perform AD conversion on the basis of the pixel signal SIG to generate the code values CP and CD.

The signal processor 16 generates image data of a captured image on the basis of the code values CP and CD generated in the plurality of pixel circuits 70 that is in the selected state. This makes it possible for the imaging device 3 to obtain a captured image having high resolution.

### (Operation Example E32)

The imaging device 3 performs an imaging operation with use of some pixels P of the plurality of pixels P in the pixel array 61 as with the operation example E12 of the imaging device 1, which makes it possible to obtain a captured image having low resolution in which the pixel values are thinned out.

Specifically, the selection control circuit 31 sets the plurality of selection signals SX1 such that “1” appears at a ratio of one to three such as . . . , “1”, “0”, “0”, “1”, “0”, “0”, . . . , as with the case of the first embodiment (FIG. 10). In addition, the selection control circuit 32 sets the plurality of selection signals SY1 such that “1” appears at a ratio of one to three such as . . . , “1”, “0”, “0”, “1”, “0”, “0”, . . . , as with the case of the first embodiment (FIG. 10). In addition, the selection control circuit 131 sets all the plurality of selection signals SX2 to “0”, and the selection control circuit 132 sets all the plurality of selection signals SY2 to “0”.

Of the plurality of pixel circuits 70 in the pixel array 61, the pixel circuits 70 in which both the selection signals SX1 and SY1 are set at the high level are set to the selected state. In each of the pixel circuits 70 that are in the selected state, the logic circuit 78 outputs the control signal TRG as the control signal TRG0, and the logic circuit 79 outputs the control signal OFG as the control signal OFG0. The pixel circuits 70 that are in the selected state each perform the light exposure operation on the basis of such control signals TRG0 and OFG0, and generate the pixel signal SIG including the pixel voltage Vpix corresponding to the amount of received light as illustrated in FIG. 8. Thereafter, the pixel circuits 70 each perform AD conversion on the basis of the pixel signal SIG to generate the code values CP and CD.

In addition, of the plurality of pixel circuits 70 in the pixel array 61, the pixel circuits 70 in which at least one of the selection signal SX1 or SY1 is set at the low level are set to the unselected state. In each of the pixel circuits 70 that are in the unselected state, the logic circuit 78 maintains the control signal TRG0 at the low level, and the logic circuit 79 maintains the control signal OFG0 at the high level. Accordingly, the pixel circuits 70 that are in the unselected state do not perform the light exposure operation.

The signal processor 16 generates image data of a captured image on the basis of the code values CP and CD generated in a plurality of pixel circuits 70 that is in the selected state. This makes it possible for the imaging device 3 to obtain a captured image having low resolution.

### (Operation Example E33)

As with the operation example E13 of the imaging device 1, in a case where the imaging device 3 performs an imaging operation with use of some pixels P of the plurality of pixels P in the pixel array 61, it is possible to reduce a noise component included in a pixel value with use of the code values CP and CD related to the pixel circuits 70 that are in the unselected state.

### (Operation Example E34)

The imaging device 3 selects the plurality of pixel P in the pixel array 61 in pixel line units to perform an imaging operation, which makes it possible to perform an interlace operation.

Specifically, in the sub-frame period SF1, the selection control circuit 31 sets all the plurality of selection signals SX1 to “1”, as with the case of the first embodiment (FIG. 13A). In addition, the selection control circuit 32 sets the plurality of selection signals SY1 such that two “1” and two “0” are repeated, such as . . . , “1”, “1”, “0”, “0”, “1”, “1”, “0”, “0”, . . . . In addition, the selection control circuit 131 sets all the plurality of selection signals SX2 to “0”, and the selection control circuit 132 sets all the plurality of selection signals SY2 to “0”.

In addition, in the sub-frame period SF2, the selection control circuit 31 sets all the plurality of selection signals SX1 to “1”, as with the case of the first embodiment (FIG. 13B). In addition, the selection control circuit 32 sets the plurality of selection signals SY1 such that two “0” and two “1” are repeated, such as . . . , “0”, “0”, “1”, “1”, “0”, “0”, “1”, “1”, . . . . In addition, the selection control circuit 131 sets all the plurality of selection signals SX2 to “0”, and the selection control circuit 132 sets all the plurality of selection signals SY2 to “0”.

In the sub-frame period SF1, in each of the pixel circuits 70 belonging to the pixel lines L1 and L2, the logic circuit 78 outputs the control signal TRG as the control signal TRG0, and the logic circuit 79 outputs the control signal OFG as the control signal OFG0. The pixel circuits 70 belonging to the pixel lines L1 and L2 each perform the light exposure operation on the basis of such control signals TRG0 and OFG0, and generate the pixel signal SIG including the pixel voltage Vpix corresponding to the amount of received light as illustrated in FIG. 8. Thereafter, the pixel circuits 70 each perform AD conversion on the basis of the pixel signal SIG to generate the code values CP and CD.

In addition, in the sub-frame period SF1, in each of the pixel circuits 70 belonging to the pixel lines L3 and L4, the logic circuit 78 maintains the control signal TRG0 at the low level, and the logic circuit 79 maintains the control signal OFG0 at the high level. Accordingly, the pixel circuits 70 belonging to the pixel lines L3 and L4 do not perform the light exposure operation.

In the sub-frame period SF2, in each of the pixel circuits 70 belonging to the pixel lines L3 and L4, the logic circuit 78 outputs the control signal TRG as the control signal TRG0, and the logic circuit 79 outputs the control signal OFG as the control signal OFG0. The pixel circuits 70 belonging to the pixel lines L3 and LA each perform the light exposure operation on the basis of such control signals TRG0 and OFG0, and generate the pixel signal SIG including the pixel voltage Vpix corresponding to the amount of received light as illustrated in FIG. 8. Thereafter, the pixel circuits 70 each perform AD conversion on the basis of the pixel signal SIG to generate the code values CP and CD.

In addition, in the sub-frame period SF2, in each of the pixel circuits 70 belonging to the pixel lines L1 and L2, the logic circuit 78 maintains the control signal TRG0 at the low level, and the logic circuit 79 maintains the control signal OFG0 at the high level. Accordingly, the pixel circuits 70 belonging to the pixel lines L1 and L2 do not perform the light exposure operation.

The signal processor 16 generates image data of a captured image on the basis of the code values CP and CD generated in a plurality of pixel circuits 70 that is in the selected state. This makes it possible for the imaging device 3 to perform the interlace operation.

### (Operation Example E35)

The imaging device 3 performs an imaging operation with use of a plurality of pixels P belonging to a certain image region of the plurality of pixels P in the pixel array 61 as with the operation example E15 of the imaging device 1, which makes it possible to obtain a ROI image. This operation is described in detail below.

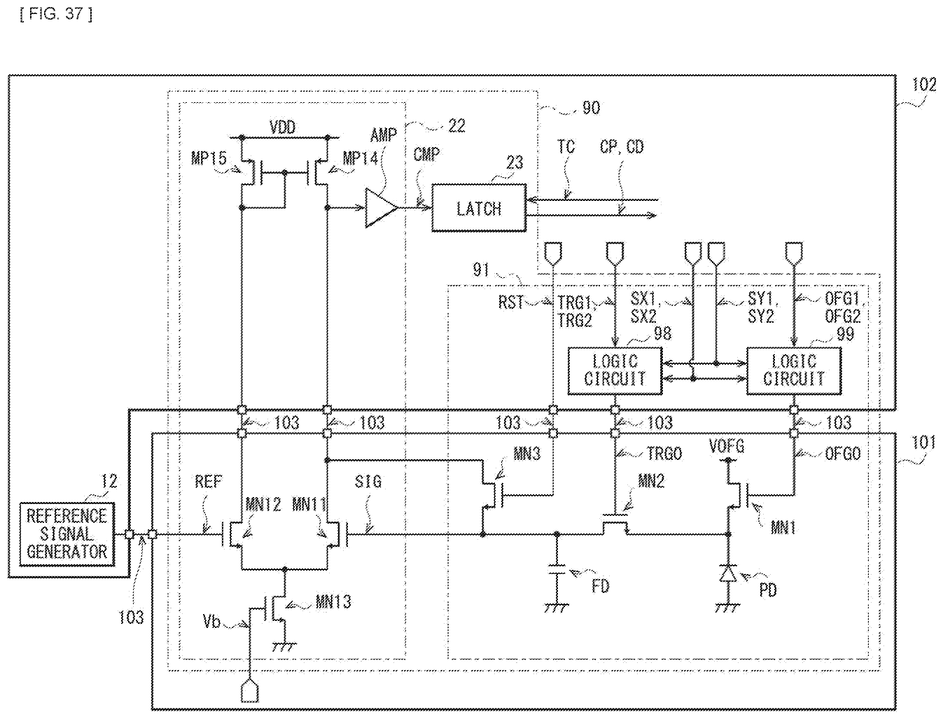

FIG. 35 illustrates an example of regions of the plurality of pixels P related to the imaging operation in the pixel array 61. Regions W5 and W6 each indicate a region where a ROI image is desired to be obtained in the pixel array 61.

As illustrated in FIG. 35, the selection control circuit 31 sets the selection signals SX1 related to the region W5 of the plurality of selection signals SX1 to “1”, and sets the other selection signals SX1 to “0”. The selection control circuit 32 sets the selection signals SY1 related to the region W5 of the plurality of selection signals SY1 to “1”, and sets the other selection signals SY1 to “O”. In addition, the selection control circuit 131 sets the selection signals SX2 related to the region W6 of the plurality of selection signals SX2 to “1”, and sets the other selection signals SX2 to “0”. The selection control circuit 132 sets the selection signals SY2 related to the region W6 of the plurality of selection signals SY2 to “1”, and sets the other selection signals SY2 to “0”. In this example, the region W5 and the region W6 overlap each other in the longitudinal direction. Thus, in the pixel array 61, two regions in which the pixel circuits 70 are changed to the selected state are set.

The pixel circuits 70 that are in the selected state each generate the pixel signal SIG including the pixel voltage Vpix corresponding to the amount of received light, and perform AD conversion on the basis of the pixel signal SIG to generate the code values CP and CD. The signal processor 16 generates image data of a captured image on the basis of the code values CP and CD generated in a plurality of pixel circuits 70 belonging to two regions W5 and W6. This makes it possible for the imaging device 3 to obtain two ROI images.

Thus, the imaging device 3 includes a third selection control circuit (selection control circuit 132) that generates a plurality of third selection signals (selection signals SY2), and a fourth selection control circuit that generates a plurality of fourth selection signals (selection signals SX2). Each of the plurality of pixel circuits 70 is supplied with a third signal that is one of the plurality of third selection signals (selection signals SY2), and is supplied with a fourth signal that is one of the plurality of fourth selection signals (selection signals SX2). The first circuit (logic circuit 78) controls the operation of the first switch (transistor MN2) on the basis of the first signal (selection signal SY1), the second signal (selection signal SX1), the third signal (selection signal SY2), the fourth signal (selection signal SX2), and the first control signal (control signal TRG). In addition, the second circuit (logic circuit 79) controls the operation of the second switch (transistor MN1) on the basis of the first signal (selection signal SY1), the second signal (selection signal SX1), the third signal (selection signal SY2), the fourth signal (selection signal SX2), and the second control signal (control signal OFG). Accordingly, for example, it is possible for the pixel circuits 70 to obtain two ROI images even in a case where two regions overlap each other in the lateral direction or the longitudinal direction as with the operation example E35, which makes it possible to enhance the degree of freedom in the imaging operation.

As described above, in the present embodiment, the third selection control circuit that generates the plurality of third selection signals and the fourth selection control circuit that generates the plurality of fourth selection signals are provided. Each of the plurality of pixel circuits is supplied with the third signal that is one of the plurality of third selection signals, and is supplied with the fourth signal that is one of the plurality of fourth selection signals. The first circuit controls the operation of the first switch on the basis of the first signal, the second signal, the third signal, the fourth signal, and the first control signal. In addition, the second circuit controls the operation of the second switch on the basis of the first signal, the second signal, the third signal, the fourth signal, and the second control signal. This makes it possible to enhance the degree of freedom in the imaging operation.

### Modification Example 3

In the embodiment described above, the selection control circuit 31 that generates the plurality of selection signals SX1, the selection control circuit 32 that generates the plurality of selection signals SY1, the selection control circuit 131 that generates the plurality of selection signals SX2, and the selection control circuit 132 that generates the plurality of selection signals SY2 are provided, and the control signals TRG and OFG are supplied to the pixel circuits selected by the plurality of selection signals SX1 and the plurality of selection signals SY1, and the pixel circuits selected by the plurality of selection signals SX2 and the plurality of selection signals SY2, but this is not limitative. Instead of this, for example, the selection control circuit that generates the plurality of selection signals SX1, the selection control circuit that generates the plurality of selection signals SY1, the selection control circuit that generates the plurality of selection signals SX2, the selection control circuit that generates the plurality of selection signals SY2, a selection control circuit that generates a plurality of selection signals SX3, and a selection control circuit that generates a plurality of selection signals SY3 may be provided, and the control signals TRG and OFG may be supplied to pixel circuits selected by the plurality of selection signals SX1 and the plurality of selection signals SY1, pixel circuits selected by the plurality of selection signals SX2 and the plurality of selection signals SY2, and pixel circuits selected by the plurality of selection signals SX3 and the plurality of selection signals SY3. In this case, for example, it is possible to obtain three ROI images even in a case where three regions overlap each other in the lateral direction or the longitudinal direction.

### 4. Fourth Embodiment

Next, description is given of an imaging device 4 according to a fourth embodiment. In the present embodiment, the selection control circuit that generates the plurality of selection signals SX1, the selection control circuit that generates the plurality of selection signals SY1, the selection control circuit that generates the plurality of selection signals SX2, and the selection control circuit that generates the plurality of selection signals SY2 are provided, and the control signals TRG1 and OFG1 are supplied to pixel circuits selected by the plurality of selection signals SX1 and the plurality of selection signals SY1, and the control signals TRG2 and OFG2 are supplied to pixel circuits selected by the plurality of selection signals SX2 and the plurality of selection signals SY2. It is to be noted that components substantially the same as those of the imaging device 3 according to the third embodiment described above are denoted by the same reference numerals, and description thereof is omitted as appropriate.

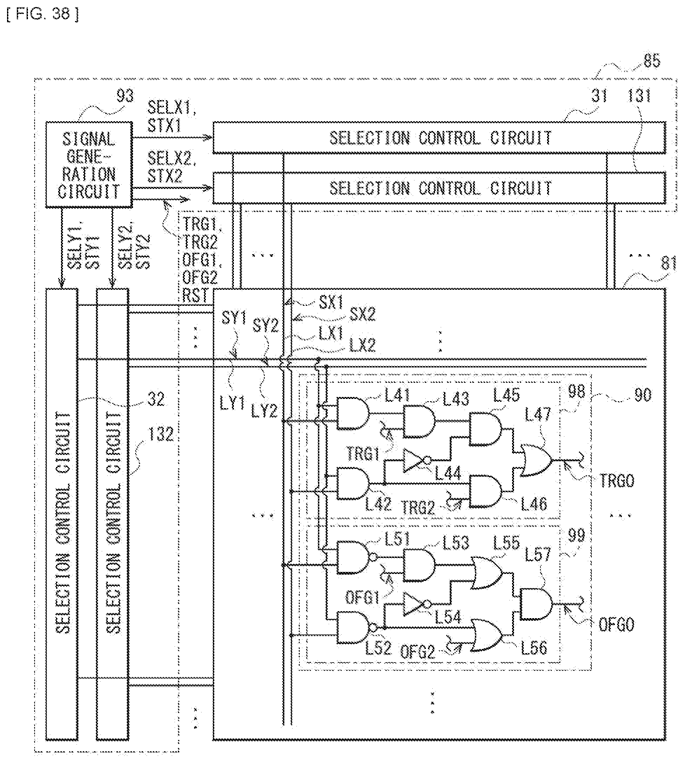

FIG. 36 illustrates a configuration example of the imaging device 4. The imaging device 4 includes a pixel array 81 and a pixel driver 85.

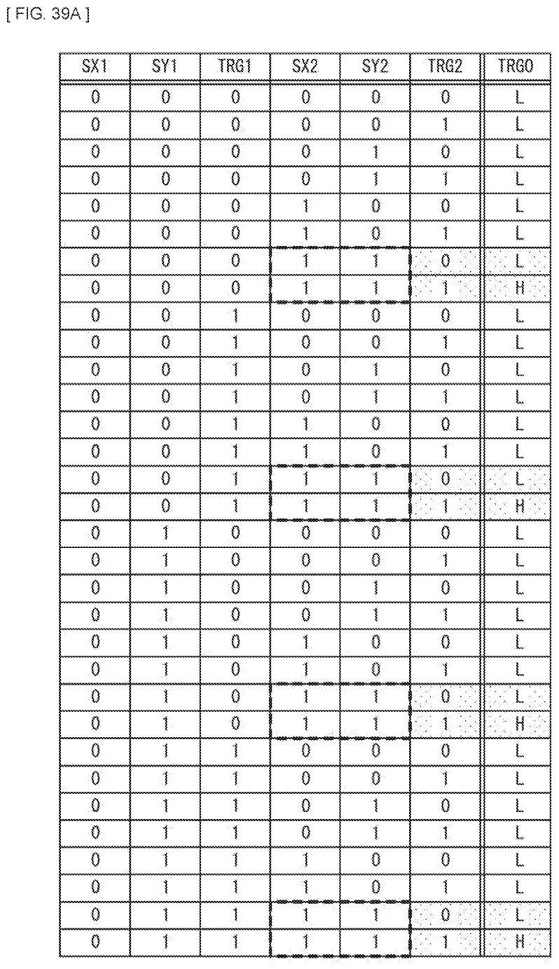

FIG. 37 illustrates a configuration example of a pixel circuit 90 related to the pixel P. The pixel circuit 90 includes a light reception circuit 91. The light reception circuit 91 includes logic circuits 98 and 99.

The logic circuit 98 is configured to generate the control signal TRG0 on the basis of the control signals TRG1 and TRG2, and the selection signals SX1, SY1, SX2, and SY2 supplied from the pixel driver 85 (FIG. 36).

The logic circuit 99 is configured to generate the control signal OFG0 on the basis of the control signals OFG1 and OFG2, and the selection signals SX1, SY1, SX2, and SY2 supplied from the pixel driver 85 (FIG. 36).

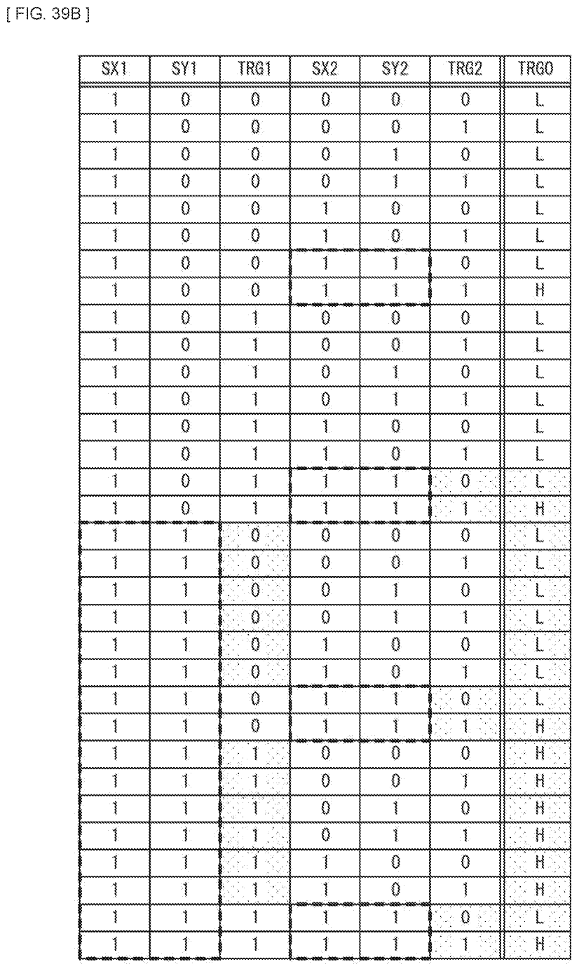

FIG. 38 illustrates a configuration example of the pixel driver 85 and the logic circuits 98 and 99.

The logic circuit 98 includes AND circuits L41 to L43, an inverter L44, AND circuits L45 and L46, and an OR circuit L47. The AND circuit L41 has two input terminals each coupled to a corresponding one of the selection signal line LX1 and the selection signal line LY1. The AND circuit L41 is configured to find AND of the selection signal SX1 and the selection signal SY1. The AND circuit L42 has two input terminals each coupled to a corresponding one of the selection signal line LX2 and the selection signal line LY2. The AND circuit L42 is configured to find AND of the selection signal SX2 and the selection signal SY2. The AND circuit L43 is configured to find AND of an output signal of the AND circuit L41 and the control signal TRG1 supplied from the signal generation circuit 93. The inverter L44 is configured to generate an inverted signal of an output signal of the AND circuit L42. The AND circuit L45 is configured to find AND of an output signal of the AND circuit L43 and an output signal of the inverter L44. The AND circuit L46 is configured to find AND of an output signal of the AND circuit L42 and the control signal TRG2 supplied from the signal generation circuit 93. The OR circuit L47 is configured to find OR of an output signal of the AND circuit L45 and an output signal of the AND circuit L46 and output a result of the OR as the control signal TRG0.

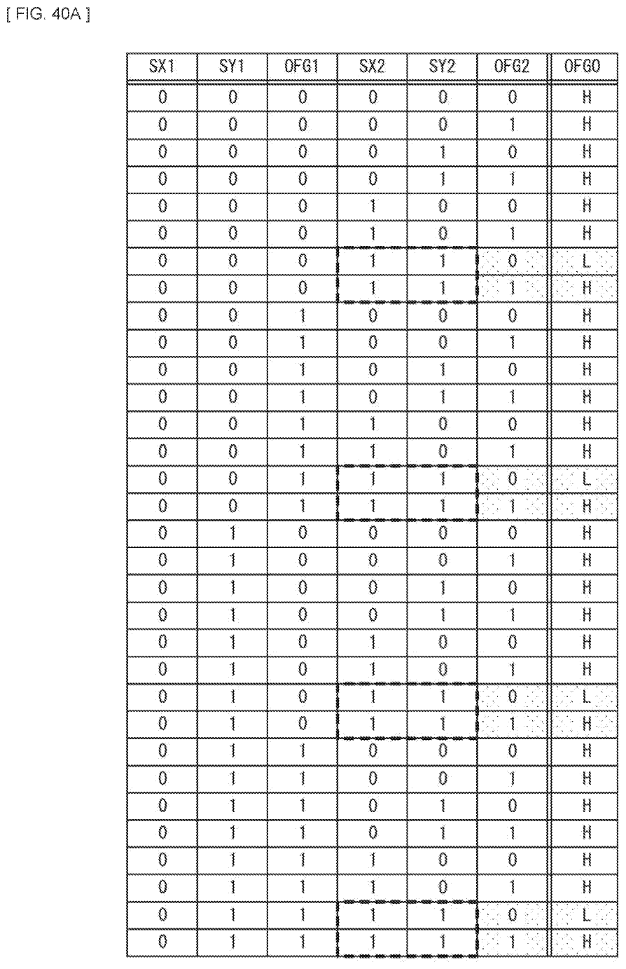

FIGS. 39A and 39B each illustrate an example of a truth table of the logic circuit 98. As indicated by a broken line, the logic circuit 98 outputs the control signal TRG1 as the control signal TRG0 in a case where both the selection signals SX1 and SY1 are at the high level and at least one of the selection signal SX2 or SY2 is at the low level. The logic circuit 98 outputs the control signal TRG2 as the control signal TRG0 in a case where both the selection signals SX2 and SY2 are at the high level. Further, the logic circuit 98 changes the control signal OFG0 to the low level in other cases.

Thus, basically, the logic circuit 98 outputs the control signal TRG1 as the control signal TRG0 in a case where both the selection signals SX1 and SY1 are at the high level, and outputs the control signal TRG2 as the control signal TRG0 in a case where both the selection signals SX2 and SY2 are at the high level. Further, in a case where both the selection signals SX1 and SY1 are at the high level and both the selection signals SX2 and SY2 are at the high level, high priority is given to the selection signals SX2 and SY2, and the logic circuit 98 outputs the control signal TRG2 as the control signal TRG0.

The logic circuit 99 includes NAND circuits L51 and L52, an AND circuit L53, an inverter L54, OR circuits L55 and L56, and an AND circuit L57. The NAND circuit L51 has two input terminals each coupled to a corresponding one of the selection signal line LX1 and the selection signal line LY1. The NAND circuit L51 is configured to find NAND of the selection signal SX1 and the selection signal SY1. The NAND circuit L52 has two input terminals each coupled to a corresponding one of the selection signal line LX2 and the selection signal line LY2. The NAND circuit L52 is configured to find NAND of the selection signal SX2 and the selection signal SY2. The AND circuit L53 is configured to find AND of an output signal of the NAND circuit L51 and the control signal OFG1 supplied from the signal generation circuit 93. The inverter L54 is configured to generate an inverted signal of an output signal of the NAND circuit L52. The OR circuit L55 is configured to find OR of an output signal of the AND circuit L53 and an output signal of the inverter L54. The OR circuit L56 is configured to find OR of an output signal of the NAND circuit L52 and the control signal OFG2 supplied from the signal generation circuit 93. The AND circuit L57 is configured to find AND of an output signal of the OR circuit L55 and an output signal of the OR circuit L56 and output a result of the AND as the control signal OFG0.

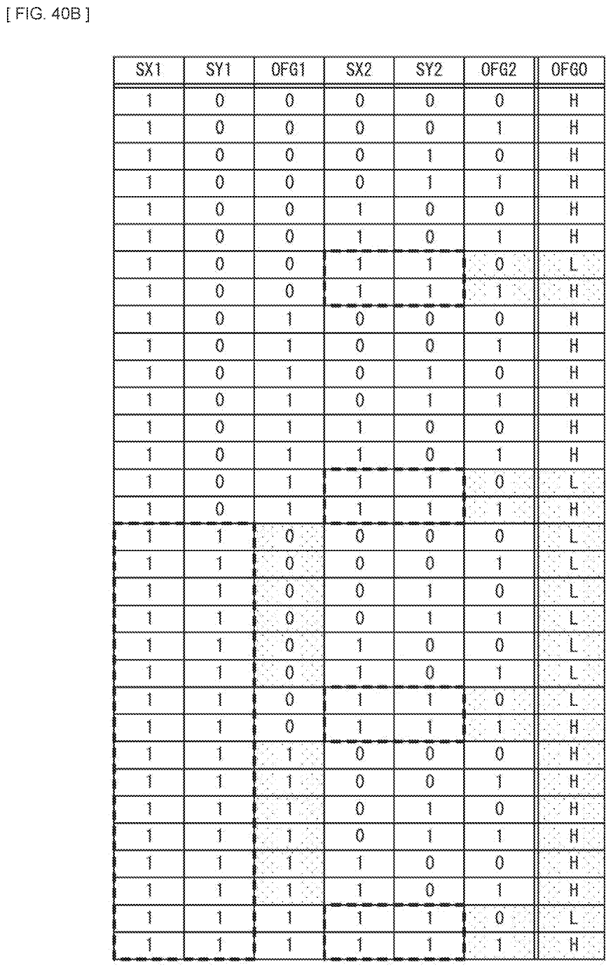

FIGS. 40A and 40B each illustrate an example of a truth table of the logic circuit 99. As indicated by a broken line, the logic circuit 98 outputs the control signal OFG1 as the control signal OFG0 in a case where both the selection signals SX1 and SY1 are at the high level and at least one of the selection signal SX2 or SY2 is at the low level. The logic circuit 99 outputs the control signal OFG2 as the control signal OFG0 in a case where both the selection signals SX2 and SY2 are at the high level. Further, the logic circuit 99 changes the control signal OFG2 to the high level in other cases.

Thus, basically, the logic circuit 99 outputs the control signal OFG1 as the control signal OFG0 in a case where both the selection signals SX1 and SY1 are at the high level, and outputs the control signal OFG2 as the control signal OFG0 in a case where both the selection signals SX2 and SY2 are at the high level. Further, in a case where both the selection signals SX1 and SY1 are at the high level and both the selection signals SX2 and SY2 are at the high level, high priority is given to the selection signals SX2 and SY2, and the logic circuit 99 outputs the control signal OFG2 as the control signal OFG0.

The pixel driver 85 (FIGS. 36 and 38) generates the control signals TRG1, TRG2, OFG1, OFG2, and RST, the plurality of selection signals SX1, the plurality of selection signals SY1, the plurality of selection signals SX2, and the plurality of selection signals SY2, and supplies these signals to the pixel array 81 to control the operations of the pixel circuits 90.

As illustrated in FIG. 38, the pixel driver 85 includes a signal generation circuit 93. The signal generation circuit 93 is configured to generate the control signals TRG1, TRG2, OFG1, OFG2, and RST, the selection signals SELX1, SELX2, SELY1, and SELY2, and the trigger signals STX1, STY1, STX2, and STY2.

Here, the signal generation circuit 93 corresponds to a specific example of a “signal generation circuit” in the present disclosure. The control signal TRG1 corresponds to a specific example of a “first control signal” in the present disclosure. The control signal OFG1 corresponds to a specific example of a “second control signal” in the present disclosure. The control signal TRG2 corresponds to a specific example of a “third control signal” in the present disclosure. The control signal OFG2 corresponds to a specific example of a “fourth control signal” in the present disclosure. The selection control circuit 32 corresponds to a specific example of a “first selection control circuit” in the present disclosure. The plurality of selection signals SY1 corresponds to a specific example of a “plurality of first selection signals” in the present disclosure. The selection control circuit 31 corresponds to a specific example of a “second selection control circuit” in the present disclosure. The plurality of selection signals SX1 corresponds to a specific example of a “plurality of second selection signals” in the present disclosure. The selection control circuit 132 corresponds to a specific example of a “third selection control circuit” in the present disclosure. The plurality of selection signals SY2 corresponds to a specific example of a “plurality of third selection signals” in the present disclosure. The selection control circuit 131 corresponds to a specific example of a “fourth selection control circuit” in the present disclosure. The plurality of selection signals SX2 corresponds to a specific example of a “plurality of fourth selection signals” in the present disclosure. A plurality of pixel circuits 90 corresponds to a specific example of a “plurality of pixel circuits” in the present disclosure. The logic circuit 98 corresponds to a specific example of a “first circuit” in the present disclosure. The logic circuit 99 corresponds to a specific example of a “second circuit” in the present disclosure.

### (Operation Example E41)

The imaging device 4 performs an imaging operation with use of all the pixels P in the pixel array 81 as with the operation example E31 of the imaging device 3, which makes it possible to obtain a captured image having high resolution.

Specifically, for example, the selection control circuit 31 sets all the plurality of selection signals SX1 to “1”, and the selection control circuit 32 sets all the plurality of selection signals SY1 to “1”. In addition, the selection control circuit 131 sets all the plurality of selection signals SX2 to “0”, and the selection control circuit 132 sets all the plurality of selection signals SY2 to “0”. Accordingly, all the pixels P (pixel circuits 90) in the pixel array 81 are changed to the selected state by the selection signals SX1 and SY1.

In addition, the signal generation circuit 93 generates the control signals TRG1, OFG1, and RST, as with the control signals TRG, OFG, and RST in the case of first embodiment (FIG. 8). In addition, for example, the signal generation circuit 93 maintains the control signal TRG2 at the low level, and maintains the control signal OFG2 at the high level.

In the pixel array 81, all the pixel circuits 90 are in the selection state. In all the pixel circuit 90, the logic circuits 98 each output the control signal TRG1 as the control signal TRG0, and the logic circuits 99 each output the control signal OFG1 as the control signal OFG0.

Accordingly, all the pixel circuits 90 in the pixel array 81 each perform the light exposure operation as illustrated in FIG. 8, and generate the pixel signal SIG including the pixel voltage Vpix corresponding to the amount of received light. Thereafter, the pixel circuits 90 each perform AD conversion on the basis of the pixel signal SIG to generate the code values CP and CD.

The signal processor 16 generates image data of a captured image on the basis of the code values CP and CD generated in the plurality of pixel circuits 90 that is in the selected state. This makes it possible for the imaging device 4 to obtain a captured image having high resolution.

### (Operation Example E42)

The imaging device 4 performs an imaging operation with use of some pixels P of the plurality of pixels P in the pixel array 81 as with the operation example E32 of the imaging device 3, which makes it possible to obtain a captured image having low resolution in which the pixel values are thinned out.

Specifically, the selection control circuit 31 sets the plurality of selection signals SX1 such that “1” appears at a ratio of one to three, such as . . . , “1”, “0”, “0”, “1”, “0”, “0”, . . . , as with the case of the first embodiment (FIG. 10). In addition, the selection control circuit 32 sets the plurality of selection signals SY1 such that “1” appears at a ratio of one to three, such as . . . , “1”, “0”, “0”, “1”, “0”, “0”, . . . , as with the case of the first embodiment (FIG. 10). In addition, the selection control circuit 131 sets all the plurality of selection signals SX2 to “0”, and the selection control circuit 132 sets all the plurality of selection signals SY2 to “0”.

In addition, the signal generation circuit 93 generates the control signals TRG1, OFG1, and RST, as with the control signals TRG, OFG, and RST in the case of the first embodiment (FIG. 8). In addition, for example, the signal generation circuit 93 maintains the control signal TRG2 at the low level, and maintains the control signal OFG2 at the high level.

Of the plurality of pixel circuits 90 in the pixel array 81, the pixel circuits 90 in which both the selection signals SX1 and SY1 are set at the high level are set to the selected state. In each of the pixel circuits 90 that are in the selected state, the logic circuit 98 outputs the control signal TRG1 as the control signal TRG0, and the logic circuit 99 outputs the control signal OFG1 as the control signal OFG0. The pixel circuits 90 that are in the selected state each perform the light exposure operation on the basis of such control signals TRG0 and OFG0, and generate the pixel signal SIG including the pixel voltage Vpix corresponding to the amount of received light as illustrated in FIG. 8. Thereafter, the pixel circuits 90 each perform AD conversion on the basis of the pixel signal SIG to generate the code values CP and CD.

In addition, of the plurality of pixel circuits 90 in the pixel array 81, the pixel circuits 90 in which at least one of the selection signal SX1 or SY1 is set at the low level are set to the unselected state. In each of the pixel circuits 90 that are in the unselected state, the logic circuit 98 maintains the control signal TRG0 at the low level, and the logic circuit 79 maintains the control signal OFG0 at the high level. Accordingly, the pixel circuits 90 that are in the unselected state do not perform the light exposure operation.

The signal processor 16 generates image data of a captured image on the basis of the code values CP and CD generated in a plurality of pixel circuits 90 that is in the selected state. This makes it possible for the imaging device 4 to obtain a captured image having low resolution.

### (Operation Example E43)

As with the operation example E33 of the imaging device 3, in a case where the imaging device 4 performs an imaging operation with use of some pixels P of the plurality of pixels P in the pixel array 81, it is possible to reduce a noise component included in a pixel value with use of the code values CP and CD related to the pixel circuits 50 that are in the unselected state.

### (Operation Example E44)

The imaging device 4 selects the plurality of pixel P in the pixel array 81 in pixel line units to perform an imaging operation as with the operation example E34 of the imaging device 3, which makes it possible to perform an interlace operation. Specifically, in the imaging device 4, it is possible to cause the light exposure periods to overlap each other between sub-frames. This operation is described in detail below.

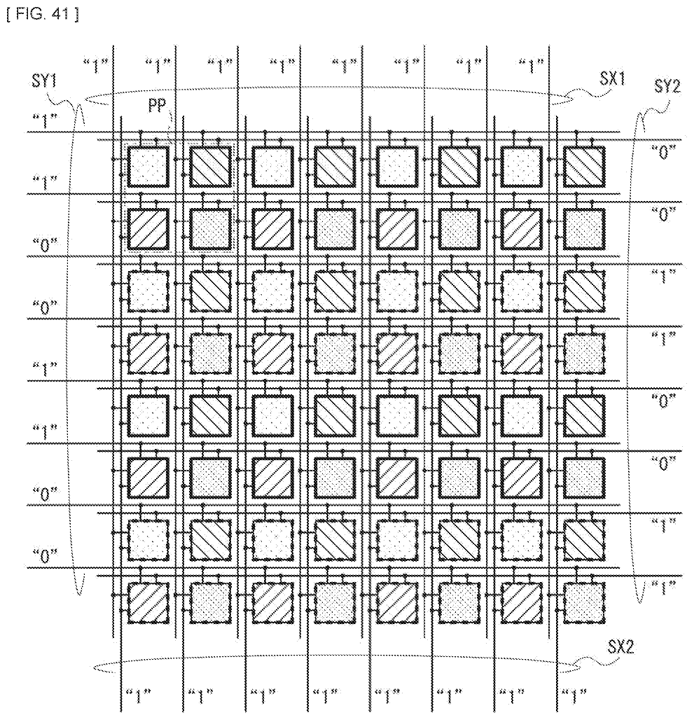

FIG. 41 illustrates an example of the pixels P related to the imaging operation in the pixel array 81. In FIG. 41, the pixels P each indicated by a thick line indicate the pixels P that are changed to the selected state by the selection signals SX1 and SY1, and the pixels P each indicated by a broken line indicate the pixels P that are changed to the unselected state by the selection signals SX2 and SY2.

The selection control circuit 31 sets all the plurality of selection signals SX1 to “1”. In addition, the selection control circuit 32 sets the plurality of selection signals SY1 such that two “1” and two “0” are repeated, such as . . . , “1”, “1”, “0”, “0”, “1”, “1”, “0”, “0”, . . . . The selection control circuit 131 sets all the plurality of selection signals SX2 to “1”. In addition, the selection control circuit 132 sets the plurality of selection signals SY2 such that two “1” and two “0” are repeated, such as . . . , “0”, “0”, “1”, “1”, “0”, “0”, “1”, “1”, . . . . In this example, in FIG. 41, the pixels P belonging to first and second pixel lines from top are changed to the selected state by the selection signals SX1 and SY1, the pixels P belonging to third and fourth pixel lines from top are changed to the selected state by the selection signals SX2 and SY2, the pixels P belonging to fifth and sixth pixel lines from top are changed to the selected state by the selection signals SX1 and SY1, and the pixels P belonging to seventh and eighth pixel lines from top are changed to the selected state by the selection signals SX2 and SY2,

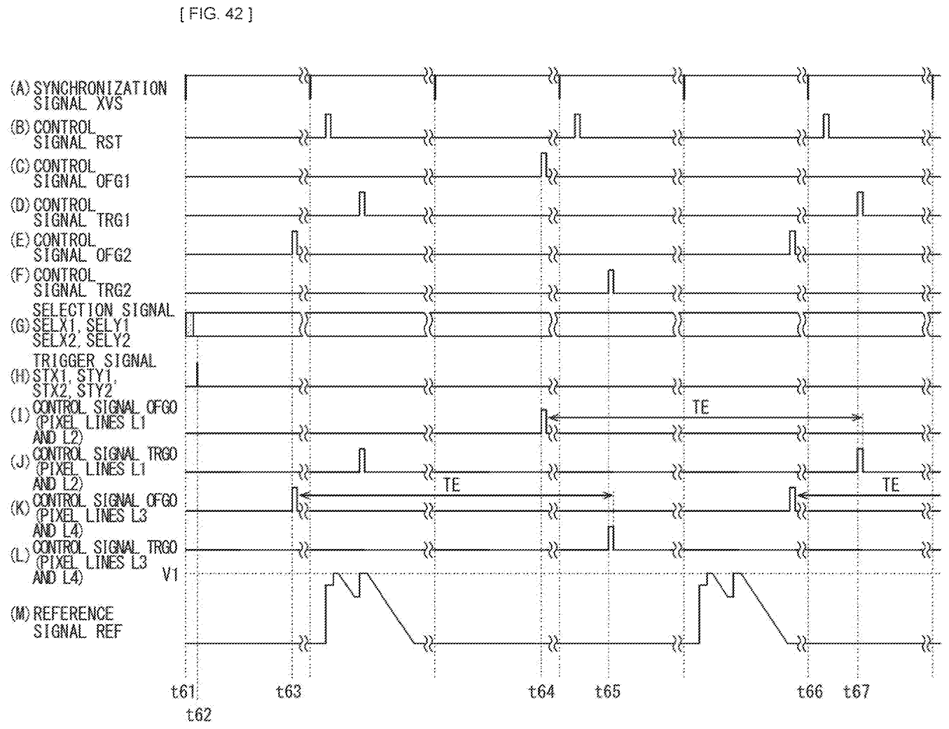

FIG. 42 illustrates an operation example of the pixel circuits 90 in the operation example E44, where (A) indicates a waveform of the synchronization signal XVS, (B) indicates a waveform of the control signal RST, (C) indicates a waveform of the control signal OFG1, (D) indicates a waveform of the control signal TRG1, (E) indicates a waveform of the control signal OFG1, (F) indicates a waveform of the control signal TRG2, (G) indicates the selection signals SELX1, SELY1, SELX2, and SELY2, (H) indicates waveforms of the trigger signals STX1, STY1, STX2, and STY2, (I) indicates a waveform of the control signal OFG0 in the pixel circuits 90 belonging to the first pixel line L1 and the second pixel line L2, (J) indicates a waveform of the control signal TRG0 in the pixel circuits 90 belonging to the first pixel line L1 and the second pixel line L2, (K) indicates a waveform of the control signal OFG0 in the pixel circuits 90 belonging to the third pixel line L3 and the fourth pixel line L4, (L) indicates a waveform of the control signal TRG0 in the pixel circuits 90 belonging to the third pixel line L3 and the fourth pixel line L4, and (M) indicates a waveform of the reference signal REF.

For example, in a case of setting to this operation mode, first, at a timing t61, the signal generation circuit 93 of the pixel driver 85 supplies the selection signal SELX1 that is a serial signal to the selection control circuit 31, supplies the selection signal SELY1 that is a serial signal to the selection control circuit 32, supplies the selection signal SELX2 that is a serial signal to the selection control circuit 131, and supplies the selection signal SELY2 that is a serial signal to the selection control circuit 132 ((G) of FIG. 42).

Thereafter, at a timing t62 after the signal generation circuit 93 finishes supplying the selection signals SELX1, SELY1, SELX2, and SELY2, the signal generation circuit 93 generates the trigger signals STX1, STY1, STX2, and STY2 ((H) of FIG. 42). Accordingly, the selection control circuit 31 supplies the plurality of selection signals SX1 corresponding to the selection signal SELX1 to the pixel array 81 via the plurality of selection signal lines LX1, the selection control circuit 32 supplies the plurality of selection signals SY1 corresponding to the selection signal SELY1 to the pixel array 81 via the plurality of selection signal lines LY1, the selection control circuit 131 supplies the plurality of selection signals SX2 corresponding to the selection signal SELX2 to the pixel array 81 via the plurality of selection signal lines LX2, and the selection control circuit 132 supplies the plurality of selection signals SY2 corresponding to the selection signal SELY2 to the pixel array 81 via the plurality of selection signal lines LY2.

In each of the pixel circuits 90 belonging to the pixel lines L1 and L2, the logic circuit 98 outputs the control signal TRG1 as the control signal TRG0 ((D) and (J) of FIG. 42), and the logic circuit 99 outputs the control signal OFG1 as the control signal OFG0 ((C) and (I) of FIG. 42). For example, the logic circuit 99 changes the control signal OFG0 from the low level to the high level at a timing t64, and changes the control signal OFG0 from the high level to the low level after a lapse of a predetermined time from the timing t64 ((I) of FIG. 42). In addition, the logic circuit 98 changes the control signal TRG0 from the low level to the high level at a timing t67, and changes the control signal TRG0 from the high level to the low level after a lapse of a predetermined time from the timing t67 ((J) of FIG. 42). Thus, the light exposure period TE is set. The pixel circuits 90 belonging to the pixel lines L1 and L2 each perform the light exposure operation on the basis of such control signals TRG0 and OFG0, and generate the pixel signal SIG including the pixel voltage Vpix corresponding to the amount of received light as illustrated in FIG. 8. Thereafter, the pixel circuits 90 each performs AD conversion on the basis of the pixel signal SIG to generate the code values CP and CD.

In each of the pixel circuits 90 belonging to the pixel lines L3 and L4, the logic circuit 98 outputs the control signal TRG2 as the control signal TRG0 ((F) and (L) of FIG. 42), and the logic circuit 99 outputs the control signal OFG2 as the control signal OFG0 ((E) and (K) of FIG. 42). For example, the logic circuit 99 changes the control signal OFG0 from the low level to the high level at a timing t63, and changes the control signal OFG0 from the high level to the low level after a lapse of a predetermined time from the timing t63 ((K) of FIG. 42). In addition, the logic circuit 88 changes the control signal TRG0 from the low level to the high level at a timing t65, and changes the control signal TRG0 from the high level to the low level after a lapse of a predetermined time from the timing t65 ((L) of FIG. 42). Thus, the light exposure period TE is set. The pixel circuits 90 belonging to the pixel lines L3 and L4 each perform the light exposure operation on the basis of such control signals TRG0 and OFG0, and generate the pixel signal SIG including the pixel voltage Vpix corresponding to the amount of received light as illustrated in FIG. 8. Thereafter, the pixel circuits 90 each perform AD conversion on the basis of the pixel signal SIG to generate the code values CP and CD.

In this example, the length of the light exposure period TE is longer than that in the case of the first embodiment described above (FIG. 4). The light exposure period TE related to the pixel circuits 90 belonging to the pixel lines L1 and L2 and the light exposure period TE related to the pixel circuits 90 belonging to the pixel lines L3 and L4 partially overlap each other.

The signal processor 16 generates image data of a captured image on the basis of the code values CP and CD generated in a plurality of pixel circuits 90 that is in the selected state, and generates image data of a captured image on the basis of the code values CP and CD generated in a plurality of pixel circuits 50 that is in the unselected state. This makes it possible for the imaging device 4 to perform the interlace operation.

### (Operation Example E45)

The imaging device 4 performs an imaging operation with use of a plurality of pixels P belonging to a certain image region of the plurality of pixels P in the pixel array 81 as with the operation example E35 of the imaging device 3, which makes it possible to obtain a ROI image. Specifically, in the imaging device 4, it is possible to set two ROI regions of which the light exposure periods TE are different in length from each other. This operation is described in detail below.

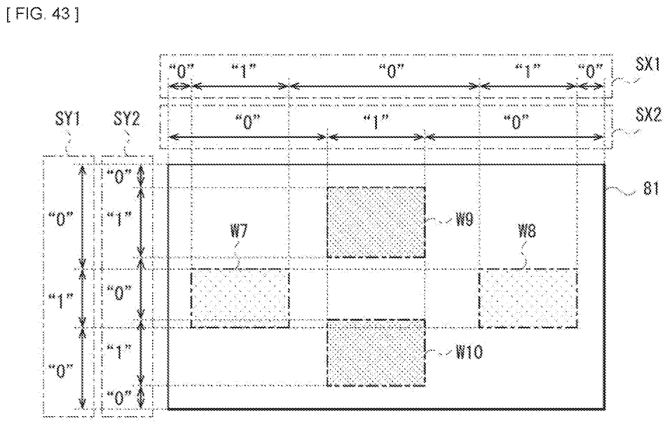

FIG. 43 illustrates an example of regions of the plurality of pixels P related to the imaging operation in the pixel array 81. Regions W7 to W10 each indicate a region where a ROI image is desired to be obtained in the pixel array 81.

As illustrated in FIG. 43, the selection control circuit 31 sets the selection signals SX1 related to the regions W7 and W8 of the plurality of selection signals SX1 to “1”, and sets the other selection signals SX1 to “0”. The selection control circuit 32 sets the selection signals SY1 related to the regions W7 and W8 of the plurality of selection signals SY1 to “1”, and sets the other selection signals SY1 to “0”. In addition, the selection control circuit 131 sets the selection signals SX2 related to the regions W9 and W10 of the plurality of selection signals SX2 to “1”, and sets the other selection signals SX2 to “0”. The selection control circuit 132 sets the selection signals SY2 related to the regions W9 and W10 of the plurality of selection signals SY2 to “1”, and sets the other selection signals SY2 to “O”. In this example, the regions W7, W8, and W10 overlap each other in the longitudinal direction. Thus, in the pixel array 81, four regions in which the pixel circuits 90 are changed to the selected state are set.

The pixel circuits 90 belonging to the regions W7 and W8 are changed to the selected state by the selection signals SX1 and SY1. Accordingly, in each of these pixel circuits 90, the logic circuit 98 outputs the control signal TRG1 as the control signal TRG0, and the logic circuit 99 outputs the control signal OFG1 as the control signal OFG0. The pixel circuits 90 belonging to the regions W7 and W8 each perform the light exposure operation on the basis of such control signals TRG0 and OFG0, and generate the pixel signal SIG including the pixel voltage Vpix corresponding to the amount of received light as illustrated in FIG. 8. Thereafter, the pixel circuits 90 each perform AD conversion on the basis of the pixel signal SIG to generate the code values CP and CD.

The pixel circuits 90 belonging to the regions W9 and W10 are changed to the selected state by the selection signals SX2 and SY2. Accordingly, in each of these pixel circuits 90, the logic circuit 98 outputs the control signal TRG2 as the control signal TRG0, and the logic circuit 99 outputs the control signal OFG2 as the control signal OFG0. The pixel circuits 90 belonging to the regions W9 and W10 each perform the light exposure operation on the basis of such control signals TRG0 and OFG0, and generate the pixel signal SIG including the pixel voltage Vpix corresponding to the amount of received light as illustrated in FIG. 8. Thereafter, the pixel circuits 90 each perform AD conversion on the basis of the pixel signal SIG to generate the code values CP and CD.

The signal processor 16 generates image data of a captured image on the basis of the code values CP and CD in four regions W7 to W10 of the code values CP and CD generated in a plurality of pixel circuits 90 that is in the selected state.

Thus, the pixel circuits 90 belonging to the regions W7 and W8 each perform the light exposure operation on the basis of the control signals TRG2 and OFG2, and the pixel circuits 90 belonging to the regions W9 and W10 each perform the light exposure operation on the basis of the control signals TRG2 and OFG2. Accordingly, for example, the length of the light exposure period TE set by the control signals TRG1 and OFG1 and the length of the light exposure period TE set by the control signals TRG2 and OFG2 are made different from each other, which makes it possible to obtain a plurality of ROI images of which the light exposure periods are different in length from each other.

Thus, in the imaging device 4, the signal generation circuit 93 generates the third control signal (control signal TRG2) and the fourth control signal (control signal OFG2). Thereafter, the first circuit (logic circuit 98) controls the operation of the first switch (transistor MN2) on the basis of the first signal (selection signal SY1), the second signal (selection signal SX1), the third signal (selection signal SY2), the fourth signal (selection signal SX2), the first control signal (control signal TRG1), and the third control signal (control signal TRG2). In addition, the second circuit (logic circuit 99) controls the operation of the second switch (transistor MN1) on the basis of the first signal (selection signal SY1), the second signal (selection signal SX1), the third signal (selection signal SY2), the fourth signal (selection signal SX2), the second control signal (control signal OFG1), and the fourth control signal (control signal OFG2). Accordingly, for example, it is possible for the pixel circuits 90 to obtain two ROI images of which the light exposure periods TE are different in length from each other as with the operation example E45, which makes it possible to enhance the degree of freedom in the imaging operation.

As described above, in the present embodiment, the signal generation circuit generates the third control signal and the fourth control signal. Thereafter, the first circuit controls the operation of the first switch on the basis of the first signal, the second signal, the third signal, the fourth signal, the first control signal, and the third control signal. In addition, the second circuit controls the operation of the second switch on the basis of the first signal, the second signal, the third signal, the fourth signal, the second control signal, and the fourth control signal. This makes it possible to enhance the degree of freedom in the imaging operation.

### Modification Example 4

In the embodiment described above, the plurality of pixels P is provided in the pixel array 81. The pixels P may include a pixel for obtaining a defocusing value in the imaging device 4, as with the modification example 2.

In this case, the pixel array 81 according to the present modification example includes six pixels (pixels PR, PGr, PGb, PB, PF1, and PF2) as with the pixel array 41A (FIG. 27) according to the modification example 2. The pixels PF1 and PF2 are so-called phase difference pixels for obtaining the defocusing value.

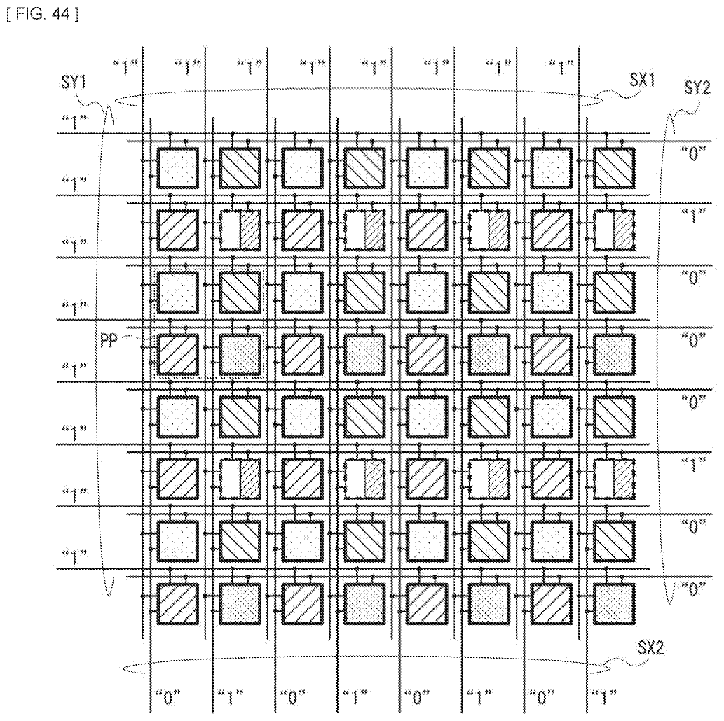

FIG. 44 illustrates an example of the pixels P related to the imaging operation in the pixel array 81 according to the present modification example. In FIG. 44, the pixels P each indicated by a thick line indicate the pixels P that are changed to the selected state by the selection signals SX1 and SY1, and the pixels P each indicated by a broken line indicate the pixels P that are changed to the unselected state by the selection signals SX2 and SY2.

As illustrated in FIG. 44, the selection control circuit 31 sets all the plurality of selection signals SX1 to “1”, and the selection control circuit 32 sets all the plurality of selection signals SY1 to “1”. In addition, the selection control circuits 131 and 132 set the plurality of selection signals SX2 and the plurality of selection signals SY2 in accordance with positions of the pixels PF1 and PF2. Specifically, in this example, the selection control circuit 131 sets the plurality of selection signals SX2 such as . . . , “0”, “1”, “0”, “1”, “0”, “1”, “0”, “1”, . . . , and the selection control circuit 132 sets the plurality of selection signals SY2 such as . . . , “0”, “1”, “0”, “0”, “0”, “1”, “0”, “0”, . . . . Accordingly, the pixels PF1 and PF2 supplied with the selection signal SX2 that is at the high level and the selection signal SY2 that is at the high level are changed to the selected state by the selection signals SX2 and SY2, and the other pixels P are changed to the selected state by the selection signals SX1 and SY1. In other words, the pixels PF1 and PF2 are supplied with the selection signals SX1, SY1, SX2, and SY2 that are at the high level; however, high priority is given to the selection signals SX2 and SY2. Accordingly, the pixels PF1 and PF2 are changed to the selected state by the selection signals SX2 and SY2.

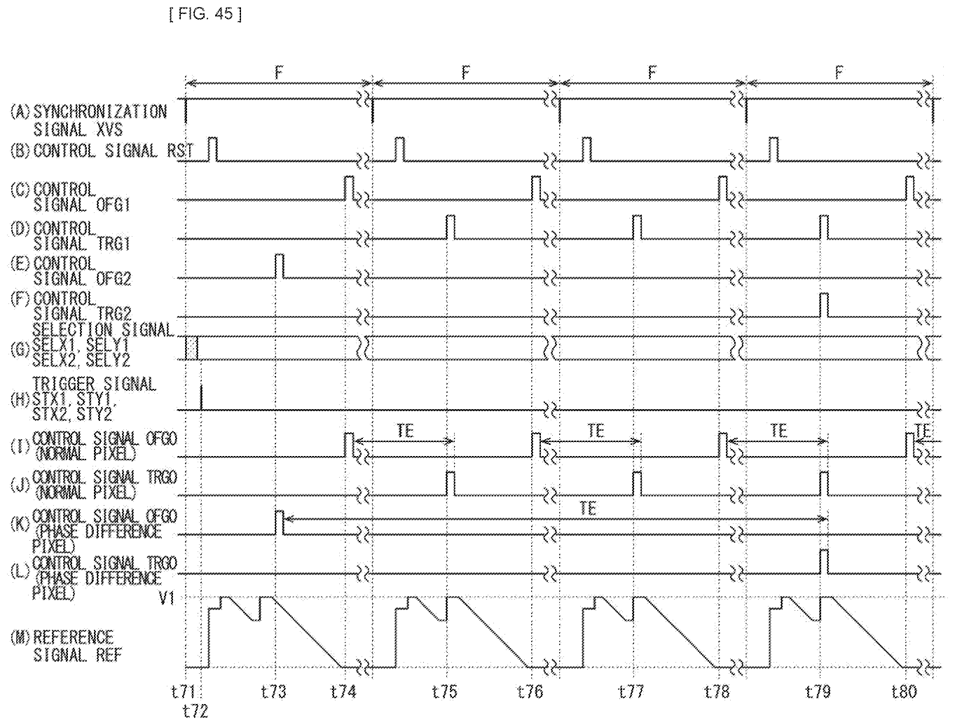

FIG. 45 illustrates an operation example of the pixel circuits 90 related to the pixels P according to the present modification example, where (A) indicates a waveform of the synchronization signal XVS, (B) indicates a waveform of the control signal RST, (C) indicates a waveform of the control signal OFG1, (D) indicates a waveform of the control signal TRG1, (E) indicates a waveform of the control signal OFG2, (F) indicates a waveform of the control signal TRG2, (G) indicates the selection signals SELX1, SELY1, SELX2, and SELY2, (H) indicates waveforms of the trigger signals STX1, STY1, STX2, and STY2, (I) indicates a waveform of the control signal OFG0 in the pixel circuits 90 of normal pixels (pixels PR, PGr, PGb, and PB), (J) indicates a waveform of the control signal TRG0 in the pixel circuits 90 of the normal pixels, (K) indicates a waveform of the control signal OFG0 in the pixel circuits 90 of the phase difference pixels (pixels PF1 and PF2), (L) indicates a waveform of the control signal TRG0 in the pixel circuits 90 of the phase difference pixels, and (M) indicates a waveform of the reference signal REF.

For example, in a case of setting to this operation mode, first, in the frame period F starting from a timing t71, the signal generation circuit 93 of the pixel driver 85 supplies the selection signal SELX1 that is a serial signal to the selection control circuit 31, supplies the selection signal SELY1 that is a serial signal to the selection control circuit 32, supplies the selection signal SELX2 that is a serial signal to the selection control circuit 131, and supplies the selection signal SELY2 that is a serial signal to the selection control circuit 132 ((G) of FIG. 45).

Thereafter, at a timing t72 after the signal generation circuit 93 finishes supplying the selection signals SELX1, SELY1, SELX2, and SELY2, the signal generation circuit 93 generates the trigger signals STX1, STY1, STX2, and STY2 ((H) of FIG. 45). Accordingly, the selection control circuit 31 supplies the plurality of selection signals SX1 corresponding to the selection signal SELX1 to the pixel array 81 via the plurality of selection signal lines LX1, the selection control circuit 32 supplies the plurality of selection signals SY1 corresponding to the selection signal SELY1 to the pixel array 81 via the plurality of selection signal lines LY1, the selection control circuit 131 supplies the plurality of selection signals SX2 corresponding to the selection signal SELX2 to the pixel array 81 via the plurality of selection signal lines LX2, and the selection control circuit 132 supplies the plurality of selection signals SY2 corresponding to the selection signal SELY2 to the pixel array 81 via the plurality of selection signal lines LY2.

In each of the pixel circuits 90 in the phase difference pixels (pixels PF1 and PF2), the logic circuit 98 outputs the control signal TRG2 as the control signal TRG0 ((F) and (L) of FIG. 45), and the logic circuit 99 outputs the control signal OFG2 as the control signal OFG0 ((E) and (K) of FIG. 45). For example, the logic circuit 99 changes the control signal OFG0 from the low level to the high level at a timing t73, and changes the control signal OFG0 from the high level to the low level after a lapse of a predetermined time from the timing t73 ((K) of FIG. 45). In addition, the logic circuit 98 changes the control signal TRG0 from the low level to the high level at a timing t79, and changes the control signal TRG0 from the high level to the low level after a lapse of a predetermined time from the timing t79 ((L) of FIG. 45). Thus, the light exposure period TE is set. The pixel circuits 90 each perform the light exposure operation on the basis of such control signals TRG0 and OFG0, and generate the pixel signal SIG including the pixel voltage Vpix corresponding to the amount of received light as illustrated in FIG. 8. Thereafter, the pixel circuits 90 each perform AD conversion on the basis of the pixel signal SIG to generate the code values CP and CD.

In the pixel circuits 90 in the normal pixels (pixels PR, PGr, PGb, and PB), the logic circuit 98 outputs the control signal TRG1 as control signal TRG0 ((D) and (J) of FIG. 45), and the logic circuit 89 outputs the control signal OFG1 as the control signal OFG0 ((C) and (I) of FIG. 45). For example, the logic circuit 99 changes the control signal OFG0 from the low level to the high level at a timing t74, and changes the control signal OFG0 from the high level to the low level after a lapse of a predetermined time from the timing t74 ((I) of FIG. 45). In addition, the logic circuit 98 changes the control signal TRG0 from the low level to the high level at a timing t75, and changes the control signal TRG0 from the high level to the low level after a lapse of a predetermined time from the timing t75 ((J) of FIG. 45). Thus, the light exposure period TE is set. The pixel circuits 90 each perform the light exposure operation on the basis of such control signals TRG0 and OFG0, and generate the pixel signal SIG including the pixel voltage Vpix corresponding to the amount of received light as illustrated in FIG. 8. Thereafter, the pixel circuits 90 each perform AD conversion on the basis of the pixel signal SIG to generate the code values CP and CD. The same applies to a period from a timing t76 to a timing t77, and the same applies to a period from a timing t78 to a timing t79.

For example, the signal processor 16 generates phase difference data on the basis of the code values CP and CD generated in a plurality of pixel circuits 90 corresponding to a plurality of phase difference pixels, and generates image data of a captured image on the basis of the code values CP and CD generated in a plurality of pixel circuits 90 corresponding to a plurality of normal pixels. For example, in a camera including the imaging device 4, the defocusing value is determined on the basis of this phase difference data, and a position of a shooting lens is moved on the basis of the defocusing value. Thus, it is possible to achieve autofocus in the camera.

### 5. Application Example to Mobile Body

The technology (present technology) according to the present disclosure is applicable to various products. For example, the technology according to the present disclosure may be achieved in the form of an apparatus to be mounted to a mobile body of any kind such as an automobile, an electric vehicle, a hybrid electric vehicle, a motorcycle, a bicycle, a personal mobility, an airplane, a drone, a vessel, and a robot.

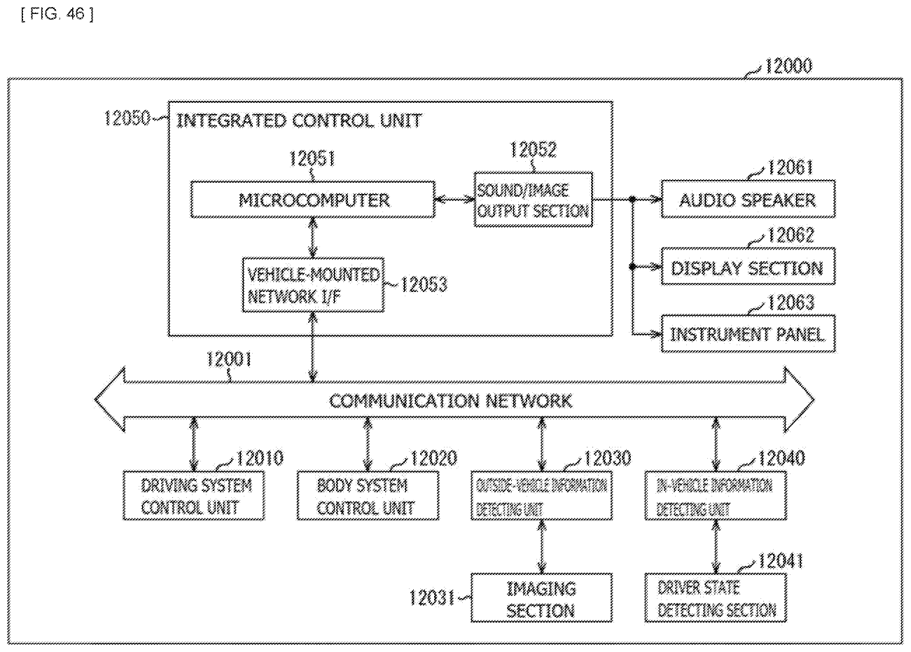

FIG. 46 is a block diagram depicting an example of schematic configuration of a vehicle control system as an example of a mobile body control system to which the technology according to an embodiment of the present disclosure can be applied.

The vehicle control system 12000 includes a plurality of electronic control units connected to each other via a communication network 12001. In the example depicted in FIG. 46, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example of FIG. 46, an audio speaker 12061, a display section 12062, and an instrument panel 12063 are illustrated as the output device. The display section 12062 may, for example, include at least one of an on-board display and a head-up display.

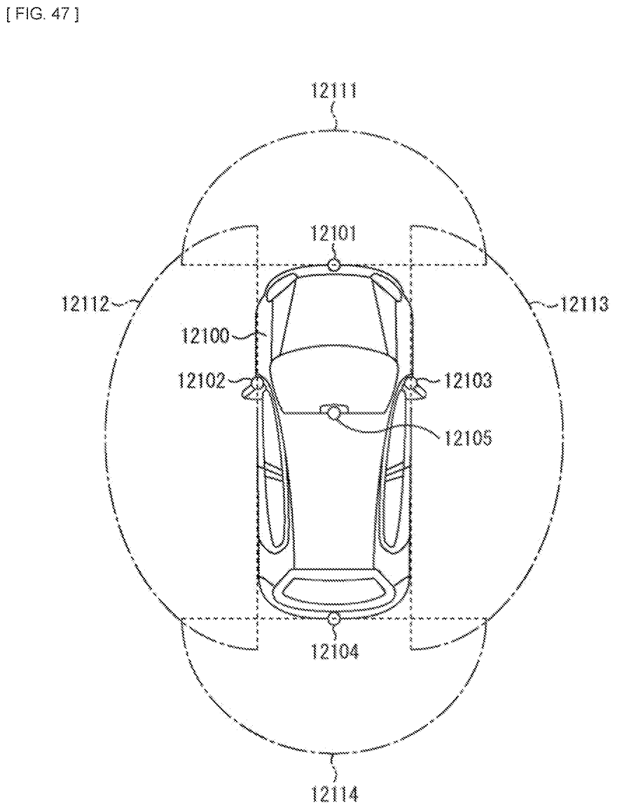

FIG. 47 is a diagram depicting an example of the installation position of the imaging section 12031.

In FIG. 47, the imaging section 12031 includes imaging sections 12101, 12102, 12103, 12104, and 12105.

The imaging sections 12101, 12102, 12103, 12104, and 12105 are, for example, disposed at positions on a front nose, sideview mirrors, a rear bumper, and a back door of the vehicle 12100 as well as a position on an upper portion of a windshield within the interior of the vehicle. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Incidentally, FIG. 47 depicts an example of photographing ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

One example of the vehicle control system to which the technology according to the present disclosure may be applied has been described above. The technology according to the present disclosure may be applied to the imaging section 12031 among the components described above. This makes it possible to perform various imaging operations in accordance with uses in the vehicle control system 12000. Accordingly, for example, it is possible to grasp an outside-vehicle environment more accurately. As a result, this allows the vehicle control system 12000 to implement, with high accuracy, collision avoidance or shock mitigation for vehicles, a following driving function based on vehicle-to-vehicle distance, a vehicle speed maintaining driving function, a warning function of collision of the vehicle, a warning function of deviation of the vehicle from a lane, and the like.

Although the present technology has been described above with reference to some embodiments, the modification examples, and specific application examples thereof, the present technology is not limited to these embodiments and the like, and may be modified in a variety of ways.

For example, in the respective embodiments described above, various imaging operations have been exemplified; however, the imaging operation is not limited thereto, and any other imaging operation may be performed.

It is to be noted that the effects described herein are merely illustrative and non-limiting, and other effects may be included.

It is to be noted that the present technology may have the following configurations. According to the present technology having the following configurations, it is possible to enhance a degree of freedom in an imaging operation.

(1)

An imaging device including:
a signal generation circuit that is configured to generate a first control signal;
a first selection control circuit that is configured to generate a plurality of first selection signals; and
a plurality of pixel circuits each including a light-receiving element, an accumulation section, a first switch, a first circuit, and a comparator circuit, the light-receiving element configured to generate electric charge corresponding to an amount of received light, the accumulation section configured to accumulate the electric charge generated by the light-receiving element, the first switch configured to couple the light-receiving element to the accumulation section by being turned on, the first circuit configured to control an operation of the first switch on the basis of one of the plurality of first selection signals and the first control signal, and the comparator circuit configured to compare a pixel signal including a voltage in the accumulation section with a reference signal having a ramp waveform.
   (2)

The imaging device according to (1), in which
the signal generation circuit is configured to further generate a second control signal,
each of the plurality of pixel circuits is supplied with a first signal that is one of the plurality of first selection signals,
the first circuit is configured to control the operation of the first switch on the basis of the first signal and the first control signal, and
each of the plurality of pixel circuits includes
a second switch that is configured to apply a predetermined voltage to the light-receiving element by being turned on, and
a second circuit that is configured to control an operation of the second switch on the basis of the first signal and the second control signal.
   (3)

The imaging device according to (2), further including a second selection control circuit that is configured to generate a plurality of second selection signals, in which
each of the plurality of pixel circuits is supplied with a second signal that is one of the plurality of second selection signals,
the first circuit is configured to control the operation of the first switch on the basis of the first signal, the second signal, and the first control signal, and
the second circuit is configured to control the operation of the second switch on the basis of the first signal, the second signal, and the second control signal.
   (4)

The imaging device according to (3), in which
each of the first signal and the second signal is active or inactive,
in each of one or more pixel circuits supplied with the first signal that is active and the second signal that is active of the plurality of pixel circuits, the first circuit is configured to control the operation of the first switch on the basis of the first control signal, and the second circuit is configured to control the operation of the second switch on the basis of the second control signal, and
in each of two or more pixel circuits other than the one or more pixel circuits of the plurality of pixel circuits, the first circuit maintains the first switch off, and the second circuit maintains the second switch on.
   (5)

The imaging device according to (4), further including:
a plurality of first selection signal lines that extends in a first direction and is provided side by side in a second direction, and is each configured to transmit a corresponding one of the plurality of first selection signals; and
a plurality of second selection signal lines that extends in the second direction and is provided side by side in the first direction, and is each configured to transmit a corresponding one of the plurality of second selection signals.
   (6)

The imaging device according to (5), in which
the plurality of pixel circuits includes
two or more pixel circuits that are provided side by side in the first direction and are coupled to one of the plurality of first selection signal lines, and
two or more pixel circuits that are provided side by side in the second direction and are coupled to one of the plurality of second selection signal lines.
   (7)

The imaging device according to (5) or (6), in which
the first selection control circuit is configured to set the plurality of first selection signals active at a ratio of one to a predetermined number, and
the second selection control circuit is configured to set the plurality of second selection signals active at a ratio of one to a predetermined number.
   (8)

The imaging device according to (5) or (6), in which the first selection control circuit is configured to set the plurality of first selection signals to alternately repeat a predetermined number of active signals and a predetermined number of inactive signals, and is configured to generate the plurality of first selection signals every time a predetermined time elapses.

(9)

The imaging device according to (6), in which
the first selection control circuit is configured to set one or more selection signals of the plurality of first selection signals active, the one or more selection signals that are to be supplied to two or more pixel circuits belonging to a first region of regions where the plurality of pixel circuits is provided, and
the second selection control circuit is configured to set one or more selection signals of the plurality of second selection signals active, the one or more selection signals that are to be supplied to the two or more pixel circuits belonging to the first region.
   (10)

The imaging device according to (3), in which
the signal generation circuit is configured to further generate a third control signal and a fourth
control signal, the first circuit is configured to control the operation of the first switch on the basis of the first signal, the second signal, the first control signal, and the third control signal, and
the second circuit is configured to control the operation of the second switch on the basis of the first signal, the second signal, the second control signal, and the fourth control signal.
   (11)

The imaging device according to (10), in which
each of the first signal and the second signal is active or inactive,
in each of one or more pixel circuits supplied with the first signal that is active and the second signal that is active of the plurality of pixel circuits, the first circuit is configured to control the operation of the first switch on the basis of the first control signal, and the second circuit is configured to control the operation of the second switch on the basis of the second control signal, and
in each of two or more pixel circuits other than the one or more pixel circuits of the plurality of pixel circuits, the first circuit is configured to control the operation of the first switch on the basis of the third control signal, and the second circuit is configured to control the operation of the second switch on the basis of the fourth control signal.
   (12)

The imaging device according to (11), in which
one or more of the light-receiving elements in the one or more pixel circuits include
a first light-receiving element provided with a light-shielding film having a first light-shielding pattern on a light reception surface, and
a second light-receiving element provided with a light-shielding film having a second light-shielding pattern on the light reception surface.
   (13)

The imaging device according to (3), further including:
a third selection control circuit that is configured to generate a plurality of third selection signals; and
a fourth selection control circuit that is configured to generate a plurality of fourth selection signals, in which
each of the plurality of pixel circuits is supplied with a third signal that is one of the plurality of third selection signals and supplied with a fourth signal that is one of the plurality of fourth selection signals,
the first circuit is configured to control the operation of the first switch on the basis of the first signal, the second signal, the third signal, the fourth signal, and the first control signal, and
the second circuit is configured to control the operation of the second switch on the basis of the first signal, the second signal, the third signal, the fourth signal, and the second control signal.
   (14)

The imaging device according to (13), in which
each of the first signal, the second signal, the third signal, and the fourth signal is active or inactive,
in each of first one or more pixel circuits supplied with the first signal that is active and the second signal that is active and second one or more pixel circuits supplied with the third signal that is active and the fourth signal that is active of the plurality of pixel circuits, the first circuit is configured to control the operation of the first switch on the basis of the first control signal, and the second circuit is configured to control the operation of the second switch on the basis of the second control signal, and
in each of two or more pixel circuits other than the first one or more pixel circuits and the second one or more pixel circuits of the plurality of pixel circuits, the first circuit maintains the first switch off, and the second circuit maintains the second switch on.
   (15)

The imaging device according to (13), in which
the signal generation circuit is configured to further generate a third control signal and a fourth control signal,
the first circuit is configured to control the operation of the first switch on the basis of the first signal, the second signal, the third signal, the fourth signal, the first control signal, and the third control signal, and
the second circuit is configured to control the operation of the second switch on the basis of the first signal, the second signal, the third signal, the fourth signal, the second control signal, and the fourth control signal.
   (16)

The imaging device according to (15), in which
each of the first signal, the second signal, the third signal, and the fourth signal is active or inactive,
in each of first one or more pixel circuits supplied with the first signal that is active and the second signal that is active of the plurality of pixel circuits, the first circuit is configured to control the operation of the first switch on the basis of the first control signal, and the second circuit is configured to control the operation of the second switch on the basis of the second control signal, and
in each of second one or more pixel circuits supplied with the third signal that is active and the fourth signal that is active of the plurality of pixel circuits, the first circuit is configured to control the operation of the first switch on the basis of the third control signal, and the second circuit is configured to control the operation of the second switch on the basis of the fourth control signal.
   (17)

The imaging device according to (16), in which, in a case where third one or more pixel circuits of the second one or more pixel circuits are included in the first one or more pixel circuits, in the third one or more pixel circuits, the first circuit is configured to control the operation of the first switch on the basis of the third control signal, and the second circuit is configured to control the operation of the second switch on the basis of the fourth control signal.

(18)

The imaging device according to (17), in which
one or more of the light-receiving elements in the third one or more pixel circuits include
a first light-receiving element provided with a light-shielding film having a first light-shielding pattern on a light reception surface, and
a second light-receiving element provided with a light-shielding film having a second light-shielding pattern on the light reception surface.
   (19)

The imaging device according to (2), in which
the first signal is active or inactive,
in each of one or more pixel circuits supplied with the first signal that is active of the plurality of pixel circuits, the first circuit is configured to control the operation of the first switch on the basis of the first control signal, and the second circuit is configured to control the operation of the second switch on the basis of the second control signal, and
in each of two or more pixel circuits other than the one or more pixel circuits of the plurality of pixel circuits, the first circuit maintains the first switch off, and the second circuit maintains the second switch on.
   (20)

An imaging method including:
generating a first control signal;
generating a plurality of first selection signals; and
in each of a plurality of pixel circuits, generating electric charge corresponding an amount of received light by a light-receiving element, coupling the light-receiving element to an accumulation section by a first switch on the basis of one of the plurality of first selection signals and the first control signal, and comparing a pixel signal including a voltage in the accumulation section with a reference signal having a ramp waveform by a comparator circuit.

This application claims the benefits of Japanese Priority Patent Application JP2021-116719 filed with the Japan Patent Office on Jul. 14, 2021, the entire contents of which are incorporated herein by reference.

It should be understood that those skilled in the art could conceive various modifications, combinations, sub-combinations, and alterations depending on design requirements and other factors, insofar as they are within the scope of the appended claims or the equivalents thereof.

1. An imaging device comprising:
a signal generation circuit that is configured to generate a first control signal;
a first selection control circuit that is configured to generate a plurality of first selection signals; and
a plurality of pixel circuits each including a light-receiving element, an accumulation section, a first switch, a first circuit, and a comparator circuit, the light-receiving element configured to generate electric charge corresponding to an amount of received light, the accumulation section configured to accumulate the electric charge generated by the light-receiving element, the first switch configured to couple the light-receiving element to the accumulation section by being turned on, the first circuit configured to control an operation of the first switch on a basis of one of the plurality of first selection signals and the first control signal, and the comparator circuit configured to compare a pixel signal including a voltage in the accumulation section with a reference signal having a ramp waveform.

2. The imaging device according to claim 1, wherein
the signal generation circuit is configured to further generate a second control signal,
each of the plurality of pixel circuits is supplied with a first signal that is one of the plurality of first selection signals,
the first circuit is configured to control the operation of the first switch on a basis of the first signal and the first control signal, and
each of the plurality of pixel circuits includes
a second switch that is configured to apply a predetermined voltage to the light-receiving element by being turned on, and
a second circuit that is configured to control an operation of the second switch on a basis of the first signal and the second control signal.

3. The imaging device according to claim 2, further comprising a second selection control circuit that is configured to generate a plurality of second selection signals, wherein
each of the plurality of pixel circuits is supplied with a second signal that is one of the plurality of second selection signals,
the first circuit is configured to control the operation of the first switch on a basis of the first signal, the second signal, and the first control signal, and
the second circuit is configured to control the operation of the second switch on a basis of the first signal, the second signal, and the second control signal.

4. The imaging device according to claim 3, wherein
each of the first signal and the second signal is active or inactive,
in each of one or more pixel circuits supplied with the first signal that is active and the second signal that is active of the plurality of pixel circuits, the first circuit is configured to control the operation of the first switch on a basis of the first control signal, and the second circuit is configured to control the operation of the second switch on a basis of the second control signal, and
in each of two or more pixel circuits other than the one or more pixel circuits of the plurality of pixel circuits, the first circuit maintains the first switch off, and the second circuit maintains the second switch on.

5. The imaging device according to claim 4, further comprising:
a plurality of first selection signal lines that extends in a first direction and is provided side by side in a second direction, and is each configured to transmit a corresponding one of the plurality of first selection signals; and
a plurality of second selection signal lines that extends in the second direction and is provided side by side in the first direction, and is each configured to transmit a corresponding one of the plurality of second selection signals.

6. The imaging device according to claim 5, wherein
the plurality of pixel circuits includes
two or more pixel circuits that are provided side by side in the first direction and are coupled to one of the plurality of first selection signal lines, and
two or more pixel circuits that are provided side by side in the second direction and are coupled to one of the plurality of second selection signal lines.

7. The imaging device according to claim 5, wherein
the first selection control circuit is configured to set the plurality of first selection signals active at a ratio of one to a predetermined number, and
the second selection control circuit is configured to set the plurality of second selection signals active at a ratio of one to a predetermined number.

8. The imaging device according to claim 5, wherein the first selection control circuit is configured to set the plurality of first selection signals to alternately repeat a predetermined number of active signals and a predetermined number of inactive signals, and is configured to generate the plurality of first selection signals every time a predetermined time elapses.

9. The imaging device according to claim 6, wherein
the first selection control circuit is configured to set one or more selection signals of the plurality of first selection signals active, the one or more selection signals that are to be supplied to two or more pixel circuits belonging to a first region of regions where the plurality of pixel circuits is provided, and
the second selection control circuit is configured to set one or more selection signals of the plurality of second selection signals active, the one or more selection signals that are to be supplied to the two or more pixel circuits belonging to the first region.

10. The imaging device according to claim 3, wherein
the signal generation circuit is configured to further generate a third control signal and a fourth control signal,
the first circuit is configured to control the operation of the first switch on a basis of the first signal, the second signal, the first control signal, and the third control signal, and
the second circuit is configured to control the operation of the second switch on a basis of the first signal, the second signal, the second control signal, and the fourth control signal.

11. The imaging device according to claim 10, wherein
each of the first signal and the second signal is active or inactive,
in each of one or more pixel circuits supplied with the first signal that is active and the second signal that is active of the plurality of pixel circuits, the first circuit is configured to control the operation of the first switch on a basis of the first control signal, and the second circuit is configured to control the operation of the second switch on a basis of the second control signal, and
in each of two or more pixel circuits other than the one or more pixel circuits of the plurality of pixel circuits, the first circuit is configured to control the operation of the first switch on a basis of the third control signal, and the second circuit is configured to control the operation of the second switch on a basis of the fourth control signal.

12. The imaging device according to claim 11, wherein
one or more of the light-receiving elements in the one or more pixel circuits include
a first light-receiving element provided with a light-shielding film having a first light-shielding pattern on a light reception surface, and
a second light-receiving element provided with a light-shielding film having a second light-shielding pattern on the light reception surface.

13. The imaging device according to claim 3, further comprising:
a third selection control circuit that is configured to generate a plurality of third selection signals; and
a fourth selection control circuit that is configured to generate a plurality of fourth selection signals, wherein
each of the plurality of pixel circuits is supplied with a third signal that is one of the plurality of third selection signals and supplied with a fourth signal that is one of the plurality of fourth selection signals,
the first circuit is configured to control the operation of the first switch on a basis of the first signal, the second signal, the third signal, the fourth signal, and the first control signal, and
the second circuit is configured to control the operation of the second switch on a basis of the first signal, the second signal, the third signal, the fourth signal, and the second control signal.

14. The imaging device according to claim 13, wherein
each of the first signal, the second signal, the third signal, and the fourth signal is active or inactive,
in each of first one or more pixel circuits supplied with the first signal that is active and the second signal that is active and second one or more pixel circuits supplied with the third signal that is active and the fourth signal that is active of the plurality of pixel circuits, the first circuit is configured to control the operation of the first switch on a basis of the first control signal, and the second circuit is configured to control the operation of the second switch on a basis of the second control signal, and
in each of two or more pixel circuits other than the first one or more pixel circuits and the second one or more pixel circuits of the plurality of pixel circuits, the first circuit maintains the first switch off, and the second circuit maintains the second switch on.

15. The imaging device according to claim 13, wherein
the signal generation circuit is configured to further generate a third control signal and a fourth control signal,
the first circuit is configured to control the operation of the first switch on a basis of the first signal, the second signal, the third signal, the fourth signal, the first control signal, and the third control signal, and
the second circuit is configured to control the operation of the second switch on a basis of the first signal, the second signal, the third signal, the fourth signal, the second control signal, and the fourth control signal.

16. The imaging device according to claim 15, wherein
each of the first signal, the second signal, the third signal, and the fourth signal is active or inactive,
in each of first one or more pixel circuits supplied with the first signal that is active and the second signal that is active of the plurality of pixel circuits, the first circuit is configured to control the operation of the first switch on a basis of the first control signal, and the second circuit is configured to control the operation of the second switch on a basis of the second control signal, and
in each of second one or more pixel circuits supplied with the third signal that is active and the fourth signal that is active of the plurality of pixel circuits, the first circuit is configured to control the operation of the first switch on a basis of the third control signal, and the second circuit is configured to control the operation of the second switch on a basis of the fourth control signal.

17. The imaging device according to claim 16, wherein, in a case where third one or more pixel circuits of the second one or more pixel circuits are included in the first one or more pixel circuits, in the third one or more pixel circuits, the first circuit is configured to control the operation of the first switch on a basis of the third control signal, and the second circuit is configured to control the operation of the second switch on a basis of the fourth control signal.

18. The imaging device according to claim 17, wherein
one or more of the light-receiving elements in the third one or more pixel circuits include
a first light-receiving element provided with a light-shielding film having a first light-shielding pattern on a light reception surface, and
a second light-receiving element provided with a light-shielding film having a second light-shielding pattern on the light reception surface.

19. The imaging device according to claim 2, wherein
the first signal is active or inactive,
in each of one or more pixel circuits supplied with the first signal that is active of the plurality of pixel circuits, the first circuit is configured to control the operation of the first switch on a basis of the first control signal, and the second circuit is configured to control the operation of the second switch on a basis of the second control signal, and
in each of two or more pixel circuits other than the one or more pixel circuits of the plurality of pixel circuits, the first circuit maintains the first switch off, and the second circuit maintains the second switch on.

20. An imaging method comprising:
generating a first control signal;
generating a plurality of first selection signals; and
in each of a plurality of pixel circuits, generating electric charge corresponding an amount of received light by a light-receiving element, coupling the light-receiving element to an accumulation section by a first switch on a basis of one of the plurality of first selection signals and the first control signal, and comparing a pixel signal including a voltage in the accumulation section with a reference signal having a ramp waveform by a comparator circuit.
